(19) United States
(12) Patent Application Publication
(10) Pub. No.: US 2022/0318202 A1
(43) Pub. Date: Oct. 6, 2022

(54) METHOD AND SUBSYSTEM OF A DISTRIBUTED LOG-ANALYTICS SYSTEM THAT AUTOMATICALLY DETERMINE THE SOURCE OF LOG/EVENT MESSAGES

(71) Applicant: VMware, Inc., Palo Alto, CA (US)

(72) Inventors: Ritesh Jha, Karnataka (IN); Vaidic Joshi, Karnataka (IN); Jobin Raju George, Karnataka (IN); Nikhil Jaiswal, Kanartaka (IN); Pushkar Patil, Karnataka (IN)

(73) Assignee: VMware, Inc., Palo Alto, CA (US)

(21) Appl. No.: 17/222,050

(22) Filed: Apr. 5, 2021

(51) Int. Cl. G06F 16/17; G06F 16/18; G06F 16/9035; G06F 16/9038; G06F 9/30; G06F 9/54

(52) U.S. Cl. CPC G06F 16/1734; G06F 16/1805; G06F 16/9035; G06F 16/9038; G06F 9/30036; G06F 9/542; G06F 9/541

(57) ABSTRACT

The current document is directed to methods and subsystems within distributed log-analytics systems that automatically and autonomously generate indications of log sources for log/event messages received by the distributed log-analytics systems. The log-source indications can be incorporated in tags associated with received log/event messages to facilitate use of log/event-message information and log/event-message-processing tools contained in content packs provided by designers, manufacturers, and vendors of computational entities by log/event-message systems that collect, process, and store large volumes of log/event messages generated by many different types of computational entities within distributed computer systems. Log-source indications are generated by a combination of using currently available log-source indications associated with log/event messages, event-type-clustering based event-type-to-log source mapping, and machine-learning-based event-type-to-log source mapping.

### TECHNICAL FIELD

The current document is directed to distributed-computer-systems and, in particular, to methods and subsystems within distributed log-analytics systems that automatically and autonomously generate the log sources for log/event messages received by the distributed log-analytics systems.

### BACKGROUND

During the past seven decades, electronic computing has evolved from primitive, vacuum-tube-based computer systems, initially developed during the 1940s, to modern electronic computing systems in which large numbers of multi-processor servers, work stations, and other individual computing systems are networked together with large-capacity data-storage devices and other electronic devices to produce geographically distributed computing systems with hundreds of thousands, millions, or more components that provide enormous computational bandwidths and data-storage capacities. These large, distributed computing systems are made possible by advances in computer networking, distributed operating systems and applications, data-storage appliances, computer hardware, and software technologies. However, despite all of these advances, the rapid increase in the size and complexity of computing systems has been accompanied by numerous scaling issues and technical challenges, including technical challenges associated with communications overheads encountered in parallelizing computational tasks among multiple processors, component failures, and distributed-system management. As new distributed-computing technologies are developed, and as general hardware and software technologies continue to advance, the current trend towards ever-larger and more complex distributed computing systems appears likely to continue well into the future.

As the complexity of distributed computing systems has increased, the management and administration of distributed computing systems has, in turn, become increasingly complex, involving greater computational overheads and significant inefficiencies and deficiencies. In fact, many desired management-and-administration functionalities are becoming sufficiently complex to render traditional approaches to the design and implementation of automated management and administration systems impractical, from a time and cost standpoint, and even from a feasibility standpoint. Therefore, designers and developers of various types of automated management-and-administration facilities related to distributed computing systems are seeking new approaches to implementing automated management-and-administration facilities and functionalities.

### SUMMARY

The current document is directed to methods and subsystems within distributed log-analytics systems that automatically and autonomously generate indications of log sources for log/event messages received by the distributed log-analytics systems. The log-source indications can be incorporated in tags associated with received log/event messages to facilitate use of log/event-message information and log/event-message-processing tools contained in content packs provided by designers, manufacturers, and vendors of computational entities by log/event-message systems that collect, process, and store large volumes of log/event messages generated by many different types of computational entities within distributed computer systems. Log-source indications are generated by a combination of using currently available log-source indications associated with log/event messages, event-type-clustering based event-type-to-log source mapping, and machine-learning-based event-type-to-log source mapping.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates an OVF package.

FIG. 7 illustrates virtual data centers provided as an abstraction of underlying physical-data-center hardware components.

FIG. 8 illustrates virtual-machine components of a VI-management-server and physical servers of a physical data center above which a virtual-data-center interface is provided by the VI-management-server.

FIG. 9 illustrates a cloud-director level of abstraction.

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds.

FIG. 11 shows a small, 11-entry portion of a log file from a distributed computer system.

FIG. 12 illustrates generation of log/event messages within a server.

FIGS. 13A-B illustrate two different types of log/event-message collection and forwarding within distributed computer systems.

FIG. 14 provides a block diagram of a generalized log/event-message system incorporated within one or more distributed computing systems.

FIG. 15 illustrates log/event-message preprocessing.

FIG. 16 illustrates processing of log/event messages by a message-collector system or a message-ingestion-and-processing system.

FIGS. 17A-C provide control-flow diagrams that illustrate log/event-message processing within currently available message-collector systems and message-ingestion-and-processing systems.

FIG. 18 illustrates various common types of initial log/event-message processing carried out by message-collector systems and/or message-ingestion-and-processing systems.

FIG. 19 illustrates processing rules that specify various types of initial log/event-message processing.

FIGS. 20A-B illustrate a log/event-message-type generation method.

FIGS. 21A-C illustrate a clustering technique for generating an event_type( ) function and extraction and message-restoration functions, ƒ( ) and ƒ¹( ).

FIGS. 22A-B illustrate a machine-learning technique for generating an event_type( ) function and extraction and message-restoration functions ƒ( ) and ƒ¹( ).

FIGS. 23A-C illustrate one approach to extracting fields from a log/event message.

FIGS. 24A-B illustrate a type of classifier referred to as a support vector machine (“SVM”).

FIGS. 25A-D illustrate data-set clustering using one of many different variations of K-means clustering.

FIGS. 26A-G provide a simple C++ implementation of one version of the clustering process.

FIG. 27 illustrates the fundamental components of a feed-forward neural network.

FIG. 28 illustrates a small, example feed-forward neural network.

FIG. 29 provides a concise pseudocode illustration of the implementation of a simple feed-forward neural network.

FIG. 30 illustrates back propagation of errors through the neural network during training.

FIGS. 31A-B show the details of the weight-adjustment calculations carried out during hack propagation.

FIGS. 32A-C illustrate various aspects of recurrent neural networks.

FIGS. 33A-C illustrate a convolutional neural network.

FIGS. 34A-B illustrate neural-network training as an example of machine-learning-based-subsystem training.

FIGS. 35A-D illustrate machine-reading-comprehension (“MRC”) systems.

FIG. 36 provides an illustration of log/event-message information and tools provided by different content packs developed for different sets of log/event messages generated within a hypothetical distributed computer system.

FIGS. 37A-C illustrate hypothetical log/event-message processing using the hypothetical content-pack information and tools provided by content packs illustrated in FIG. 36.

FIGS. 38A-B illustrate problems associated with log/event-message tagging.

FIG. 39 shows a small, modified portion of the routine “process message” shown in FIG. 17B.

FIG. 40 shows a small number of simple, relational database tables used in one implementation of the currently disclosed methods and systems.

FIGS. 41A-B provide control-flow diagrams for the routine “tag,” called in step 3904 of FIG. 39.

FIG. 42 provides a control-flow diagram for the routine “log-source mapping.”

FIGS. 43A-B provide control-flow diagrams for the routines “handle unverified log sources” and “unknown,” both repeatedly called by the routine “log-source mapping” shown in FIG. 42.

FIG. 44 provides a control-flow diagram for the routine “CPack scoring.” called in step 4208 of FIG. 42.

FIGS. 45A-F provide control-flow diagrams for the routines directly and indirectly called by the routine “CPack scoring.”

FIGS. 46A-B provide control-flow diagrams for the routine “ML sourcing,” called in step 4214 of FIG. 42.

### DETAILED DESCRIPTION

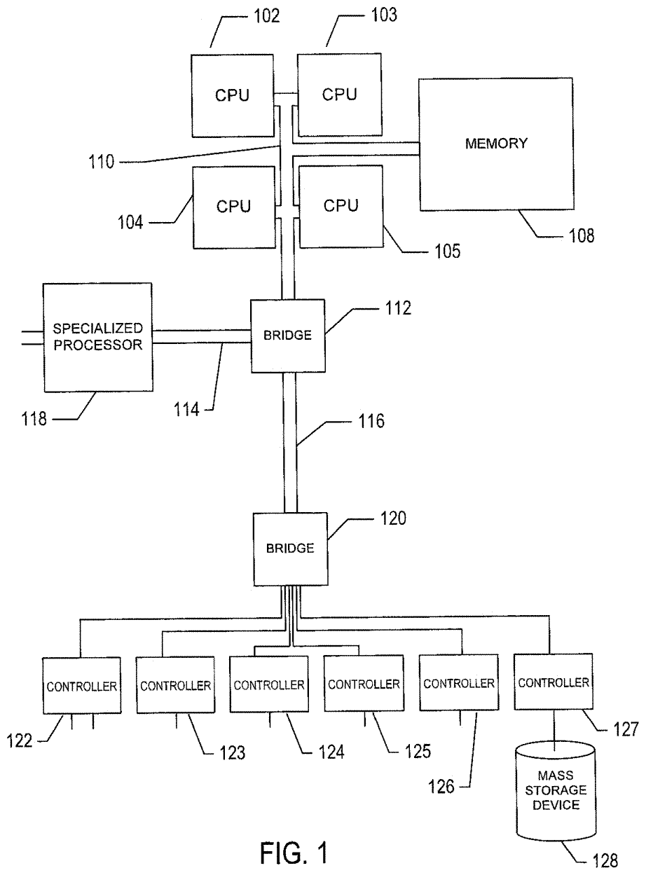

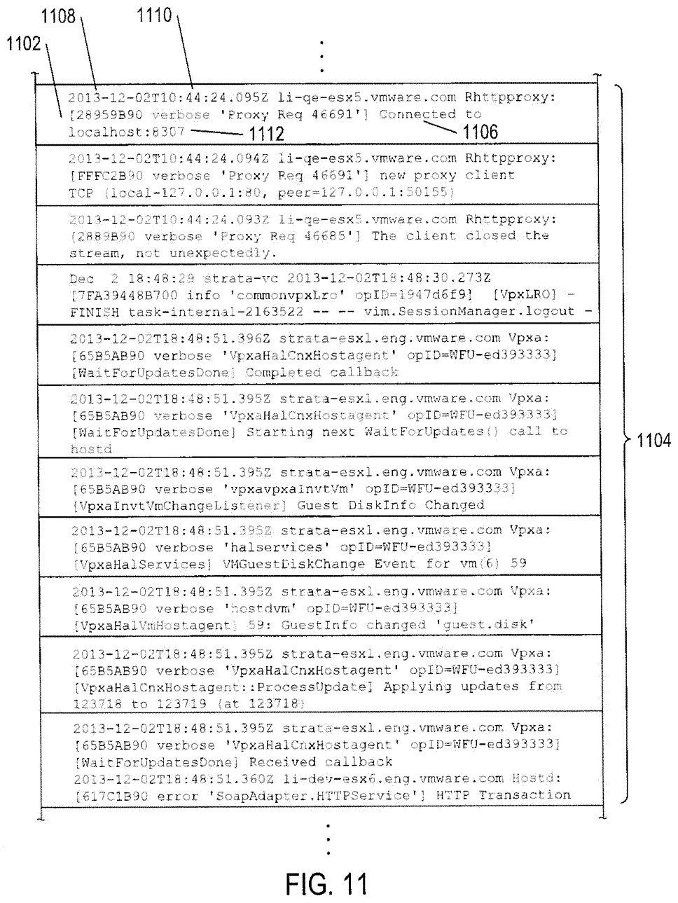

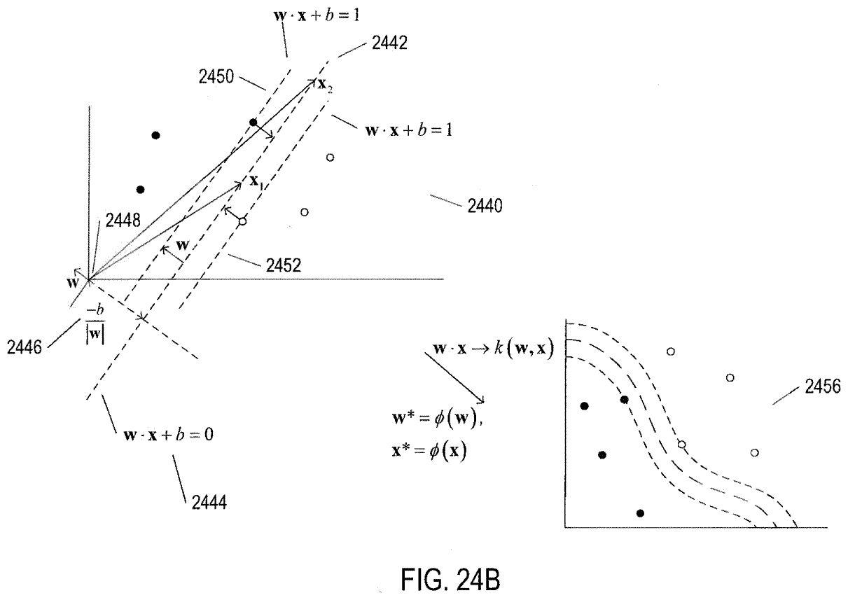

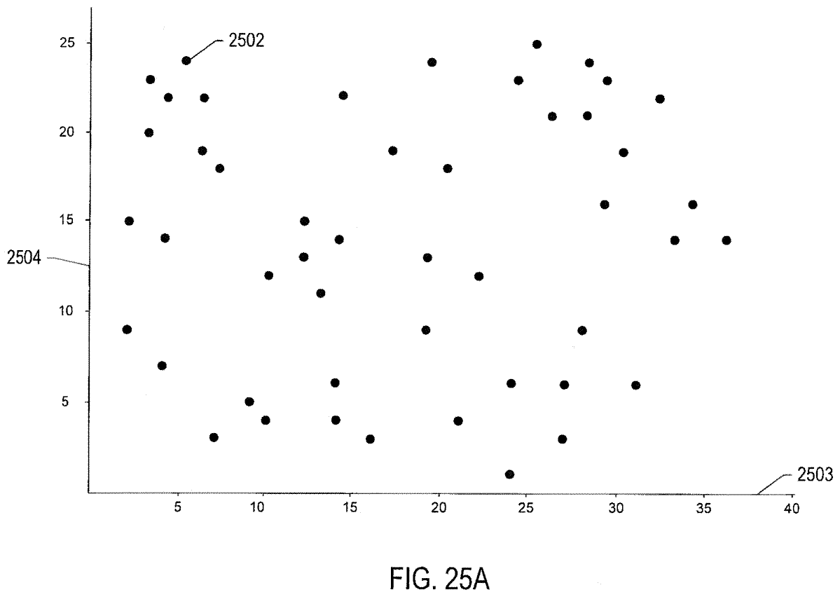

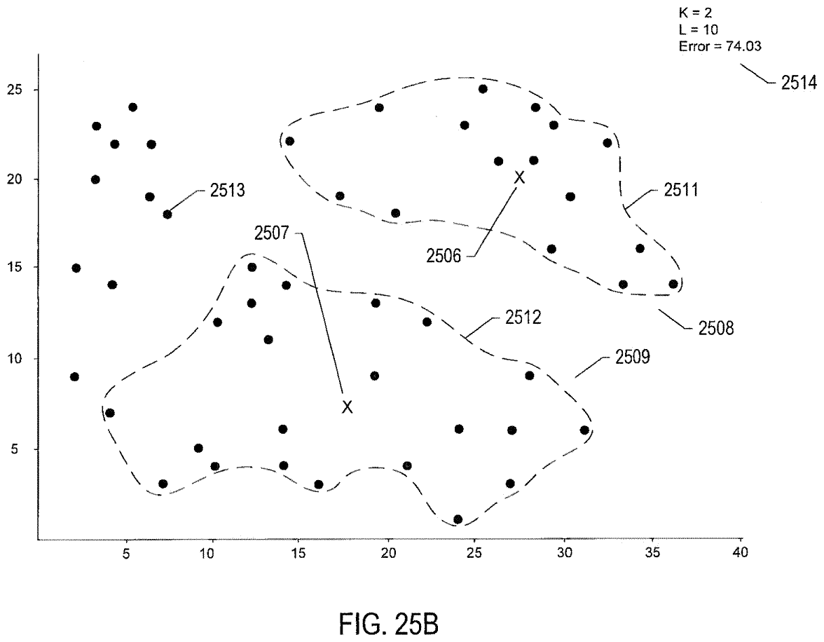

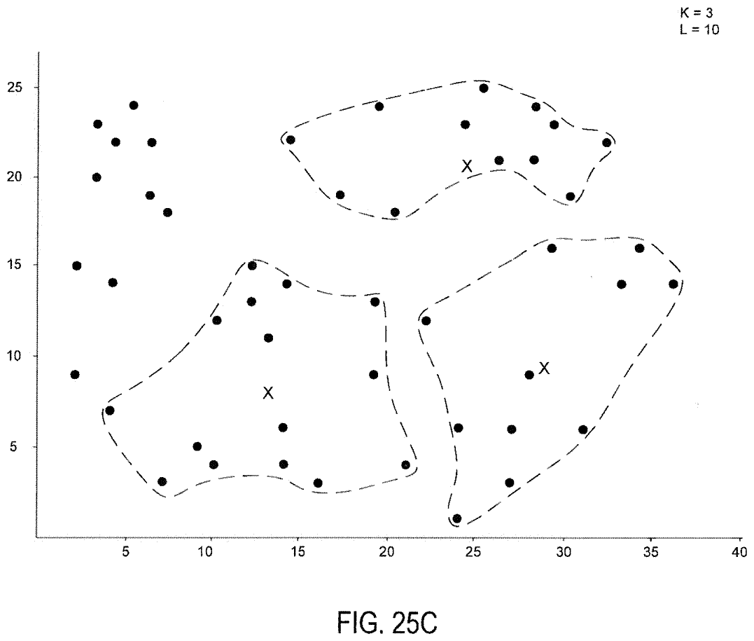

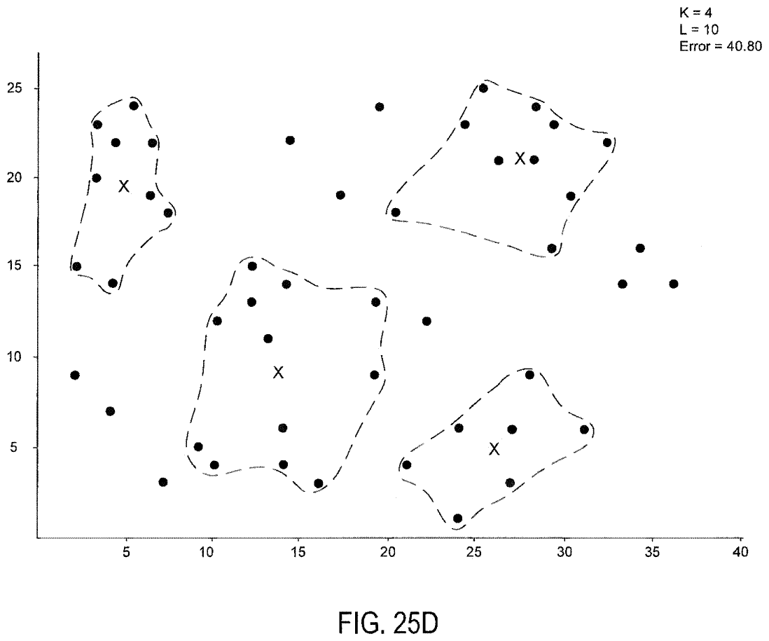

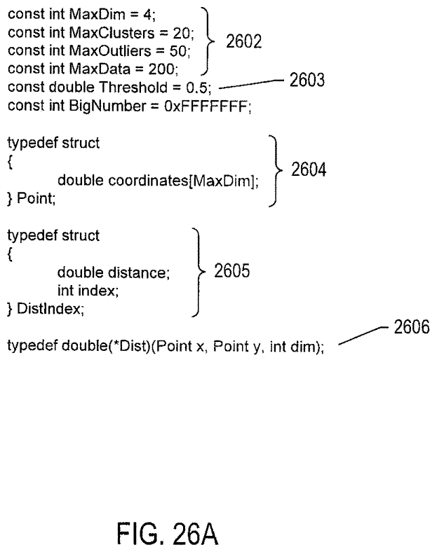

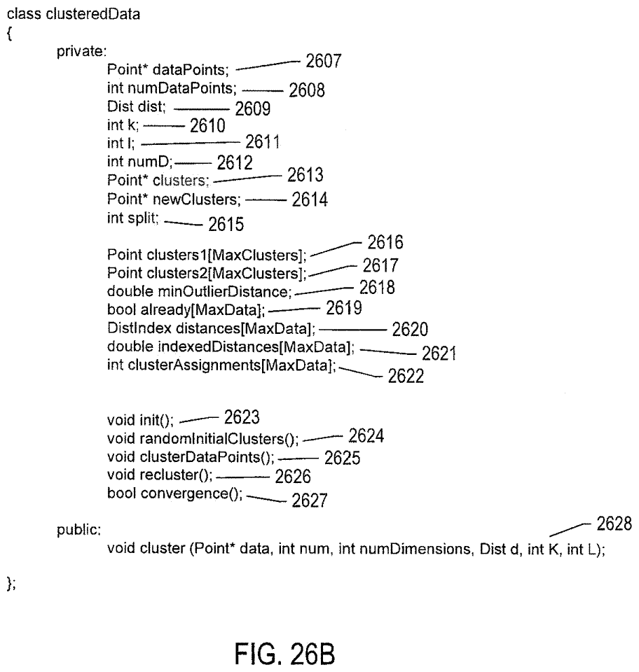

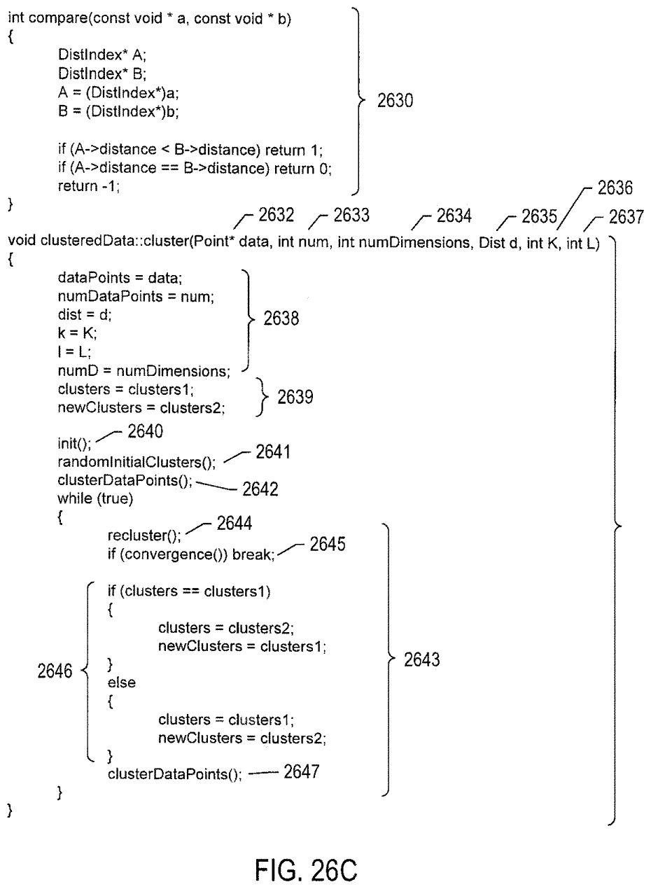

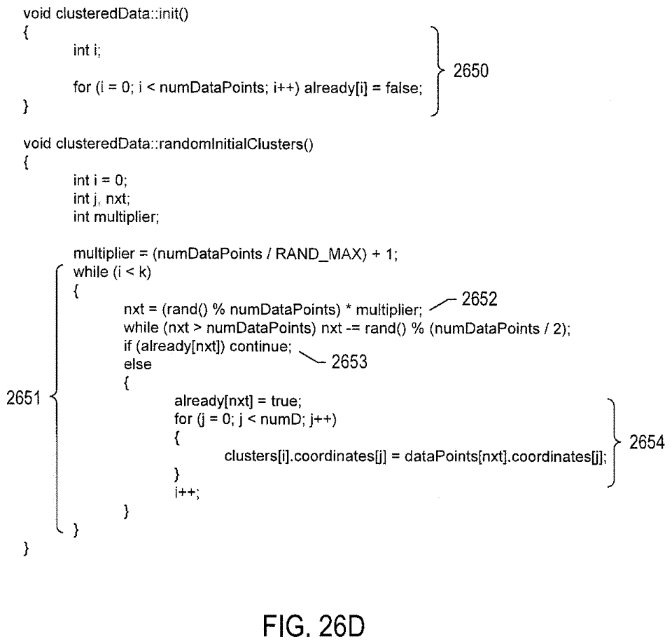

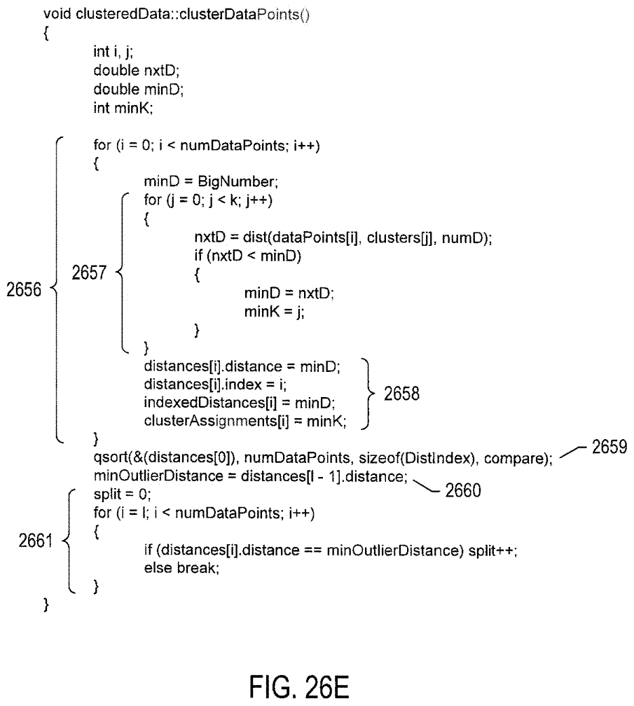

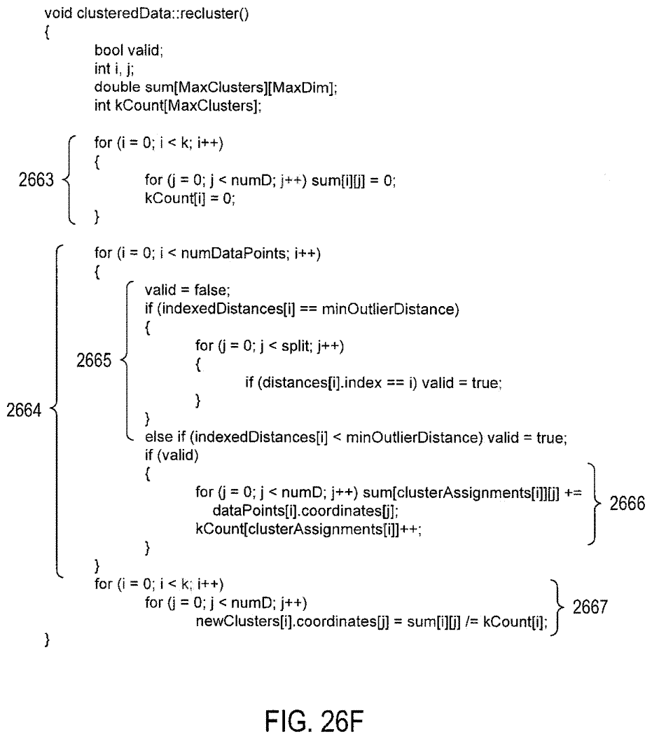

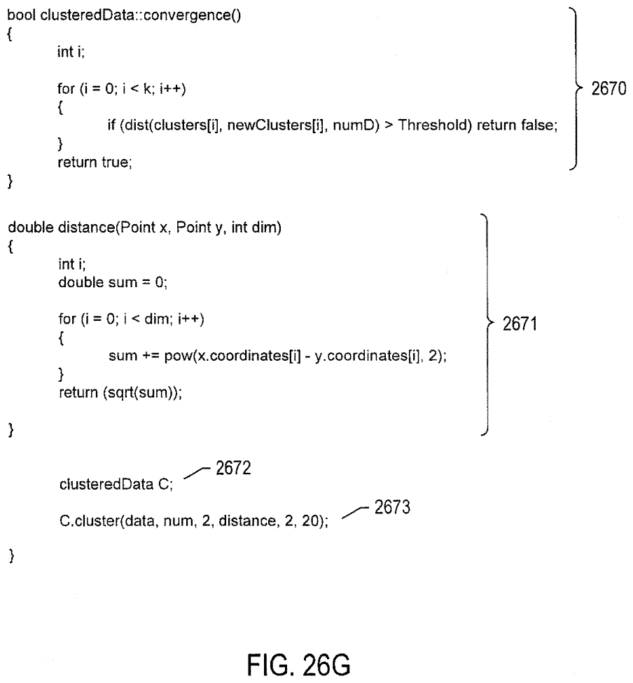

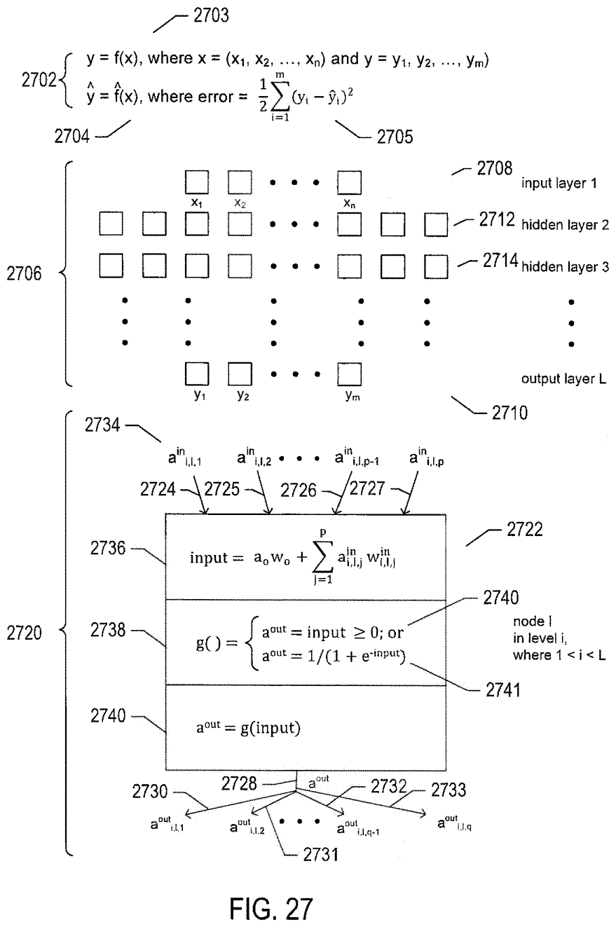

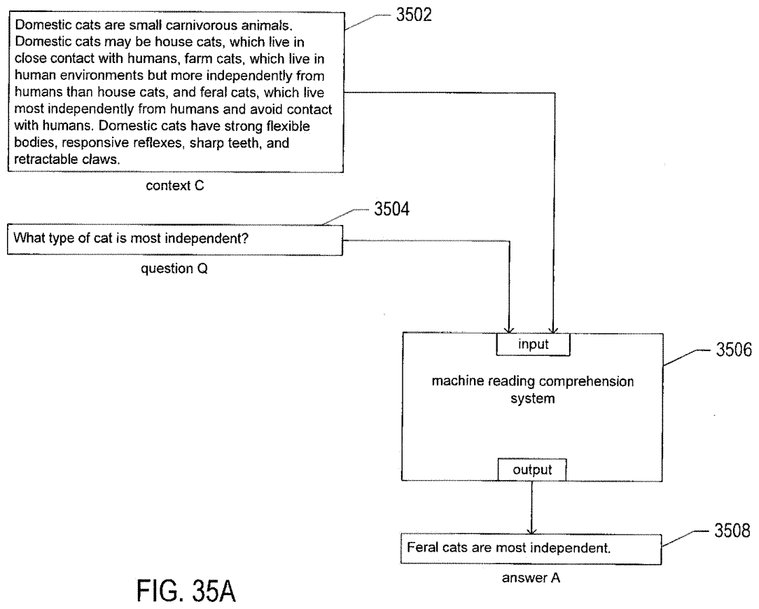

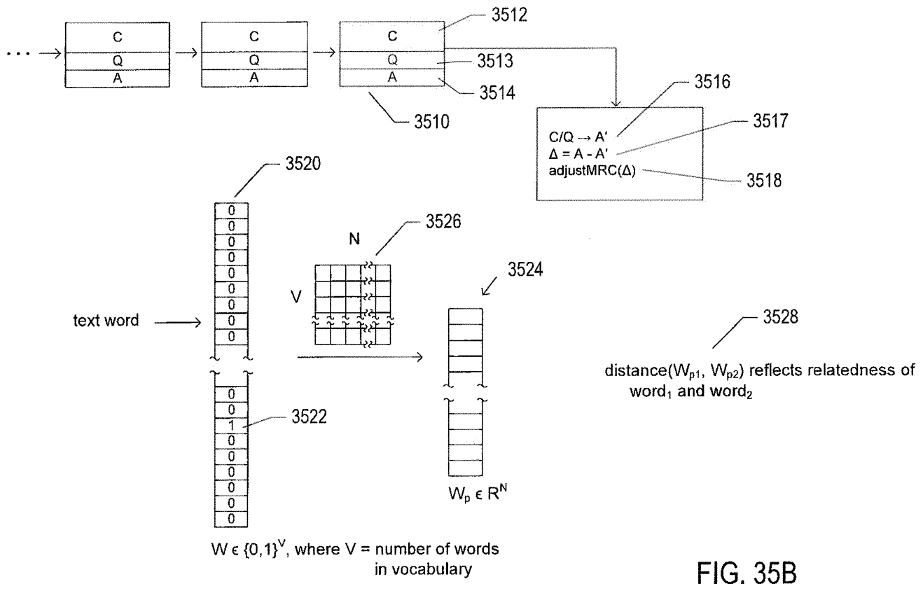

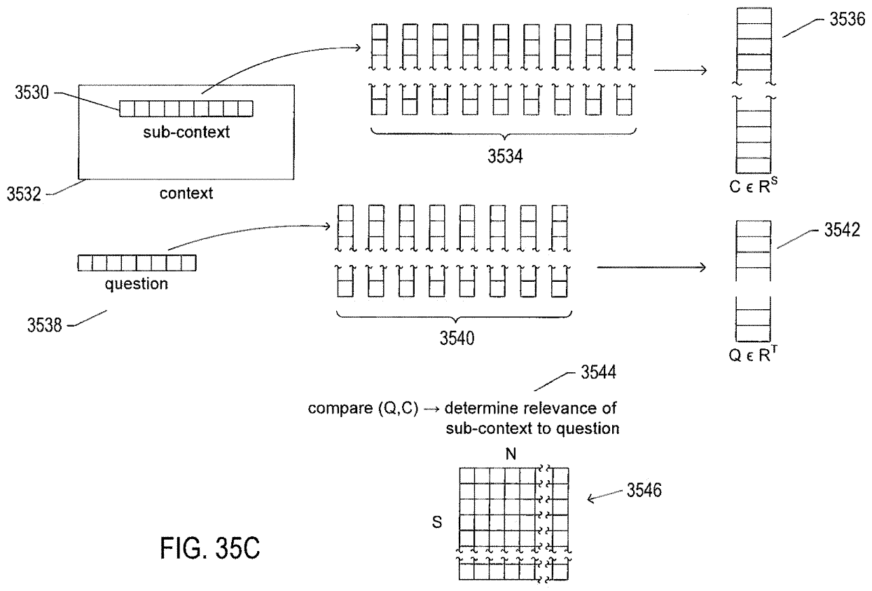

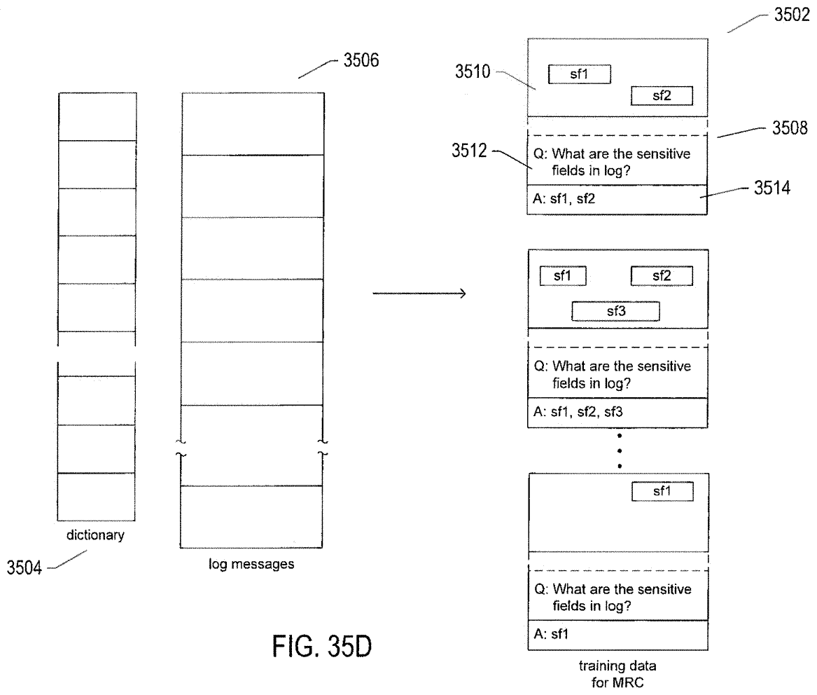

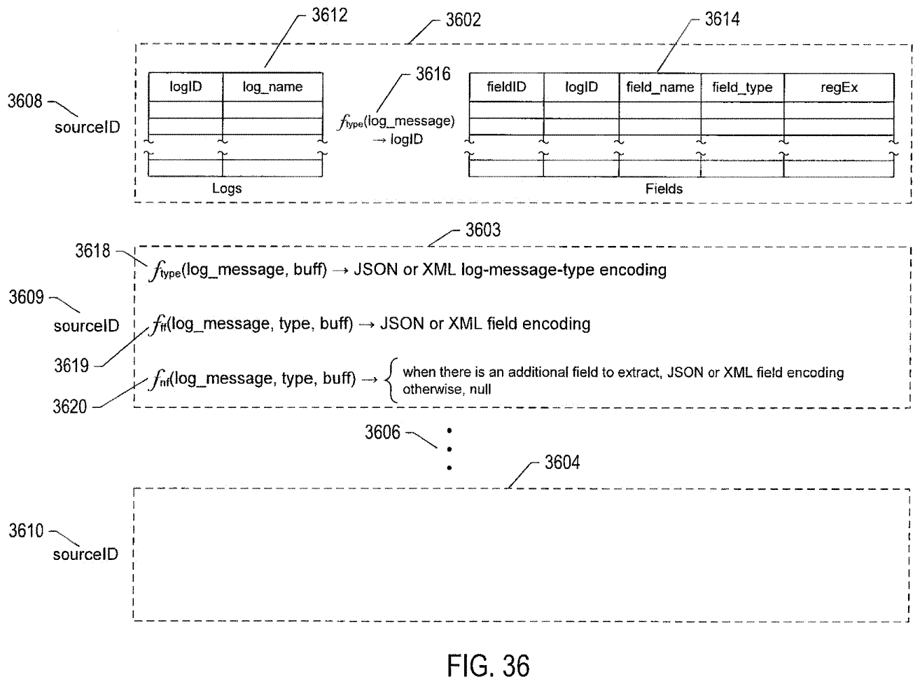

The current document is directed methods and subsystems within distributed log-analytics systems that automatically and autonomously generate indications of log sources for log/event messages received by a log/event-message system that collects, processes, and stores the log/event messages. In a first subsection, below, a detailed description of computer hardware, complex computational systems, and virtualization is provided with reference to FIGS. 1-10. In a second subsection, an overview of distributed log-analytics systems is provided with reference to FIGS. 11-23C. In a third subsection, support vector machines are discussed with reference to FIGS. 24A-B. In a fourth subsection. K-means clustering is discussed with reference to FIGS. 25A-26G. In a fifth subsection, neural networks are discussed with reference to FIGS. 27-34B. In a sixth subsection, a natural-language-processing method, referred to as “machine-reading comprehension,” is discussed with reference to FIGS. 35A-D. Finally, in a seventh subsection, the currently disclosed methods and systems are discussed with reference to FIGS. 36-46B.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

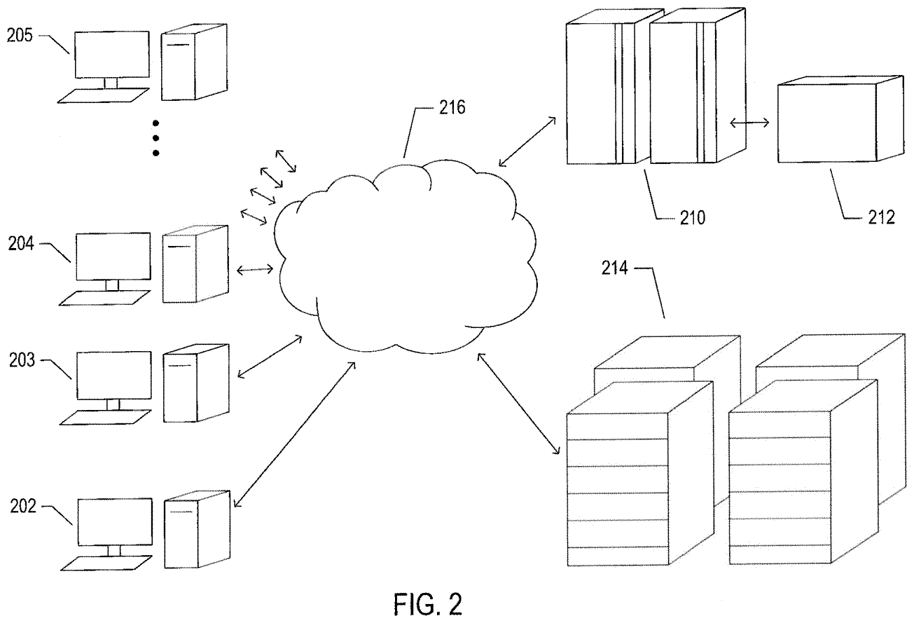

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

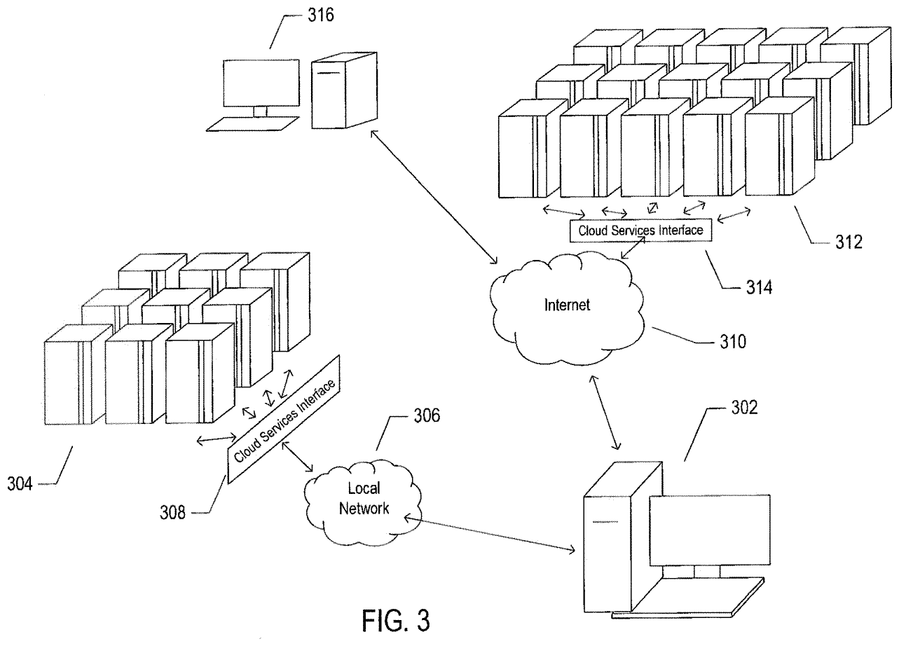

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

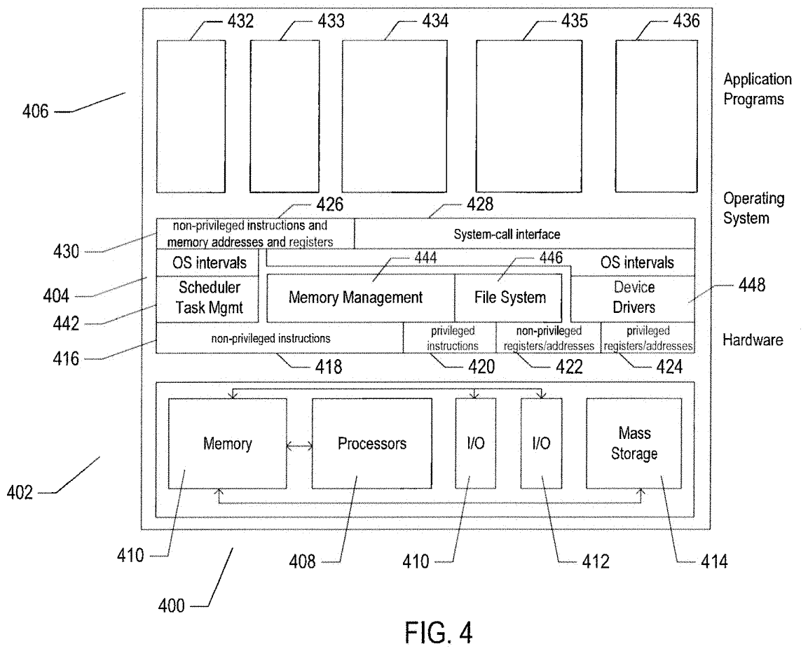

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

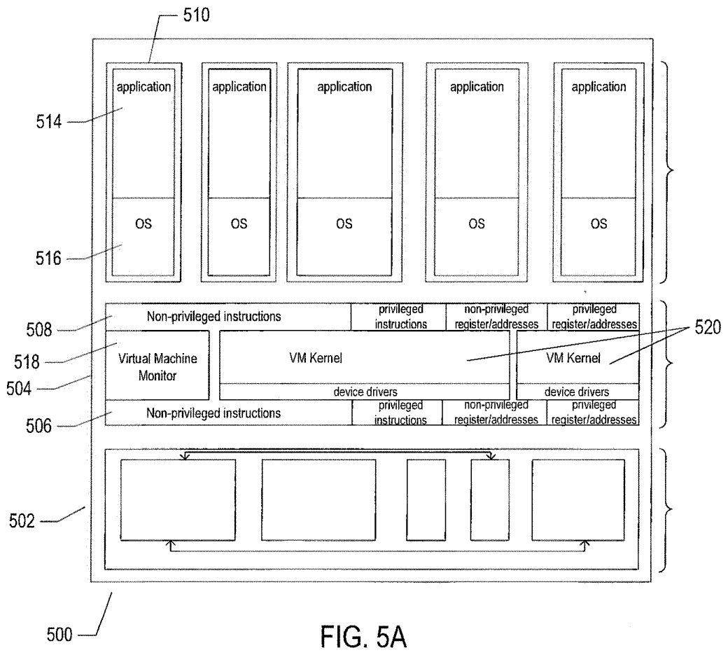

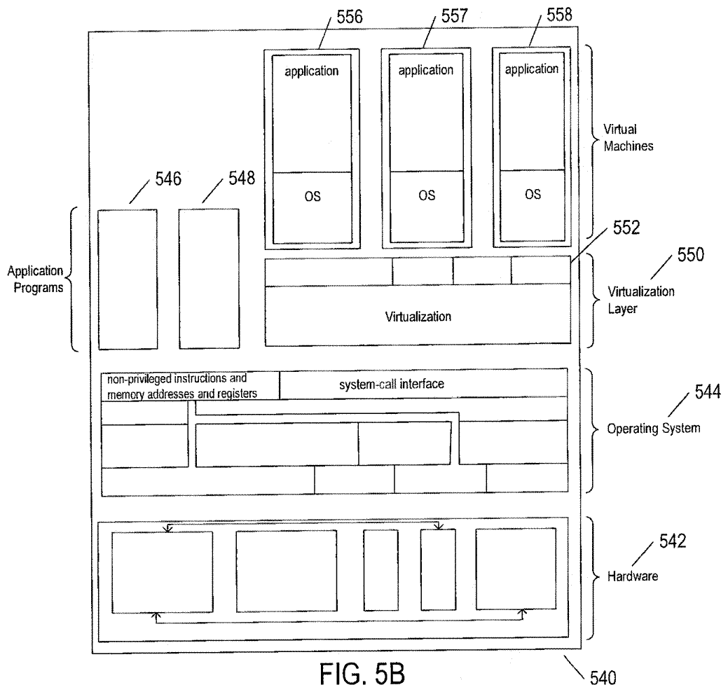

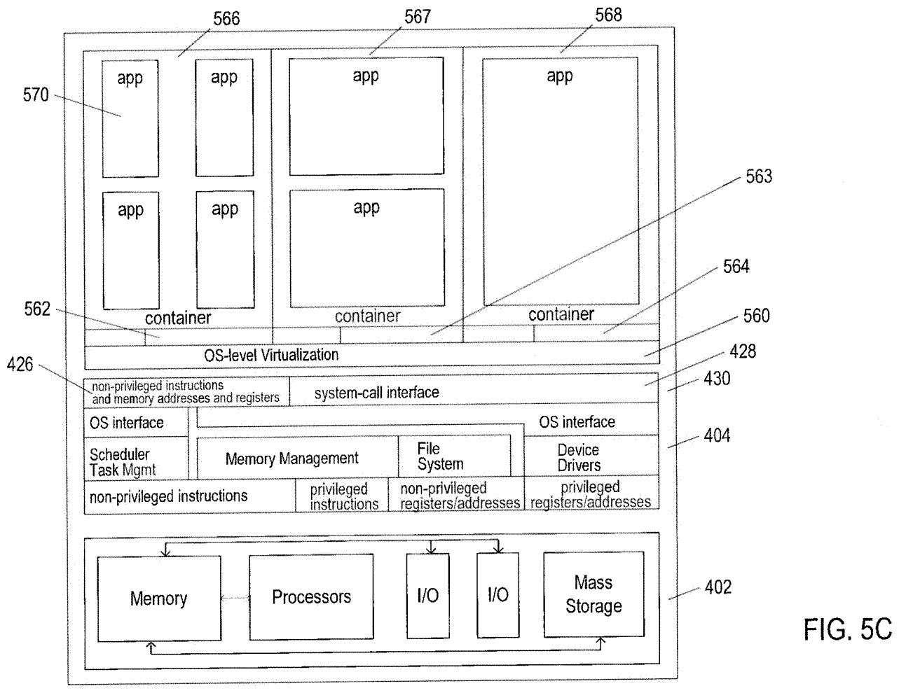

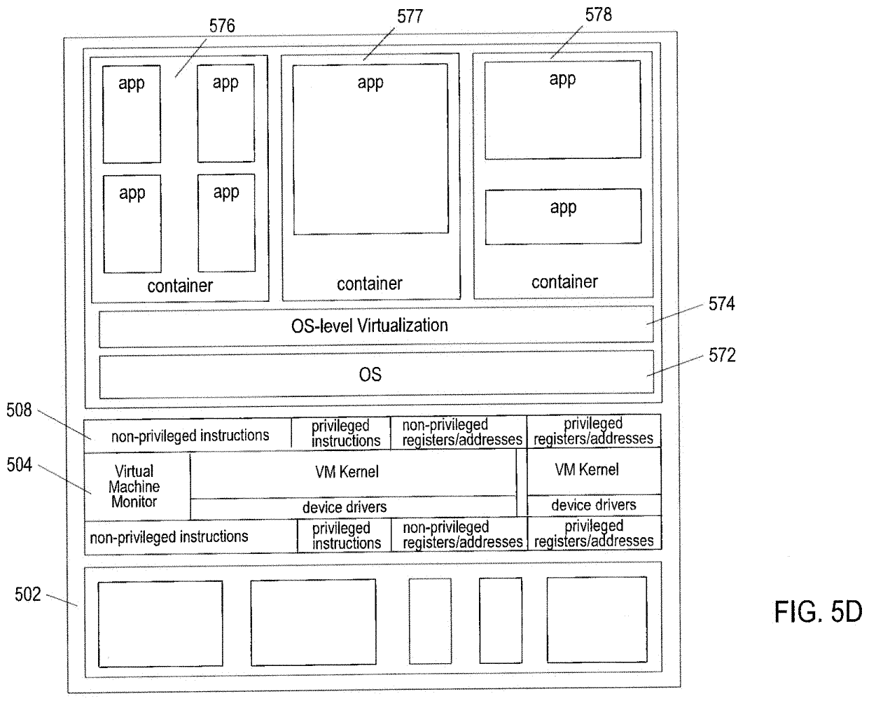

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems. OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence, OSL virtualization uses operating-system features, such as name space support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

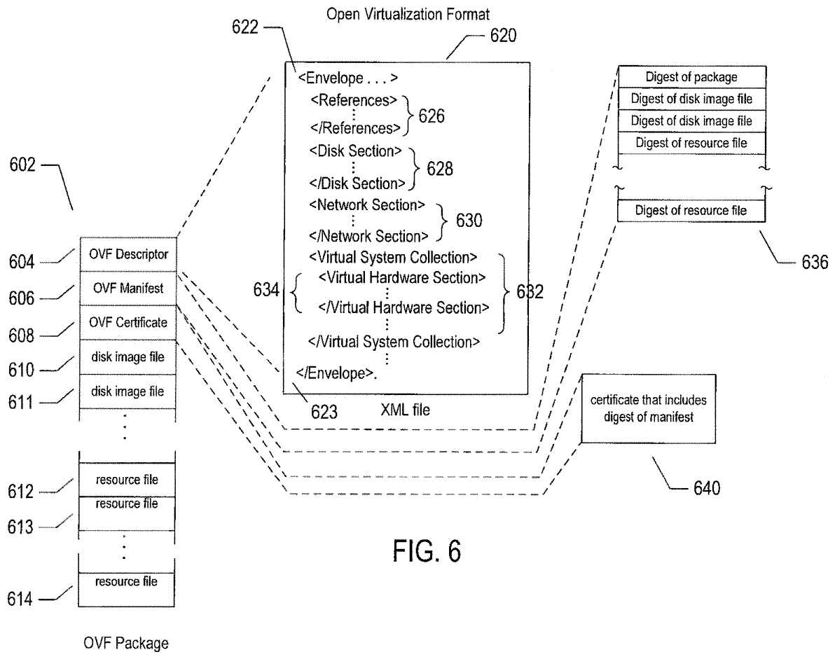

A virtual machine or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a virtual machine within one or more data files. FIG. 6 illustrates an OVF package. An OVF package 602 includes an OVF descriptor 604, an OVF manifest 606, an OVF certificate 608, one or more disk-image files 610-611, and one or more resource files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a networks section 630 that includes meta information about all of the logical networks included in the OVF package, and a collection of virtual-machine configurations 632 which further includes hardware descriptions of each virtual machine 634. There are many additional hierarchical levels and elements within a typical OVF descriptor. The OVF descriptor is thus a self-describing XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and resource files 612 are digitally encoded content, such as operating-system images. A virtual machine or a collection of virtual machines encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more virtual machines that is encoded within an OVF package.

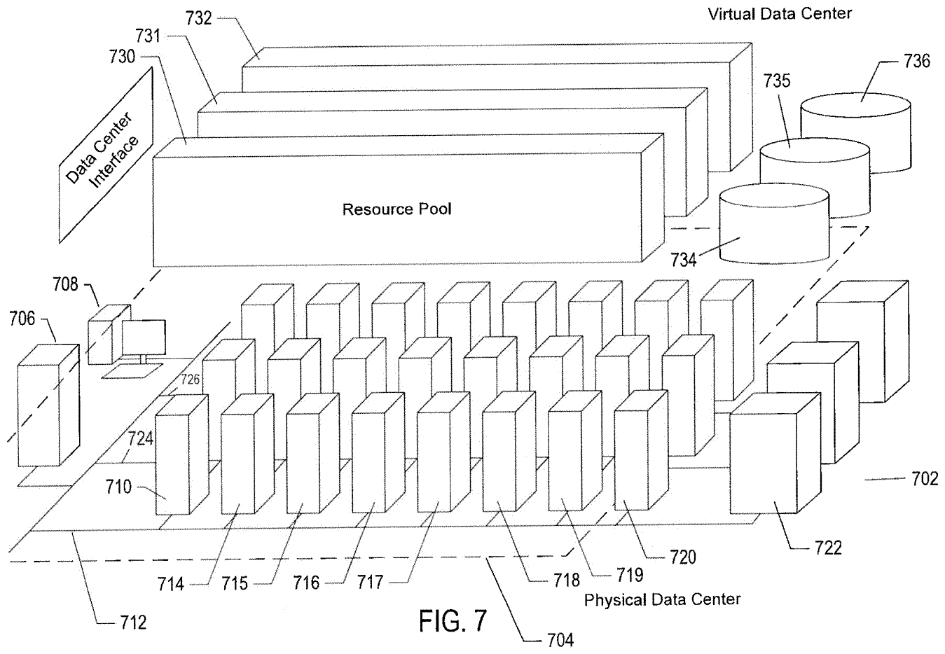

The advent of virtual machines and virtual environments has alleviated many of the difficulties and challenges associated with traditional general-purpose computing. Machine and operating-system dependencies can be significantly reduced or entirely eliminated packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 7 illustrates virtual data centers provided as an abstraction of underlying physical-data-center hardware components. In FIG. 7, a physical data center 702 is shown below a virtual-interface plane 704. The physical data center consists of a virtual-infrastructure management server (“VI-management-server”) 706 and any of various different computers, such as PCs 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight servers and a mass-storage array. The individual server computers, such as server computer 710, each includes a virtualization layer and runs multiple virtual machines. Different physical data centers may include many different types of computers, networks, data-storage systems and devices connected according to many different types of connection topologies. The virtual-data-center abstraction layer 704, a logical abstraction layer shown by a plane in FIG. 7, abstracts the physical data center to a virtual data center comprising one or more resource pools, such as resource pools 730-732, one or more virtual data stores, such as virtual data stores 734-736, and one or more virtual networks. In certain implementations, the resource pools abstract banks of physical servers directly interconnected by a local area network.

The virtual-data-center management interface allows provisioning and launching of virtual machines with respect to resource pools, virtual data stores, and virtual networks, so that virtual-data-center administrators need not be concerned with the identities of physical-data-center components used to execute particular virtual machines. Furthermore, the VI-management-server includes functionality to migrate running virtual machines from one physical server to another in order to optimally or near optimally manage resource allocation, provide fault tolerance, and high availability by migrating virtual machines to most effectively utilize underlying physical hardware resources, to replace virtual machines disabled by physical hardware problems and failures, and to ensure that multiple virtual machines supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of virtual machines and virtual appliances as well as to provide high-level, distributed functionalities that involve pooling the resources of individual physical servers and migrating virtual machines among physical servers to achieve load balancing, fault tolerance, and high availability.

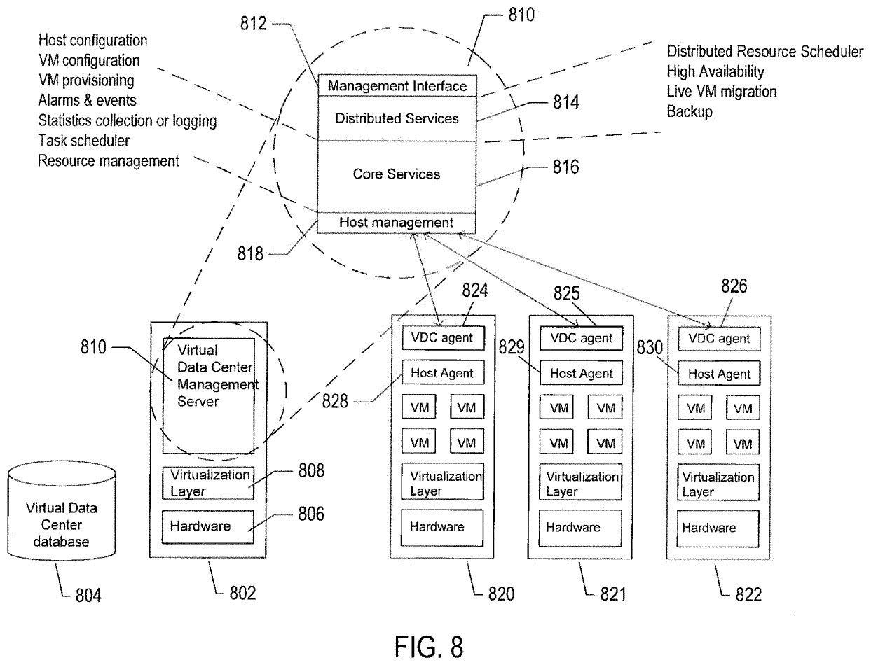

FIG. 8 illustrates virtual-machine components of a VI-management-server and physical servers of a physical data center above which a virtual-data-center interface is provided by the VI-management-server. The VI-management-server 802 and a virtual-data-center database 804 comprise the physical components of the management component of the virtual data center. The VI-management-server 802 includes a hardware layer 806 and virtualization layer 808 and runs a virtual-data-center management-server virtual machine 810 above the virtualization layer. Although shown as a single server in FIG. 8, the VI-management-server (“VI management server”) may include two or more physical server computers that support multiple VI-management-server virtual appliances. The virtual machine 810 includes a management-interface component 812, distributed services 814, core services 816, and a host-management interface 818. The management interface is accessed from any of various computers, such as the PC 708 shown in FIG. 7. The management interface allows the virtual-data-center administrator to configure a virtual data center, provision virtual machines, collect statistics and view log files for the virtual data center, and to carry out other, similar management tasks. The host-management interface 818 interfaces to virtual-data-center agents 824, 825, and 826 that execute as virtual machines within each of the physical servers of the physical data center that is abstracted to a virtual data center by the VI management server.

The distributed services 814 include a distributed-resource scheduler that assigns virtual machines to execute within particular physical servers and that migrates virtual machines in order to most effectively make use of computational bandwidths, data-storage capacities, and network capacities of the physical data center. The distributed services further include a high-availability service that replicates and migrates virtual machines in order to ensure that virtual machines continue to execute despite problems and failures experienced by physical hardware components. The distributed services also include a live-virtual-machine migration service that temporarily halts execution of a virtual machine, encapsulates the virtual machine in an OVF package, transmits the OVF package to a different physical server, and restarts the virtual machine on the different physical server from a virtual-machine state recorded when execution of the virtual machine was halted. The distributed services also include a distributed backup service that provides centralized virtual-machine backup and restore.

The core services provided by the VI management server include host configuration, virtual-machine configuration, virtual-machine provisioning, generation of virtual-data-center alarms and events, ongoing event logging and statistics collection, a task scheduler, and a resource-management module. Each physical server 820-822 also includes a host-agent virtual machine 828-830 through which the virtualization layer can be accessed via a virtual-infrastructure application programming interface (“API”). This interface allows a remote administrator or user to manage an individual server through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server. The virtual-data-center agents relay and enforce resource allocations made by the VI management server, relay virtual-machine provisioning and configuration-change commands to host agents, monitor and collect performance statistics, alarms, and events communicated to the virtual-data-center agents by the local host agents through the interface API, and to carry out other, similar virtual-data-management tasks.

The virtual-data-center abstraction provides a convenient and efficient level of abstraction for exposing the computational resources of a cloud-computing facility to cloud-computing-infrastructure users. A cloud-director management server exposes virtual resources of a cloud-computing facility to cloud-computing-infrastructure users. In addition, the cloud director introduces a multi-tenancy layer of abstraction, which partitions virtual data centers (“VDCs”) into tenant-associated VDCs that can each be allocated to a particular individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

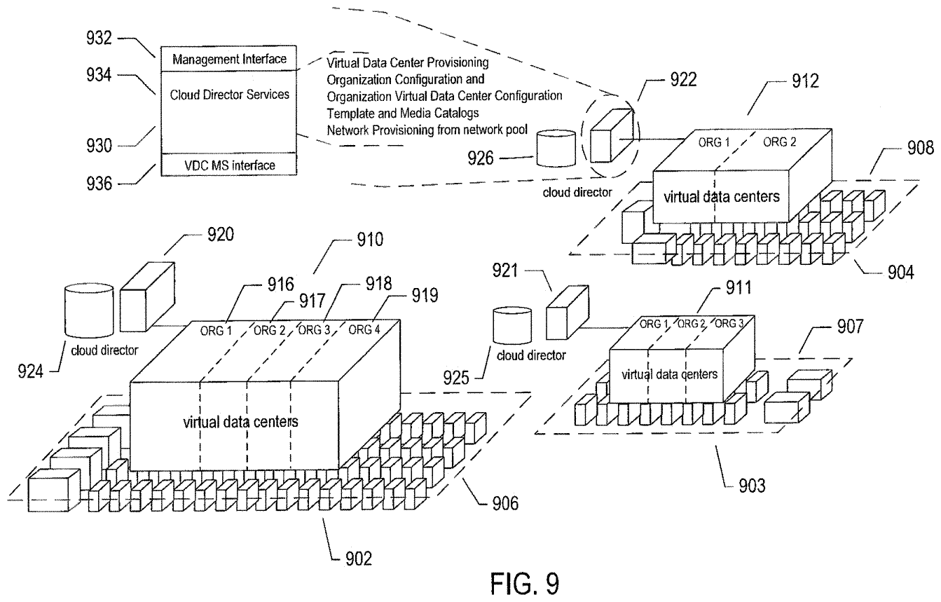

FIG. 9 illustrates a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The resources of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director servers 920-922 and associated cloud-director databases 924-926. Each cloud-director server or servers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are virtual machines that each contains an OS and/or one or more virtual machines containing applications. A template may include much of the detailed contents of virtual machines and virtual appliances that are encoded within OVF packages, so that the task of configuring a virtual machine or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VI management server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

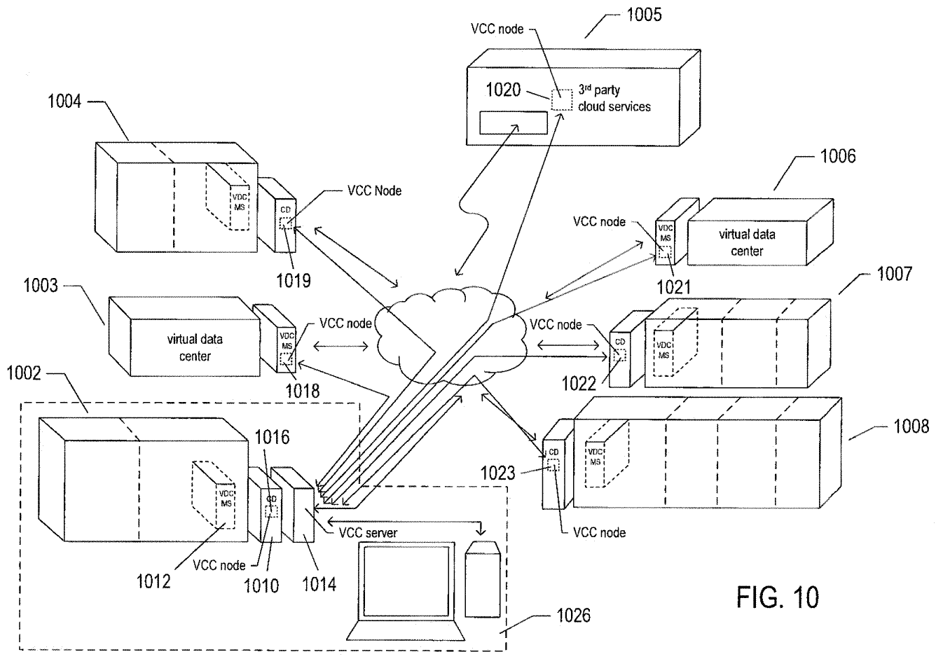

FIG. 10 illustrates virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of C server and nodes. In FIG. 10, seven different cloud-computing facilities are illustrated 1002-1008. Cloud-computing facility 1002 is a private multi-tenant cloud with a cloud director 1010 that interfaces to a VI management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VI management server that manages a single-tenant private cloud. The VCC server 1014 additionally interfaces, through the Internet, to VCC node virtual appliances executing within remote VI management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

### An Overview of Distributed Log-Analytics Systems

Modern distributed computing systems feature a variety of different types of automated and semi-automated administration and management systems that detect anomalous operating behaviors of various components of the distributed computing systems, collect errors reported by distributed-computing-system components, and use the detected anomalies and collected errors to monitor and diagnose the operational states of the distributed computing systems in order to automatically undertake corrective and ameliorative actions and to alert human system administrators of potential, incipient, and already occurring problems. Log/event-message reporting, collecting, storing, and querying systems are fundamental components of administration and management subsystems. The phrase “log/event message” refers to various types of generally short log messages and event messages issued by message-generation-and-reporting functionality incorporated within many hardware components, including network routers and bridges, network-attached storage devices, network-interface controllers, virtualization layers, operating systems, applications running within servers and other types of computer systems, and additional hardware devices incorporated within distributed computing systems. The log/event messages generally include both text and numeric values and represent various types of information, including notification of completed actions, errors, anomalous operating behaviors and conditions, various types of computational events, warnings, and other such information. The log/event messages are transmitted to message collectors, generally running within servers of local data centers, which forward collected log/event messages to message-ingestion-and-processing systems that collect and store log/event messages in message databases. Log/event-message query-processing systems provide, to administrators and managers of distributed computing systems, query-based access to log/event messages in message databases. The message-ingestion-and-processing systems may additionally provide a variety of different types of services, including automated generation of alerts, filtering, and other message-processing services.

Large modern distributed computing systems may generate enormous volumes of log/event messages, from tens of gigabytes (“GB”) to terabytes (“TB”) of log/event messages per day. Generation, transmission, and storage of such large volumes of data represent significant networking-bandwidth, processor-bandwidth, and data-storage overheads for distributed computing systems, significantly decreasing the available networking bandwidth, processor bandwidth, and data-storage capacity for supporting client applications and services. In addition, the enormous volumes of log/event messages generated, transmitted, and stored on a daily basis result in significant transmission and processing latencies, as a result of which greater than desired latencies in alert generation and processing of inquiries directed to stored log/event messages are often experienced by automated and semi-automated administration tools and services as well as by human administrators and managers.

FIG. 11 shows a small, 11-entry portion of a log file from a distributed computer system. A log file may store log/event messages for archival purposes, in preparation for transmission and forwarding to processing systems, or for batch entry into a log/event-message database. In FIG. 11, each rectangular cell, such as rectangular cell 1102, of the portion of the log file 1104 represents a single stored log/event message. In general, log/event messages are relatively cryptic, including only one or two natural-language sentences or phrases as well as various types of file names, path names, network addresses, component identifiers, and, other alphanumeric parameters. For example, log entry 1102 includes a short natural-language phrase 1106, date 1108 and time 1110 parameters, as well as a numeric parameter 1112 which appears to identify a particular host computer.

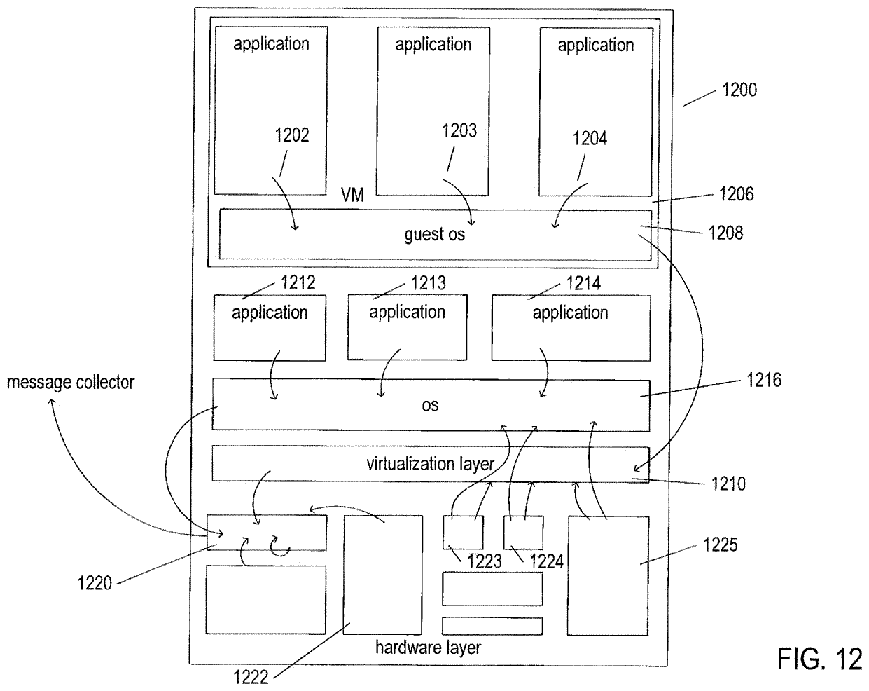

FIG. 12 illustrates generation of log/event messages within a server. A block diagram of a server 1200 is shown in FIG. 12. Log/event messages can be generated within application programs, as indicated by arrows 1202-1204. In this example, the log/event messages generated by applications running within an execution environment provided by a virtual machine 1206 are reported to a guest operating system 1208 running within the virtual machine. The application-generated log/event messages and log/event messages generated by the guest operating system are, in this example, reported to a virtualization layer 1210. Log/event messages may also be generated by applications 1212-1214 running in an execution environment provided by an operating system 1216 executing independently of a virtualization layer. Both the operating system 1216 and the virtualization layer 1210 may generate additional log/event messages and transmit those log/event messages along with log/event messages received from applications and the guest operating system through a network interface controller 1222 to a message collector. In addition, various hardware components and devices within the server 1222-1225 may generate and send log/event messages either to the operating system 1216 and/or virtualization layer 1210, or directly to the network interface controller 122 for transmission to the message collector. Thus, many different types of log/event messages may be generated and sent to a message collector from many different components of many different component levels within a server computer or other distributed-computer-system components, such as network-attached storage devices, networking devices, and other distributed-computer-system components.

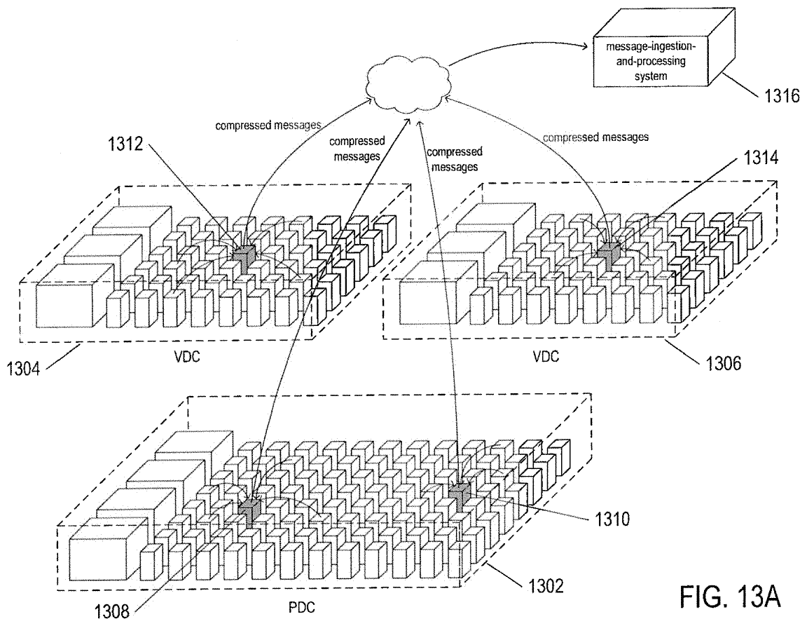

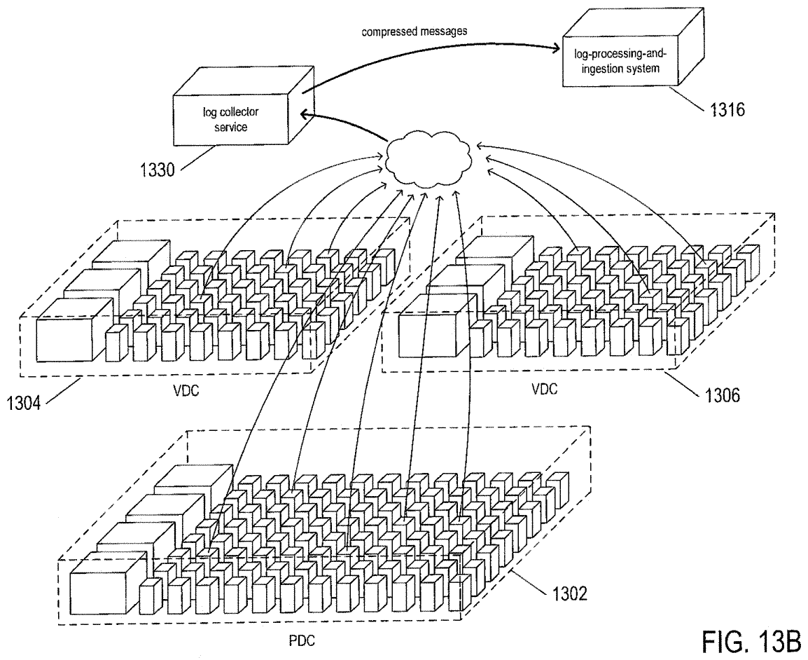

FIGS. 13A-13 illustrate two different types of log/event-message collection and forwarding within distributed computer systems. FIG. 13A shows a distributed computing system comprising a physical data center 1302 above which two different virtual data centers 1304 and 1306 are implemented. The physical data center includes two message collectors running within two physical servers 1308 and 1310. Each virtual data center includes a message collector running within a virtual server 1312 and 1314. The message collectors compress batches of the collected messages and forward the compressed messages to a message-processing-and-ingestion system 1316. In certain cases, each distributed computing facility owned and/or managed by a particular organization may include one or more message-processing-and-ingestion systems dedicated to collection and storage of log/event messages for the organization. In other cases, they message-processing-and-ingestion system may provide log/event-message collection and storage for multiple distributed computing facilities owned and managed by multiple different organizations. In this example, log/event messages may be produced and reported both from the physical data center as well as from the higher-level virtual data centers implemented above the physical data center. In alternative schemes, message collectors within a distributed computing system may collect log/event messages generated both at the physical and virtual levels.

FIG. 13B shows the same distributed computing system 1302, 1304, and 1306 shown in FIG. 13A. However, in the log/event-message reporting scheme illustrated in FIG. 13B, log/event messages are collected by a remote message-collector service 1330 which then forwards the collected log/event messages to the message-processing-and-ingestion system 1316.

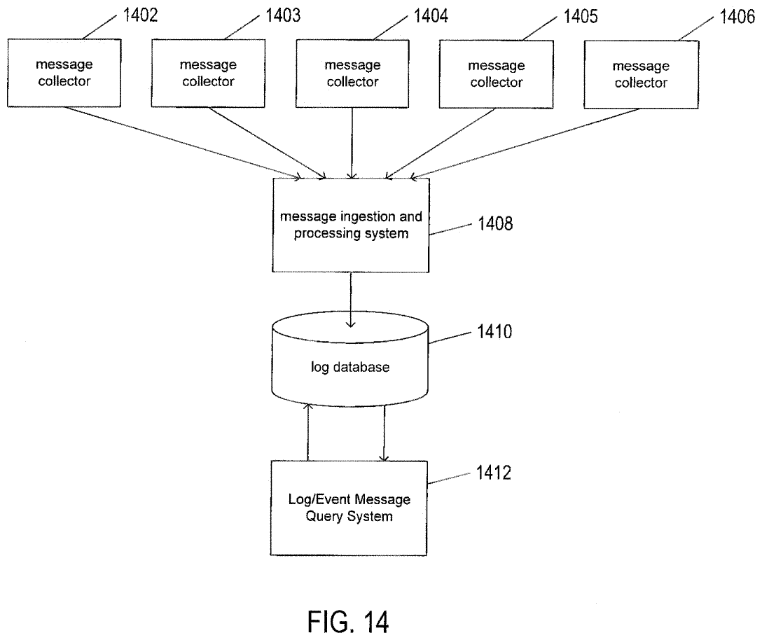

FIG. 14 provides a block diagram of a generalized log/event-message system incorporated within one or more distributed computing systems. The message collectors 1402-1406 receive log/event messages from log/event-message sources, including hardware devices, operating systems, virtualization layers, guest operating systems, and applications, among other types of log/event-message sources. The message collectors generally accumulate a number of log/event messages, compress them using any of commonly available data-compression methods, and send the compressed batches of log/event messages to a message-ingestion-and-processing system 1408. The message-ingestion-and-processing system decompresses received batches of messages, carry out any of various types of message processing, such as generating alerts for particular types of messages, filtering the messages, and normalizing the messages, prior to storing some or all of the messages in a message database 1410. A log/event-message query-processing system 1412 receives queries from distributed-computer-system administrators and managers, as well as from automated administration-and-management systems, and accesses the message database 1410 to retrieve stored log/event messages and/or information extracted from log/event messages specified by the receive queries for return to the distributed-computer-system administrators and managers and automated administration-and-management systems.

As discussed above, enormous volumes of log/event messages are generated within modern distributed computing systems. As a result, message collectors are generally processor-bandwidth bound and network-bandwidth bound. The volume of log/event-message traffic can use a significant portion of the intra-system and inter-system networking bandwidth, decreasing the network bandwidth available to support client applications and data transfer between local applications as well as between local applications and remote computational entities. Loaded networks generally suffer significant message-transfer latencies, which can lead to significant latencies in processing log/event messages and generating alerts based on processed log/event messages and to delayed detection and diagnosis of potential and incipient operational anomalies within the distributed computing systems. Message collectors may use all or significant portion of the network bandwidth and computational bandwidth of one or more servers within a distributed computer system, lowering the available computational bandwidth for executing client applications and services. Message-ingestion-and-processing systems are associated with similar network-bandwidth and processor-bandwidth overheads, but also use large amounts of data-storage capacities within the computing systems in which they reside. Because of the volume of log/event-message data stored within the message database, many of the more complex types of queries executed by the log/event-message query system against the stored log/event-message data may be associated with significant latencies and very high computational overheads. As the number of components within distributed computing systems increases, the network, processor-bandwidth, and storage-capacity overheads can end up representing significant portions of the total network bandwidth, computational bandwidth, and storage capacity of the distributed computing systems that generate log/event messages.

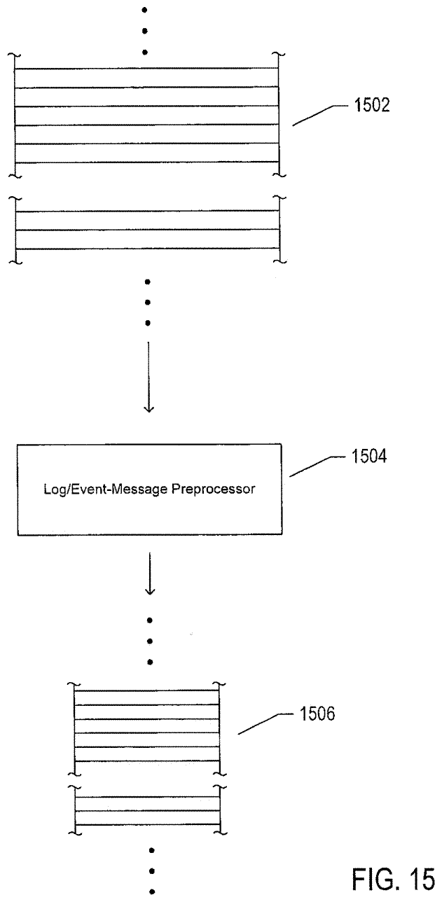

One approach to addressing the above-discussed problems is to attempt to preprocess log/event messages in ways that decrease the volume of data in a log/event-message stream. FIG. 15 illustrates log/event-message preprocessing. As shown in FIG. 15, an input stream of log/event messages 1502 is preprocessed by a log/event-message preprocessor 1504 to generate an output stream 1506 of log/event messages that represents a significantly smaller volume of data. Preprocessing may include filtering received log/event messages, compressing received log/event messages, and applying other such operations to received log/event messages that result in a decrease in the data volume represented by the stream of log/event messages output from the preprocessing steps.

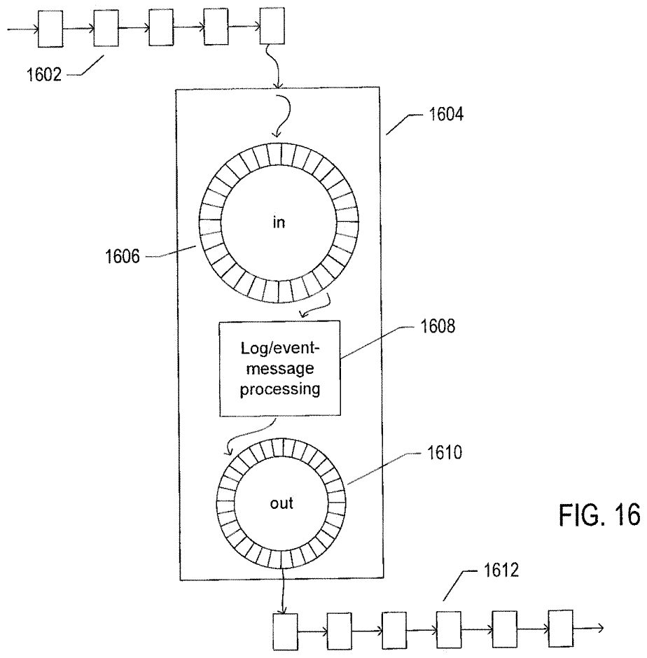

FIG. 16 illustrates processing of log/event messages by a message-collector system or a message-ingestion-and-processing system. An input stream of event/log messages 1602 is received by data-transmission components of the system 1604 and placed in an in queue 1606. Log/event-message processing functionality 1608 processes log/event messages removed from the in queue and places resulting processed log/event messages for transmission to downstream processing components in an out queue 1610. Data-transmission components of the system remove processed log/event messages from the out queue and transmit them via electronic communications to downstream processing components as an output log/event-message stream 1612. Downstream components for message-collector systems primarily include message-ingestion-and-processing systems, but may include additional targets, or destinations, to which log/event-messages are forwarded or to which alerts and notifications are forwarded. Downstream components for message-ingestion-and-processing systems primarily include log/event-message query systems, which store log/event messages for subsequent retrieval by analytics systems and other log/event-message-consuming systems within a distributed computer system, but may also include additional targets, or destinations, to which log/event-messages are forwarded or to which alerts and notifications are forwarded as well as long-term archival systems.

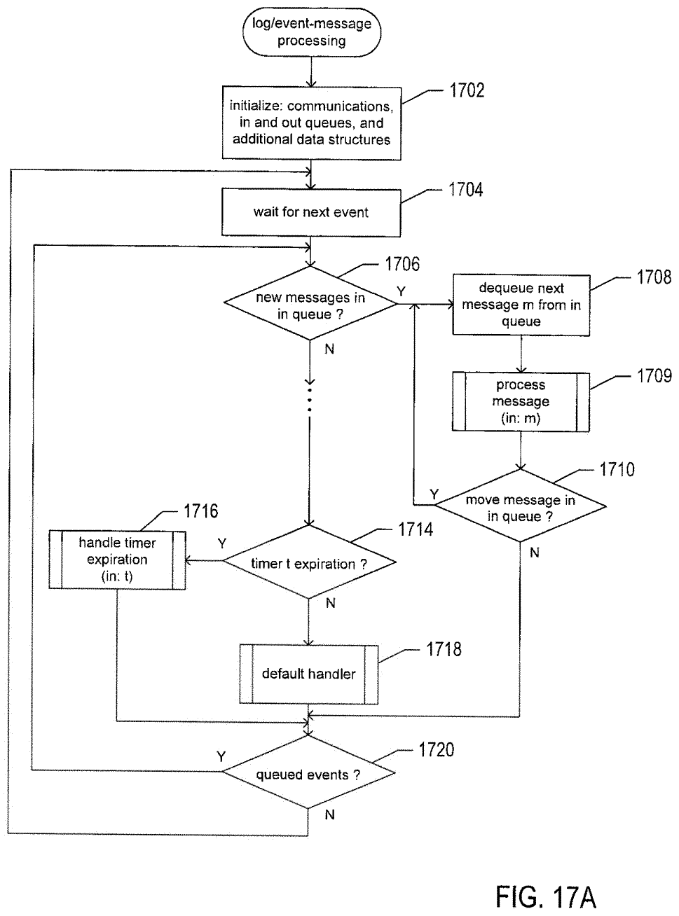

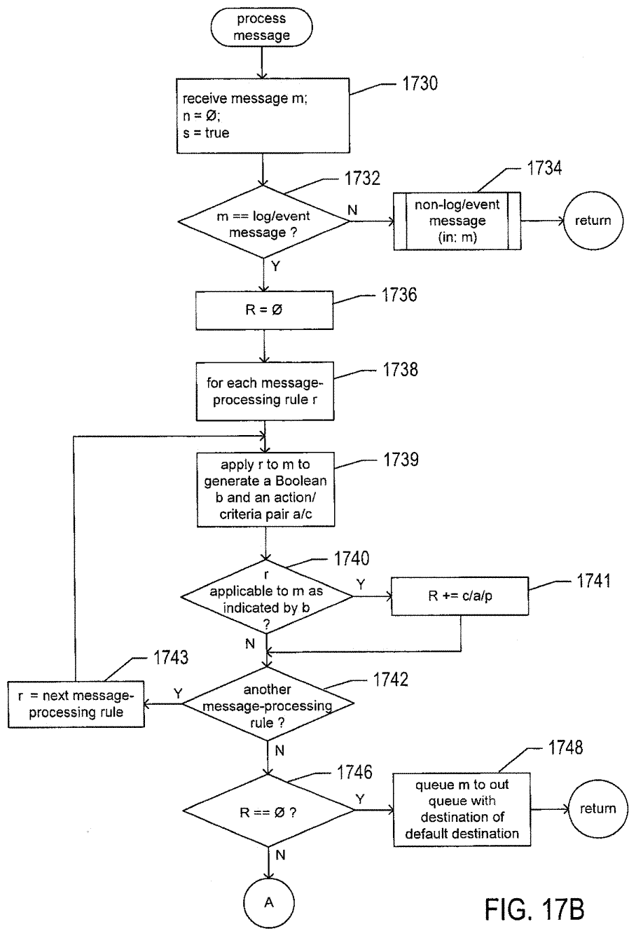

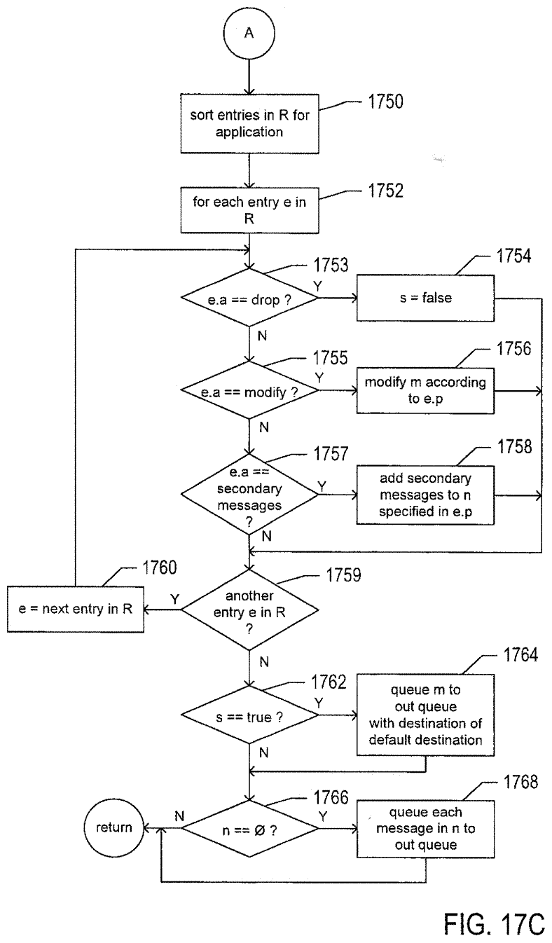

FIGS. 17A-C provide control-flow diagrams that illustrate log/event-message processing within currently available message-collector systems and message-ingestion-and-processing systems. FIG. 17A shows a highest-level control-flow diagram in which the log/event-message processing logic is represented as an event loop. In step 1702, log/event-message processing is initialized by initializing communications connections, through which log/event messages are received and to which processed log/event messages are output for transmission to downstream components, by initializing the in and out queues, and by initializing additional data structures. In step 1704, the log/event-message processing logic waits for a next event to occur. When a next event occurs, and when the next-occurring event is reception of one or more new messages, as determined in step 1706, messages are dequeued from the in queue and processed in the loop of steps 1708-1710. For each dequeued message, the routine “process message” is called in step 1709. Ellipsis 1712 indicates that there may be many additional types of events that are handled by the event loop shown in FIG. 17A. When the next-occurring event is a timer expiration, as determined in step 1714, a timer-expiration handler is called in step 1716. A default handler 1718 handles any rare or unexpected events. When there are more events queued for processing, as determined in step 1720, control returns to step 1706. Otherwise, control returns to step 1704, where the log/event-message-processing logic waits for the occurrence of a next event.

FIGS. 17B-C provide a control-flow diagram for the routine “process message” called in step 1709 of FIG. 17A. In step 1730, the routine “process message” receives a message in, sets a set variable n to null, and sets a Boolean variable s to TRUE. When the received message is not a log/event message, as determined in step 1732, a routine is called to process the non-log/event message, in step 1734, and the routine “process message” terminates. Processing of non-log/event messages is not further described. When the received message is a log/event message, as determined in step 1732, a set variable R is set to null, in step 1736. In the for-loop of steps 1738-1743, the routine “process message” attempts to apply each rule r of a set of processing rules to the received message to determine whether or not the rule r applies to the message. When the currently considered processing rule r is applicable to the message, as determined in steps 1739 and 1740, the rule is added to the set of rules contained in the set variable R, in step 1741. As discussed below, a processing rule consists of a Boolean expression representing the criteria for applicability of the rule, c, an action a to be taken when the rule applies to a message, and any of various parameters p used for rule application. Thus, in step 1741, the rule added to the set of rules contained in set variable R is shown as the criteria/action/parameters triple c/a/p. When, following execution of the for-loop of steps 1738-1743, the set variable R contains no applicable rules, as determined in step 1746, the received message In is added to the out queue, in step 1748, for transmission to downstream processing components. Otherwise, the applicable rules are applied to the received message m as shown in FIG. 17C. First, the rules stored in set variable R are sorted into an appropriate rule sequence for application to the message, in step 1750. Sorting of the rules provides for message-processing efficiency and correctness. For example, if one of the applicable rules specifies that the message to be dropped, but another of the applicable rules specifies that a copy of the message needs to be forwarded to a specified target or destination, the rule that specifies forwarding of the copy of the message should be processed prior to processing the rule that specifies that the message is to be dropped, unless the latter rule is meant to exclude prior message forwarding. In the for-loop of steps 1752-1760, each rule of the sorted set of rules in the set variable R is applied to the received message m. When the currently considered rule indicates that the message should be dropped, as determined in step 1753, the local variable s is set to FALSE, in step 1754. When the currently considered rule indicates that the received message m needs to be modified, as determined in step 1755, the modification is carried out in step 1756. When the currently considered rule indicates that secondary messages, such as forwarded copies, notifications, or alerts should be transmitted to target destinations, as determined in step 1757, the secondary messages are generated and placed in the set variable n, in step 1758. Following completion of the for-loop of steps 1752-1760, when the local variable s has the value TRUE, as determined in step 1762, the received message in is queued to the out queue, and step 1764, for transmission to the default destination for messages for the system, such as a message-ingestion-and-processing system, in the case of a message collector system, or a log/event-message query system, in the case of a message-ingestion-and-processing system. When the local set variable n is not empty, as determined in step 1766, each secondary message contained in local set variable n is queued to the out queue for transmission, in step 1768.

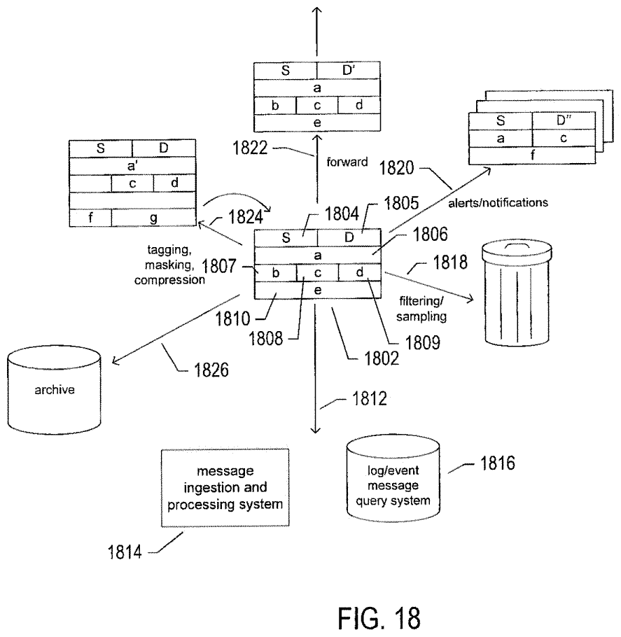

FIG. 18 illustrates various common types of initial log/event-message processing carried out by message-collector systems and/or message-ingestion-and-processing systems. A received log/event message 1802 is shown in the center of FIG. 18. In this example, the message contains source and destination addresses 1804-1805 in a message header as well as five variable fields 1806-1810 with field values indicated by the symbols “a,” “b,” “c,” “d,” and “e,” respectively. The message is generally transmitted to a downstream processing component, as represented by arrow 1812, where downstream processing components include a message-ingestion-and-processing system 1814 and a log/event-message query system 1860. Transmission of the message to a downstream processing component occurs unless a processing rule specifies that the transmission should not occur. Alternatively, the message may be dropped, as indicated by arrow 1818, due to a filtering or sampling action contained in a processing rule. Sampling involves processing only a specified percentage p of log/event messages of a particular type or class and dropping the remaining 1-p percentage of the log/event messages of the particular type or class. Filtering involves dropping, or discarding, those log/event messages that meet a specified criteria. Rules may specify that various types of alerts and notifications are to be generated, as a result of reception of a message to which the rule applies, for transmission to target destinations specified by the parameters of the rule, as indicated by arrow 1820. As indicated by arrow 1822, a received log/event message may be forwarded to a different or additional target destinations when indicated by the criteria associated with a processing rule. As indicated by arrow 1824, processing rules may specify that received log/event messages that meet specified criteria should be modified before subsequent processing steps. The modification may involve tagging, in which information is added to the message, masking, which involves altering field values within the message to prevent access to the original values during subsequent message processing, and compression, which may involve deleting or abbreviating fields within the received log/event message. Arrow 1826 indicates that a rule may specify that a received message is to be forwarded to a long-term archival system. These are but examples of various types of initial log/event-message processing steps that that may be carried out by message collectors and/or message-ingestion-and-processing systems when specified by applicable rules.

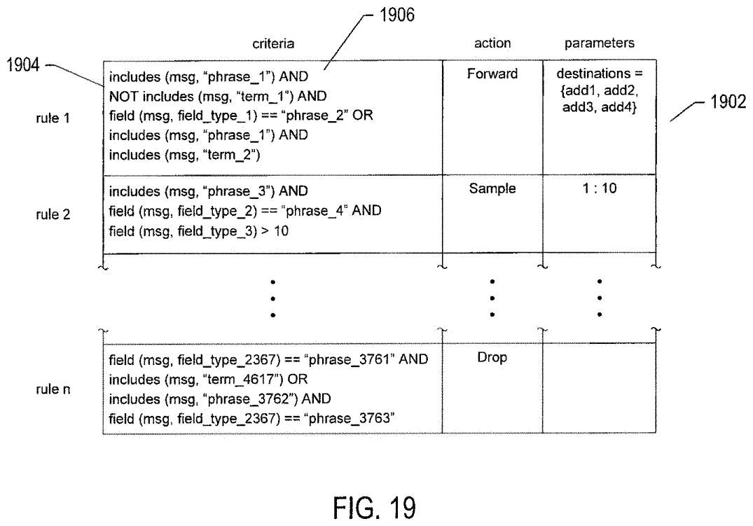

FIG. 19 illustrates processing rules that specify various types of initial log/event-message processing. The processing rules are contained in a table 1902 shown in FIG. 19. As discussed above, each rule comprises a Boolean expression that includes the criteria for rule applicability, an action, and parameters used for carrying out the actions. In the table 1902 shown in FIG. 19, each row of the table corresponds to a rule. A first, rule 1, 1904, is applied to a log/event message when application of the Boolean expression 1906 to the log/event message returns a value TRUE. This expression indicates that rule 1 is applicable to a log/event message msg when the message includes a first phrase phrase . . . 1, does not include a first term term . . . 1, and includes, as the value of a first field, a second phrase phrase . . . 2 or when the message includes the first phrase phrase . . . 1 as well as a second term terms . . . 2. When the criteria are met by a log/event message, the log/event message is specified, by the rule, to be forwarded to four destinations with addresses add1, add2, add3, and add4. The placeholders phrase . . . 1, phrase . . . 2, term . . . 1, term . . . 2, add1, add2, add3, and add4 in the expression stand for various particular character strings and/or alphanumeric strings. The rules shown in FIG. 19, of course, are only hypothetical examples of the types of log/event-message processing rules that might be employed by initial-log/event-message-processing logic within message collectors and message-ingestion-and-processing systems.

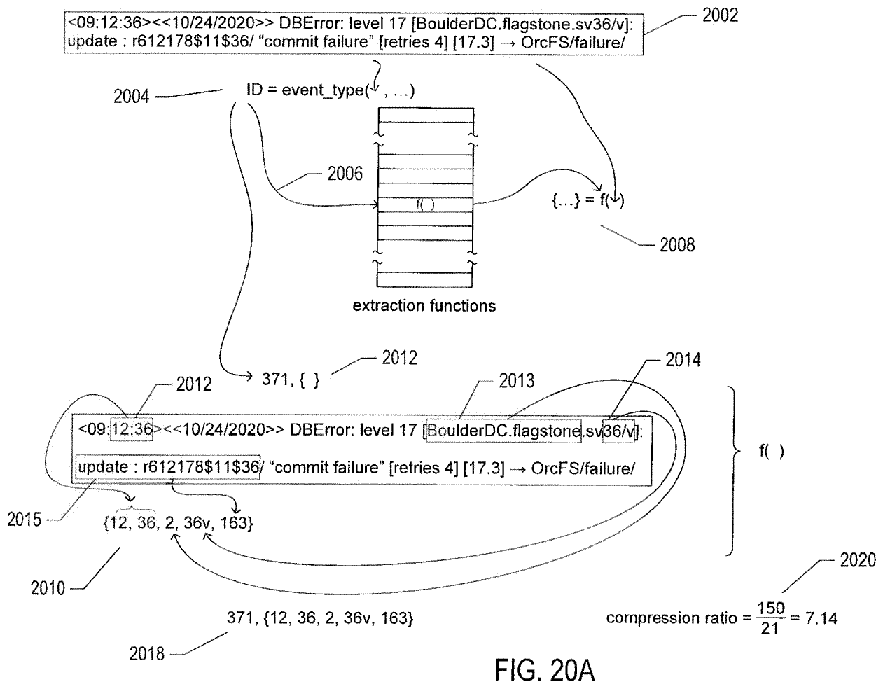

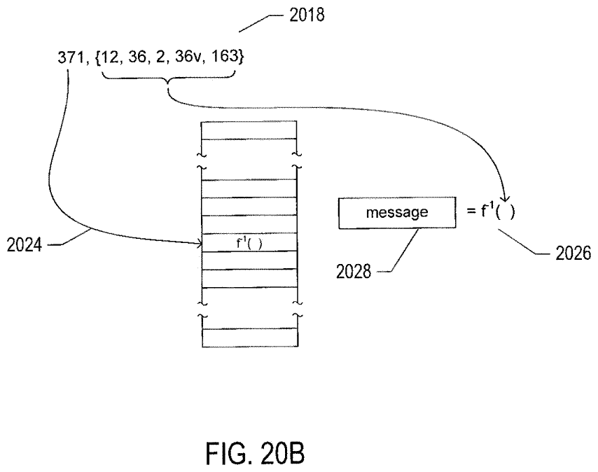

FIGS. 20A-B illustrate a log/event-message-type generation method. A hypothetical log/event message 2002 is shown at the top of FIG. 20A. As is typical for log/event messages, log/event message 2002 includes numerous formatted fields and phrases with significant meanings that cannot be discerned from the contents of the log/event message, alone. Either by automated, semi-automated, or manual means, a log/event message can be processed to determine a message type, referred to below as an “event type,” corresponding to the message and to determine a list of numeric values and/or character strings that correspond to variables within a log/event message. In other words, log/event messages are associated with types and log/event messages contain static and relatively static portions with low information content and variable portions with high information content. As shown in FIG. 20 A, log/event message 2002 can be automatically processed 2004 to generate an event type, referred to as “ID” in FIGS. 20A-B. This processing is encapsulated in the function event_type( ). Implementation of the function event_type( ) can vary, depending on the distributed computing systems that generate the log/error messages. In certain cases, relatively simple pattern-matching techniques can be used, along with regular expressions, to determine the event type for a given log/error message. In other implementations, a rule-based system or a machine-learning system, such as a neural network, can be used to generate an event type for each log/error message and/or parse the log/error message. In certain cases, the event type may be extracted from an event-type field of event messages as a numerical or character-string value. The event type can then be used, as indicated by curved arrow 2006 in FIG. 20A, to select a parsing function ƒ( ) for the event type that can be used to extract the high-information-content, variable values from the log/event message 2008. The extracted variable values are represented, in FIG. 20A and subsequent figures, by the notation “{ . . . },” or by a list of specific values within curly brackets, such as the list of specific values “{12, 36, 2, 36v, 163}” 2010 shown in FIG. 20A. As a result, each log/event message can be alternatively represented as a numerical event type, or identifier, and a list of 0, 1, or more extracted numerical and/or character-string values 2012. In the lower portion of FIG. 20A, parsing of log/event message 2002 by a selected parsing or extraction function ƒ( ) is shown. The high-information variable portions of the log/event message are shown within rectangles 2012-2015. These portions of the log/event message are then extracted and transformed into the list of specific values “{12, 36, 2, 36v, 163}” 2010. Thus, the final form of log/event message 2002 is an ID and a compact list of numeric and character-string values 2018, referred to as an “event tuple.” As shown in FIG. 20B, there exists an inverse process for generating the original log/error message from the expression 2018 obtained by the compression process discussed above with reference to FIG. 20A. The event type, or ID, is used to select, as indicated by curved arrow 2024, a message-restoration function ƒ¹( ) which can be applied 2026 to the expression 2018 obtained by the event-tuple-generation process to generate the original message 2028. In certain implementations, the decompressed, or restored, message may not exactly correspond to the original log/event message, but may contain sufficient information for all administration/management needs. In other implementations, message restoration restores the exact same log/event message that was compressed by the process illustrated in FIG. 20A.

A variety of techniques and approaches to generating or implementing the above-discussed event_type( ) function and extraction and message-restoration functions ƒ( ) and ƒⁱ( ) are possible. In certain cases, these functions can be prepared manually from a list of well-understood message types and message formats. Alternatively, these functions can be generated by automated techniques, including clustering techniques, or implemented by machine-learning techniques.

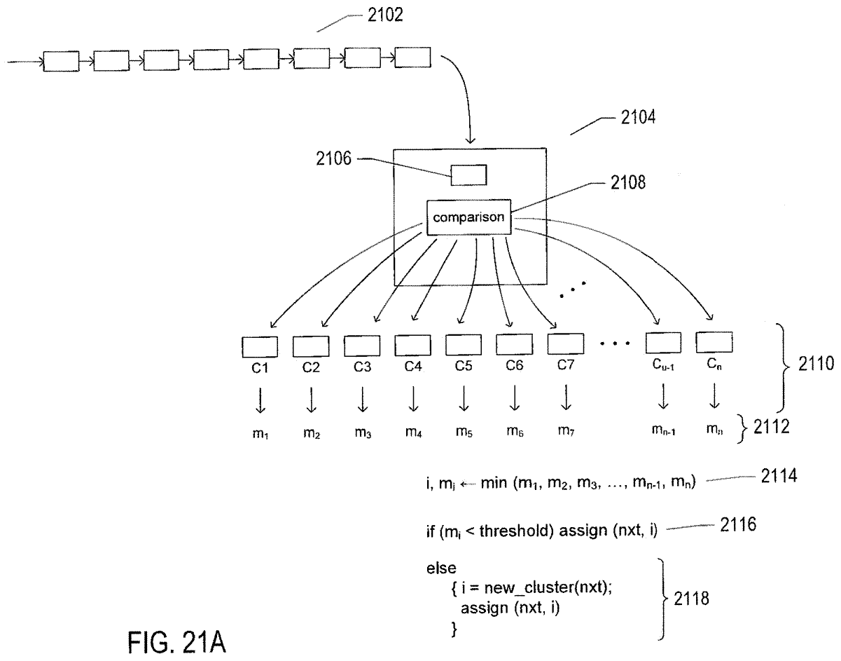

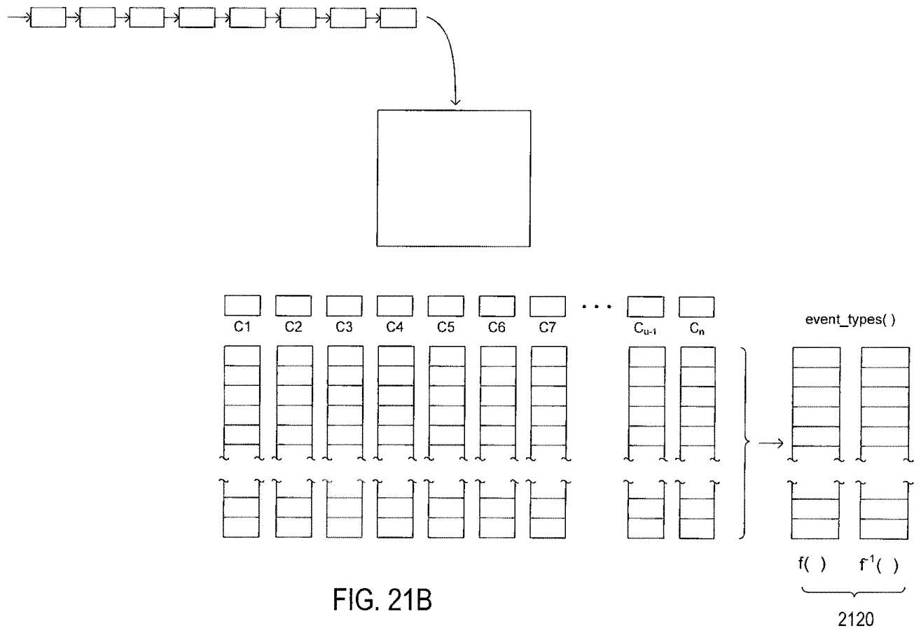

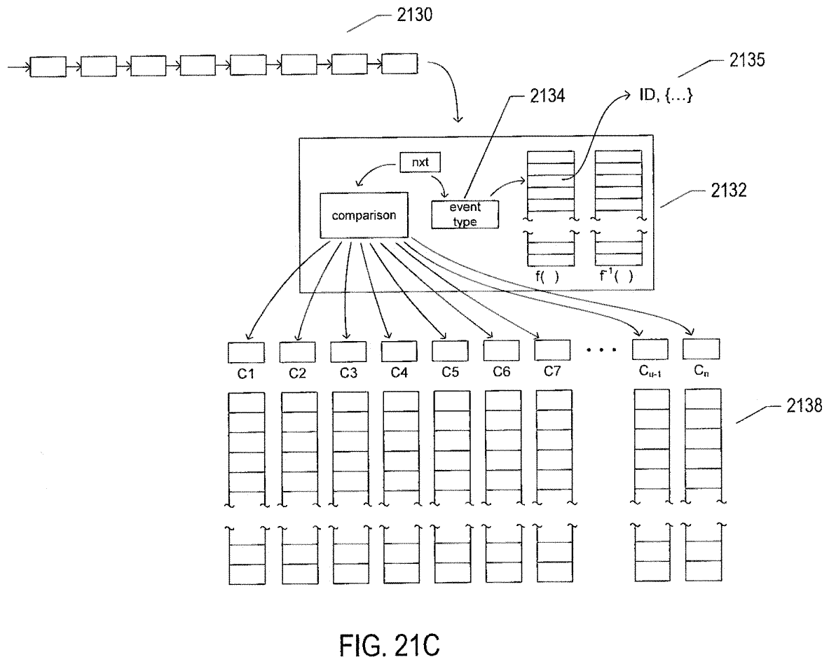

FIGS. 21A-C illustrate a clustering technique for generating an event_type( ) function and extraction and message-restoration functions ƒ( ) and ƒ¹( ).

As shown in FIG. 21A, incoming log/event messages 2102 are input sequentially to a clustering system 2104. Each message 2106 is compared, by a comparison function 2108, to prototype messages representative of all of the currently determined clusters 2110. Of course, initially, the very first log/event message becomes the prototype message for a first cluster. A best comparison metric and the associated cluster are selected from the comparison metrics 2112 generated by the comparison function 2114. An example shown in FIG. 21A, the best comparison metric is the metric with the lowest numerical value. In this case, when the best comparison metric is a value less than a threshold value, the log/event message 2106 is assigned to the cluster associated with the best comparison metric 2116. Otherwise, the log/event message is associated with the new cluster 2118. As shown in FIG. 21B, this process continues until there are sufficient number of log/event messages associated with each of the different determined clusters, and often until the rate of new-cluster identification falls below a threshold value, at which point the clustered log/event messages are used to generate sets of extraction and message-restoration functions ƒ( ) and ƒ¹( ) 2120. Thereafter, as shown in FIG. 21C, as new log/event messages 2130 are received, the fully functional clustering system 2132 generates the event-type/variable-portion-list expressions for the newly received log/event messages 2134-2135 using the current event_type( ) function and sets of extraction and message-restoration functions ƒ( ) and ƒ¹( ) but also continues to cluster a sampling of newly received log/event messages 2138 in order to dynamically maintain and evolve the set of clusters, the event_type( ) function, and the sets of extraction and message-restoration functions ƒ( ) and ƒ¹( ).

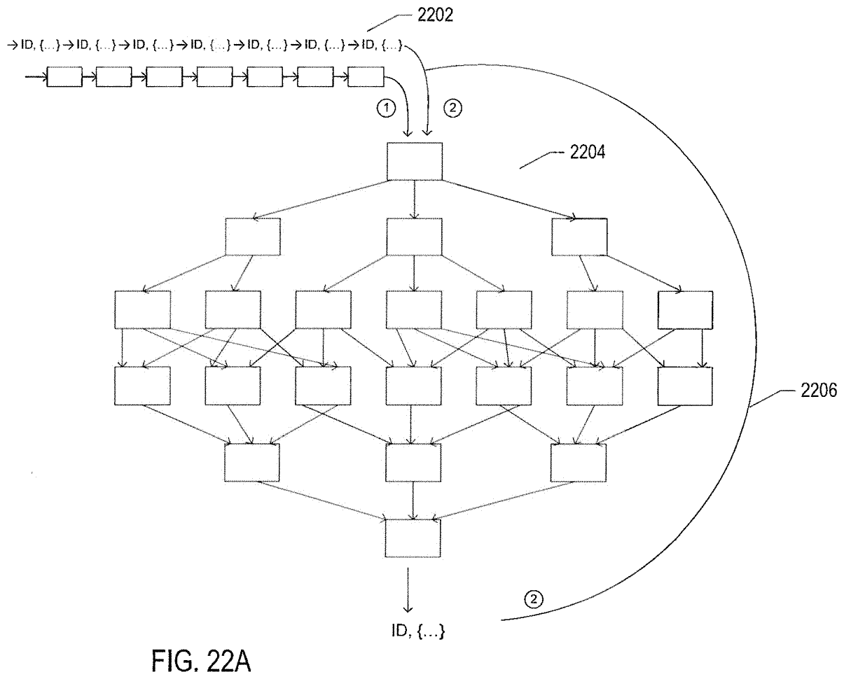

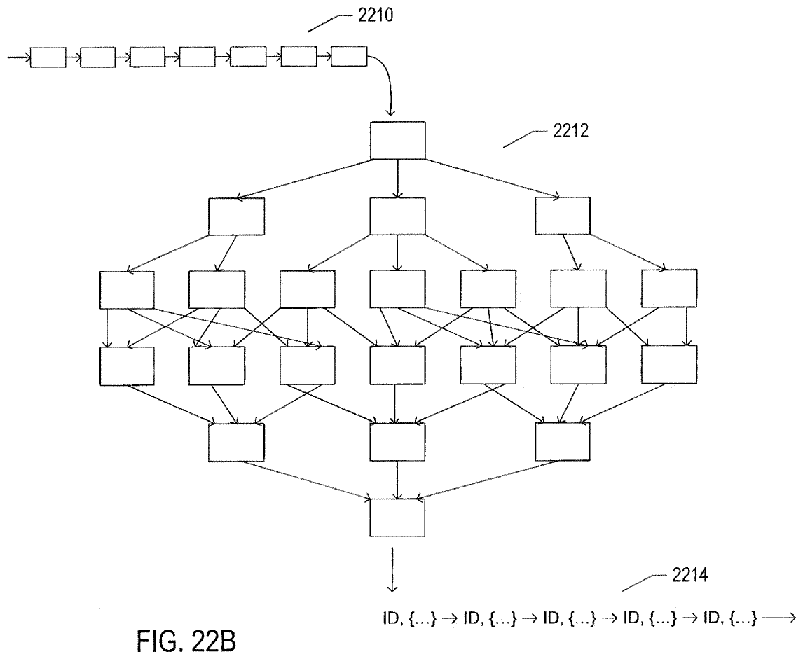

FIGS. 22A-B illustrate a machine-learning technique for generating an event_type( ) function and extraction and message-restoration functions ƒ( ) and ƒ¹( ). As shown in FIG. 22A, a training data set of log/event messages and corresponding compressed expressions 2202 is fed into a neural network 2204, which is modified by feedback from the output produced by the neural network 2206. The feedback-induced modifications include changing weights associated with neural-network nodes and can include the addition or removal of neural-network nodes and neural-network-node levels. As shown in FIG. 22B, once the neural network is trained, received log/event messages 2210 are fed into the trained neural network 2212 to produce corresponding compressed-message expressions 2214. As with the above-discuss clustering method, the neural network can be continuously improved through feedback-induced neural-network-node-weight adjustments as well as, in some cases, topological adjustments.

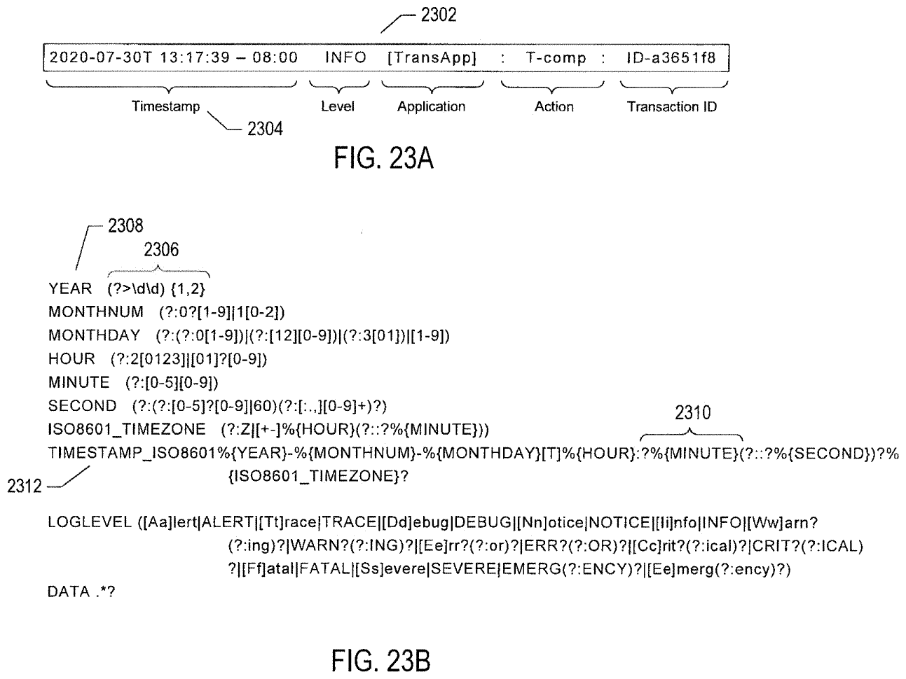

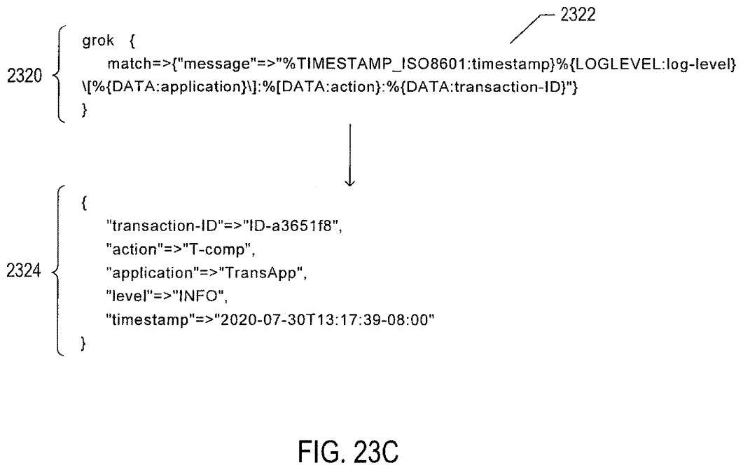

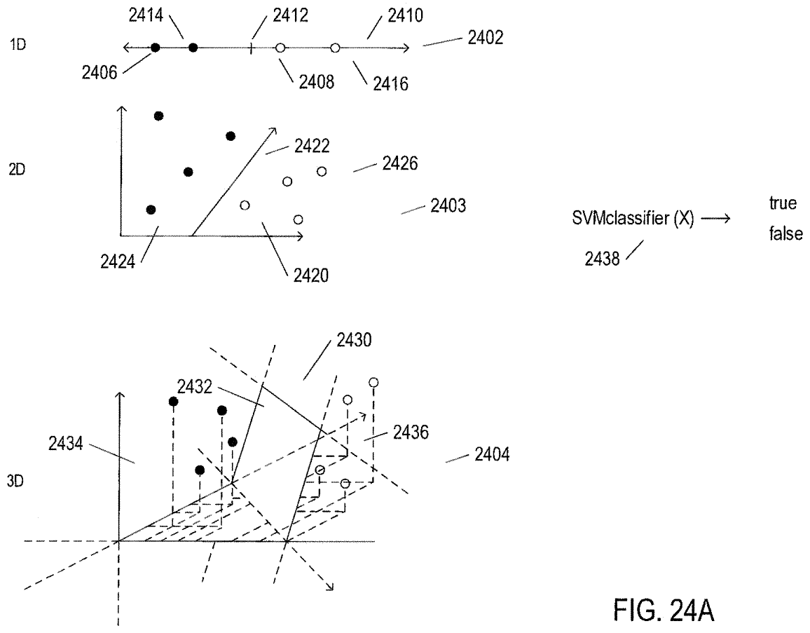

FIGS. 23A-C illustrate one approach to extracting fields from a log/event message. Log/event messages may be understood as containing discrete fields, but, in practice, they are generally alphanumeric character strings. An example log/event message 2302 is shown at the top of FIG. 23A. The five different fields within the log/event message are indicated by labels, such as the label “timestamp” 2304, shown below the log/event message. FIG. 238 includes a variety of labeled regular expressions that are used, as discussed below with reference to FIG. 23C, to extract the values of the discrete fields in log/event message 2302. For example, regular expression 2306 follows the label YEAR 2308. When this regular expression is applied to a character string, it matches either a four-digit indication of a year, such as “2020,” or a two-digit indication of the year, such as “20.” The string “\d\d” matches two consecutive digits. The “(?>” and “)” characters surrounding the string “\d\d” indicates an atomic group that prevents unwanted matches to pairs of digits within strings of digits of length greater than two. The string “{1, 2}” indicates that the regular expression matches either one or two occurrences of a pair of digits. A labeled regular expression can be included in a different regular expression using a preceding string “%{” and a following symbol “},” as used to include the labeled regular expression MINUTE (2310 in FIG. 23B) in the labeled regular expression TIMESTAMP_ISO8601 (2312 in FIG. 23B). There is extensive documentation available for the various elements of regular expressions.

Grok parsing uses regular expressions to extract fields from log/event messages. The popular Logstash software tool uses grok parsing to extract fields from log/event messages and encode the fields according to various different desired formats. For example, as shown in FIG. 23C, the call to the grok parser 2320 is used to apply the quoted regular-expression pattern 2322 to a log/event message with a format of the log/event message 2302 shown in FIG. 23A, producing a formatted indication of the contents of the fields 2324. Regular-expression patterns for the various different types of log/event messages can be developed to identify and extract fields from the log/event messages input to message collectors. When the grok parser unsuccessfully attempts to apply a regular-expression pattern to a log/event message, an error indication is returned. The Logstash tool also provides functionalities for transforming input log/event messages into event tuples. The regular-expression patterns, as mentioned above, can be specified by log/event-message-system users, such as administrative personnel, can be generated by user interfaces manipulated by log/event-message-system users, or may be automatically generated by machine-learning-based systems that automatically develop efficient compression methods based on analysis of log/event-message streams.

### Support Vector Machines

FIGS. 24A-B illustrate a type of classifier referred to as a support vector machine (“SVM”). In general, a classifier receives input data and returns a value that represents a characteristic of the data. A binary classifier produces one of two possible output values, such as {0, 1}. {male, female}, or {true, false}. Multiple-class SVM classifiers return one of multiple different possible classifications, such as one particular log source from among a set that includes all possible log sources. An SVM is generally trained, using training input data points for which desired output values are known, to partition a data-point space into a number of regions equal to the number of possible classifications, such as two regions for a binary classifier. Following training, the SVM, upon input of a data point with an unknown output value, determines in which of the partitions of the data-point space the input data point is located and returns the output value associated with the partition of the data-point space in which the input data point is located. In FIG. 24A, example one-dimensional 2402, two-dimensional 2403, and three-dimensional 2404 binary SVMs are illustrated. In each example SVM, data points in a first partition are represented by filled disks, such as filled disk 2406, and data points in a second partition are represented by unfilled disks, such as unfilled disk 2408. In the one-dimensional SVM 2402, the horizontal line 2410 representing the data-point space is partitioned by a point on the line 2412 into a first, left-hand region 2414 and a second right-hand region 2416. In the two-dimensional SVM 2403, the plane 2420 representing the data-point space is partitioned by a line 2412 into a first region 2424 and a second region 2426. In the three-dimensional SVM 2404, the volume 2430 representing the data-point space is partitioned by a plane 2432 into a first region 2434 and a second region 2436. In these examples, each SVM classifier receives an input data point x and returns one of the two values {true, false} 2438.

FIG. 24B illustrates linear and non-linear binary SVMs. In a linear SVM 2440, the partition 2442 is an (n−1)-dimensional object within an n-dimensional data-point space. The partition can therefore be described by the expression 2444:

w·x+b=0,
where w is a vector normal to the partition,
   x is a data point on or within the partition, and
   b is a constant.
      The value

$$\frac{- b}{\vert w \vert}$$

is the shortest distance 2446 from the origin 2448 to the partition 2442. There are two additional partition-like elements 2450 and 2452 on either side of the partition 2442 with equations:

w·x+b=1, and

w·x+b=−1.

The shortest distance between the partition and the additional partition-like elements 2450 and 2452 is |w|, the magnitude of vector w. The SVM is constructed by determining an equation for the partition that correctly partitions the two different sets of data points and that minimizes as an optimization problem. A non-linear SVM 2456 can be generated by replacing the dot-product operation with a function k( ):

w·x→k(w,x),

which is equivalent to a vector-space transform ϕ

w*=ϕ(w),

x*ϕ(x)

that transforms vectors in an original vector space S to a transformed vector space S*. The same optimization method can be used to generate a linear partition in the transformed vector space which is generally a curved partition in the original vector space. The examples shown in FIGS. 24A-B are binary SVMs, to facilitate clear illustration. The illustrated concepts are straightforwardly extended to multi-class SVMs.

### K-Means Clustering

FIGS. 25A-D illustrate data-set clustering using one of many different variations of K-means clustering. The two examples used in these figures are two-dimensional, for ease of illustration. As discussed further, below, the various types of K-means clustering and other clustering processes are straightforwardly extended to higher-dimensional datasets. Indeed, a simple C++ implementation of one example of one K-means-clustering variant, provided below, carries out clustering in a metric-data space of arbitrary dimension.

FIG. 25A illustrates a first example two-dimensional dataset. Each data point, such as data point 2502, represents an observation that includes data values for 2 metrics. The first metric is represented by the horizontal axis 2503 and the second metric is represented by the vertical axis 2504. Each data point is thus the head of a two-dimensional vector.

The clustering process receives, as input: (1) K, an integer specifying the desired number of clusters; (2) L, an integer specifying the desired number of outlier data points; (3) P, an integer specifying of the number of dimensions, or metrics; (4) a distance function that computes the distance between any two locations in a P-dimensional metric space; and (5) a dataset that includes N P-dimensional observations. The clustering process than identifies locations of each of K clusters of data points and identifies L outlier data points, with each data point in the P-dimensional dataset either belonging to one of the K clusters or identified as one of the L outliers. The clustering process does not necessarily find an optimal clustering, where the optimal clustering would have a minimum sum of squared distances of the data points belonging to the K clusters to their cluster centers. However, the clustering process is guaranteed to converge on a locally optimal clustering.

A number of examples of clustering and outlier identification produced by clustering process are first discussed. FIG. 25B shows a clustering obtained for the dataset illustrated in FIG. 25A when K=2, L=10, and P=2 is input to the clustering process. In FIG. 25B, as in subsequently discussed figures, the identified centers of the clusters are marked with x-like symbols 2506 and 2507. The two clusters 2508 and 2509 are each indicated by a dashed boundary 2511 and 2512, as are the clusters in subsequently discussed figures. Those data points which do not lie within the boundary of the cluster, such as data point 2513, are outlier data points. For many of the clusterings shown in the figures, an error is reported, such as the error 2514 reported for the clustering shown in FIG. 25B. This is the square root of the sum of the squares of the distances of each data point within a cluster to that cluster's center. Were the input value K equal to the number of observations N and the input value L equal to 0, the clustering process would return K clusters, each with a center equal to an observation and with an error of 0. Were the input value K equal to 1 and the input value L equal to 0, the clustering process would return a single cluster with a center equal to the centroid of the distribution of data points. It would appear that the set of outlier data points in FIG. 25B could just as easily have been identified as a cluster. In fact, as shown in subsequently discussed figures, the clustering shown in FIG. 25B represents a decidedly non-optimal clustering that represents a local minimum within the hyper-dimensional surface of all possible clusterings.

FIG. 25C shows a clustering obtained for the dataset illustrated in FIG. 25A when K=3, L=10, and P=2 is input to the clustering process. The same points identified as outliers in the clustering shown in FIG. 25B are again identified as outliers in the clustering process illustrated in FIG. 25C. This is, in part, because at least two of the starting cluster centers are the same as in the clustering process that produced the results shown in FIG. 25B. FIG. 25D shows a clustering obtained for the dataset illustrated in FIG. 25A when K=3, L=2 among all 0, and P=2 is input to the clustering process. In this case, because the number of desired outliers doubled, the 3 clusters contain fewer data points. FIG. 25D shows a clusterings obtained for the dataset illustrated in FIG. 25A when K=4, L=10, and P=2 is input to the clustering process. Selecting clusterings with the lowest errors from a series of repeated clusterings with different initial cluster centers may represent an approach to identifying either a globally optimal clustering or a locally near-optimal clustering.

FIGS. 26A-G provide a simple C++ implementation of one version of the clustering process. A first set of constants 2602 in FIG. 26A specify the maximum expected values for arguments to the clustering methods, including the maximum expected number of dimensions, number of desired clusters, number of desired outliers, and number of observations in the dataset. The constant “Threshold” 2603 is the minimum shift in a cluster center between iterations of the clustering process that provokes a next iteration. It is this parameter that controls when a clustering is determined to have converged. The type definition “Point” 2604 defines a data type that contains the coordinates for a data point. The type definition “DistIndex” 2605 defines a data type that contains the distance between a data point and its cluster center as well as an index or identifier of the data point. The type definition “Dist” 2606 defines a pointer to a distance function that is applied by the clustering methods for calculating distances between data points and other locations in the transformed-metric space.

FIG. 26B includes the declaration of a class “clusteredData.” This class includes the data members: (1) dataPoints 2607, a pointer to a dataset; (2) numDataPoints 2608, the number of data points in the dataset; (3) dist 2609, a pointer to the distance function used to compute distances between data points: (4) k 2610, the number of desired clusters; (5) 12611, the number of desired outliers; (6) numD 2612, the number of dimensions of the dataset; (7) clusters 2613, a pointer to a current set of cluster centers; (8) newClusters 2614, a pointer to a next set of cluster centers; (9) split 2615, the number of data points in a sorted list of data points having the same distance to their cluster center following a data point identified as the first non-outlier data point; (10) clusters1 2616, an array of cluster centers; (11) clusters2 2617, an array of cluster centers; (12) minOutlierDistance 2618, the minimum distance of an outlier data point from a cluster center; (13) already 2619, an array of Boolean values indicating whether or not corresponding data points have been selected for initial cluster centers; (14) distances 2620, an array that includes the distances of data points from the cluster centers along with an index for each data point; (15) indexedDistances 2621, an array of distances of data points from their cluster centers; and (16) clustersAssignments 2622, an array that contains indications of the cluster to which each data point has been assigned.

The class “clusteredData” includes the following member functions: (1) init 2626, an initialization routine; (2) randomInitailClusters 2624, a method that randomly selects K data points as the initial cluster centers; (3) clusterDataPoints 2625, a method that assigns data points to a set of cluster centers, and thus clusters the data points; (4) recluster 2626, a method that determines new cluster centers as the centroids of a set of current clusters; (5) convergence 2627, a routine that determines whether or not the clustering process has converged; and (6) cluster 2628, the method that represents the clustering process.

FIG. 26C shows implementations of a function “compare,” used in a quicksort of data points distances and the member function “cluster.” The function “compare” 2630 compares the magnitudes of two distances within two DistIndex data structures and returns 1 if the first distance is less than the second distance, returns 0 if the first distance is equal to the second distance, and returns −1 if the first distances greater than the second distance. These values allow quicksort to sort an array of DistIndex structures in descending order by distance. The member function “cluster” implements of the clustering process discussed above with reference to FIGS. 21A-22B. The member function “cluster” receives, as input arguments, a pointer to the dataset 2632, the number of data points in the dataset 2633, the number of dimensions of the dataset 2634, a pointer to a distance function 2635, the desired number of clusters 2636, and the desired number of outlier data points 2637. In a first set of statements 2638, the input arguments are stored in local data members. The local-data-member pointer clusters is initialized to point to the array clusters1 and the local-data-member pointer newClusters is initialized to point to the array clusters2 in the next two statements 2639. The initialization routine is called in statement 2640. Then, the member function randomInitialClusters is called, in statement 2641, to select an initial set of data points, the locations of which are assigned as the centers of an initial set of K clusters. In statement 2642, the member function clusterDataPoints is called to assign all of the data points to the initial set of clusters, the centers for which were selected in the previous statement. Then, in the while-loop 2643, new cluster centers are computed via a call to the member function re-cluster, in statement 2644, and the member function convergence is called, in statement 2645, to determine whether or not clustering has converged around the current set of cluster centers. One clustering has converged, the member function cluster terminates. Otherwise, in the set of statements 2646, the cluster-center arrays pointed to by the pointers clusters and newCluster are switched, and the member function clusterDataPoints is called, in statement 2647, to recluster the data points around the new cluster centers computed by the member function recluster, in statement 2644. Thus, the clustering process is relatively straightforward. An initial set of K cluster centers is selected, the data points are clustered with respect to the initial set of K cluster centers, and then the clustering process iteratively computes new cluster centers and reclusters the data points about the new cluster centers until the process converges on a set of cluster centers that represent a local minimum, in most cases, but may fortuitously represent a global minimum.

FIG. 26D provides implementations of the initialization member function init and the member function randomInitialClusters. The initialization routine 2656 sets all the elements of the array already to FALSE. The member function randomInitialClusters randomly selects K data points, the locations of which become initial cluster centers, in the while-loop 2651. An index of a next data point is randomly selected, in statement 2652, and, provided that the data point is not already been used as a cluster center, as determined in statement 2653, places the coordinates of the data point into the array “clusters” as a next cluster center in the for-loop 2654.

FIG. 26E shows an implementation of the member function clusterDataPoints. In for-loop 2656, each data point is assigned to a cluster. In the for-loop, all of the cluster centers are considered in order to find the cluster center closest to the currently considered data point. The distance of a data point to its cluster center is recorded and the cluster assignment is recorded in the set of statements 2658. In statement 2659, the distances of the data points to their respective cluster centers is sorted in descending order by a quicksort routine. In statement 2660, the minimum outlier distance is determined as the Lth distance in the sorted array of distances of data points to their cluster centers. The first L distances in the sorted array of distances correspond to the identified L outlier data points, which are, by definition, the data points furthest away from a cluster center. Finally, in the set of statements 2661, the data member split is set to the number of distances in the array of sorted distances equal to the minimum outlier distance that follow the Lth distance in the array. Thus, clustering of data points is a straightforward process in which data points are assigned to the clusters with centers nearest to them and the L data points furthest away from cluster centers are identified as outliers.

FIG. 26F provides an implementation of the member function recluster. In the for-loop 2663, the two-dimensional array sum is initialized to 0 and the array kCount is initialized to 0. The two-dimensional array sum stores the sums of the coordinate components of the data points in each cluster and the array kCount stores a count of the number of data points in each cluster. In the for-loop 2664, all of the data points are considered. In a first set of statements 2665, the local variable valid is set to TRUE if the currently considered data point is not an outlier, and is otherwise set to FALSE. If the data point is not an outlier data point, each of its coordinate components is added to the sum of coordinate components for the data points in its cluster and the number of data points in the cluster is incremented, in the set of statements 2666. In a final doubly nested for-loop 2667, all of the sums of coordinate data points are divided by the number of data points in the cluster in order to compute the centroid of each cluster, and the centroid of each cluster is stored as a new cluster center in the array of cluster centers referenced by the pointer newClusters. Thus, the member function recluster computes new cluster centers for each cluster as the centroid of the data points currently assigned to the cluster.

FIG. 26G shows implementations of the member function convergence and a distance function. The member function convergence 2670 determines whether the center of any cluster has moved more than a threshold distance during the last clustering iteration and, if so, returns the Boolean value FALSE to indicate that clustering has not converged. Otherwise, the Boolean value TRUE is returned. The distance function 2671 computes the Euclidean distance in the transformed metric space between two data points or transformed-metric-space locations. The statement 2672 illustrates declaration of an instance of the class “clusteredData.” Statement 2673 illustrates invocation of the clustering process by calling the public member function cluster of an instance of the class clusteredData.

### Neural Networks

FIG. 27 illustrates the fundamental components of a feed-forward neural network. Equations 2702 mathematically represents ideal operation of a neural network as a function ƒ(x). The function receives an input vector x and outputs a corresponding output vector y 2703. For example, an input vector may be a digital image represented by a two-dimensional array of pixel values in an electronic document or may be an ordered set of numeric or alphanumeric values. Similarly, the output vector may be, for example, an altered digital image, an ordered set of one or more numeric or alphanumeric values, an electronic document, one or more numeric values. The initial expression 2703 represents the ideal operation of the neural network. In other words, the output vectors y represent the ideal, or desired, output for corresponding input vector x. However, in actual operation, a physically implemented neural network \hat{ƒ}(x), as represented by expressions 2704, returns a physically generated output vector ŷ that may differ from the ideal or desired output vector y. As shown in the second expression 2705 within expressions 2704, an output vector produced by the physically implemented neural network is associated with an error or loss value. A common error or loss value is the square of the distance between the two points represented by the ideal output vector and the output vector produced by the neural network. To simplify hack-propagation computations, discussed below, the square of the distance is often divided by 2. As further discussed below, the distance between the two points represented by the ideal output vector and the output vector produced by the neural network, with optional scaling, may also be used as the error or loss. A neural network is trained using a training dataset comprising input-vector/ideal-output-vector pairs, generally obtained by human or human-assisted assignment of ideal-output vectors to selected input vectors. The ideal-output vectors in the training dataset are often referred to as “labels.” During training, the error associated with each output vector, produced by the neural network in response to input to the neural network of a training-dataset input vector, is used to adjust internal weights within the neural network in order to minimize the error or loss. Thus, the accuracy and reliability of a trained neural network is highly dependent on the accuracy and completeness of the training dataset.

As shown in the middle portion 2706 of FIG. 27, a feed-forward neural network generally consists of layers of nodes, including an input layer 2708, and output layer 2710, and one or more hidden layers 2712 and 2714. These layers can be numerically labeled 1, 2, 3, . . . , L, as shown in FIG. 27. In general, the input layer contains a node for each element of the input vector and the output layer contains one node for each element of the output vector. The input layer and/or output layer may have one or more nodes. In the following discussion, the nodes of a first level with a numeric label lower in value than that of a second layer are referred to as being higher-level nodes with respect to the nodes of the second layer. The input-layer nodes are thus the highest-level nodes. The nodes are interconnected to form a graph.

The lower portion of FIG. 27 (2720 in FIG. 27) illustrates a feed-forward neural-network node. The neural-network node 2722 receives inputs 2724-2727 from one or more next-higher-level nodes and generates an output 2728 that is distributed to one or more next-lower-level nodes 2730-2733. The inputs and outputs are referred to as “activations,” represented by superscripted-and-subscripted symbols “a” in FIG. 27, such as the activation symbol 2734. An input component 2736 within a node collects the input activations and generates a weighted sum of these input activations to which a weighted internal activation a₀ is added. An activation component 2738 within the node is represented by a function g( ), referred to as an “activation function.” that is used in an output component 2740 of the node to generate the output activation of the node based on the input collected by the input component 2736. The neural-network node 2722 represents a generic hidden-layer node. Input-layer nodes lack the input component 2736 and each receive a single input value representing an element of an input vector. Output-component nodes output a single value representing an element of the output vector. The values of the weights used to generate the cumulative input by the input component 2736 are determined by training, as previously mentioned. In general, the input, outputs, and activation function are predetermined and constant, although, in certain types of neural networks, these may also be at least partly adjustable parameters. In FIG. 27, two different possible activation functions are indicated by expressions 2740 and 2741. The latter expression represents a sigmoidal relationship between input and output that is commonly used in neural networks and other types of machine-learning systems.

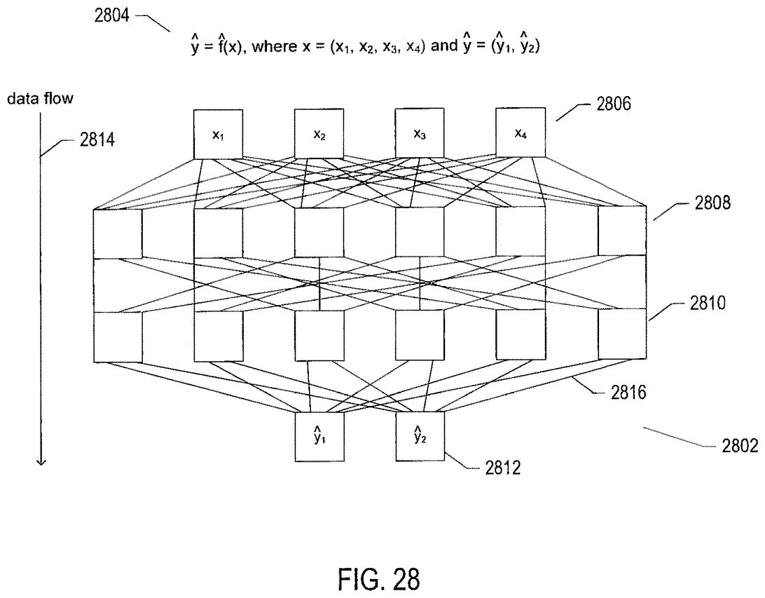

FIG. 28 illustrates a small, example feed-forward neural network. The example neural network 2802 is mathematically represented by expression 2804. It includes an input layer of four nodes 2806, a first hidden layer 2808 of six nodes, a second hidden layer 2810 of six nodes, and an output layer 2812 of two nodes. As indicated by directed arrow 2814, data input to the input-layer nodes 2806 flows downward through the neural network to produce the final values output by the output nodes in the output layer 2812. The line segments, such as line segment 2816, interconnecting the nodes in the neural network 2802 indicate communications paths along which activations are transmitted from higher-level nodes to lower-level nodes. In the example feed-forward neural network, the nodes of the input layer 2806 are fully connected to the nodes of the first hidden layer 2808, but the nodes of the first hidden layer 2808 are only sparsely connected with the nodes of the second hidden layer 2810. Various different types of neural networks may use different numbers of layers, different numbers of nodes in each of the layers, and different patterns of connections between the nodes of each layer to the nodes in preceding and succeeding layers.

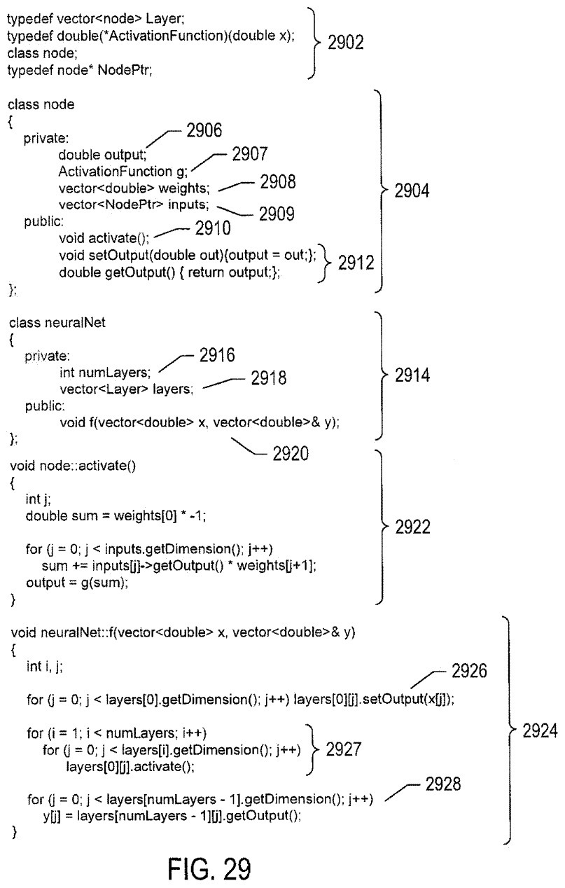

FIG. 29 provides a concise pseudocode illustration of the implementation of a simple feed-forward neural network. Three initial type definitions 2902 provide types for layers of nodes, pointers to activation functions, and pointers to nodes. The class node 2904 represents a neural-network node. Each node includes the following data members: (1) output 2906, the output activation value for the node: (2) g 2907, a pointer to the activation function for the node; (3) weights 2908, the weights associated with the inputs; and (4) inputs 2909, pointers to the higher-level nodes from which the node receives activations. Each node provides an activate member function 2910 that generates the activation for the node, which is stored in the data member output, and a pair of member functions 2912 for setting and getting the value stored in the data member output. The class neuralNet 2914 represents an entire neural network. The neural network includes data members that store the number of layers 2916 and a vector of node-vector layers 2918, each node-vector layer representing a layer of nodes within the neural network. The single member function ƒ 2920 of the class neuralNet generates an output vector v for an input vector x. An implementation of the member function activate for the node class is next provided 2922. This corresponds to the expression shown for the input component 2736 in FIG. 27. Finally, an implementation for the member function ƒ 2924 of the neuralNet class is provided. In a first for-loop 2926, an element of the input vector is input to each of the input-layer nodes. In a pair of nested for-loops 2927, the activate function for each hidden-layer and output-layer node in the neural network is called, starting from the highest hidden layer and proceeding layer-by-layer to the output layer. In a final for-loop 2928, the activation values of the output-layer nodes are collected into the output vector y.

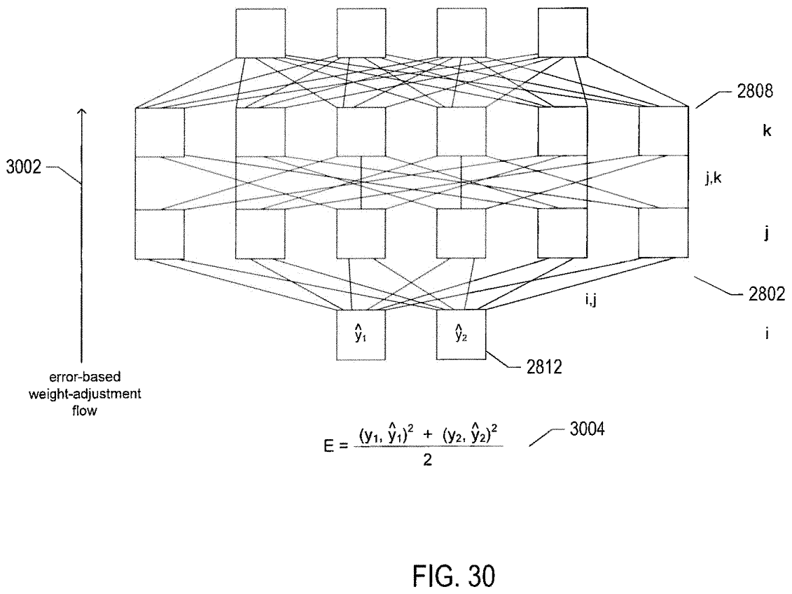

FIG. 30, using the same illustration conventions as used in FIG. 28, illustrates back propagation of errors through the neural network during training. As indicated by directed arrow 3002, the error-based weight adjustment flows upward from the output-layer nodes 2812 to the highest-level hidden-layer nodes 2808. For the example neural network 2802, the error, or loss, is computed according to expression 3004. This loss is propagated upward through the connections between nodes in a process that proceeds in an opposite direction from the direction of activation transmission during generation of the output vector from the input vector. The back-propagation process determines, for each activation passed from one node to another, the value of the partial differential of the error, or loss, with respect to the weight associated with the activation. This value is then used to adjust the weight in order to minimize the error, or loss.

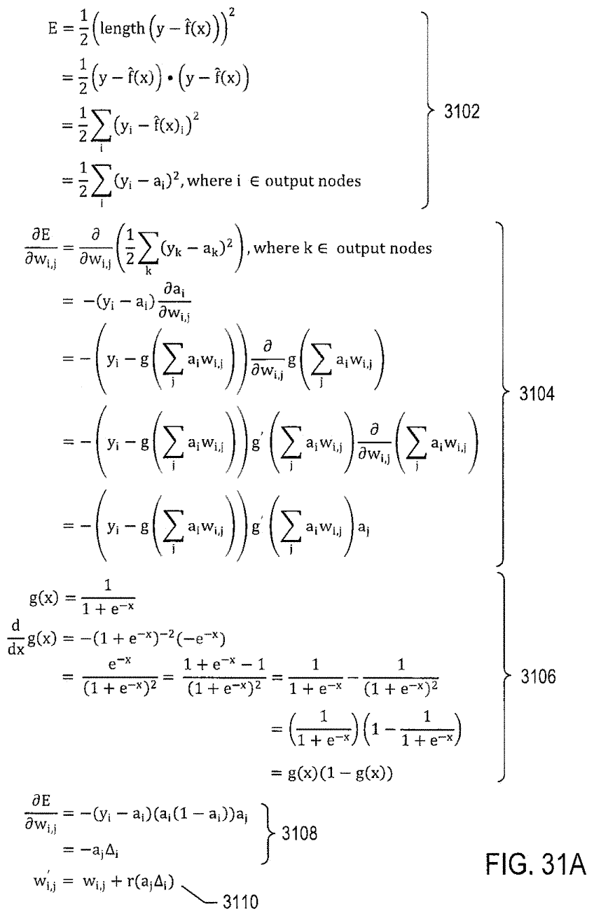

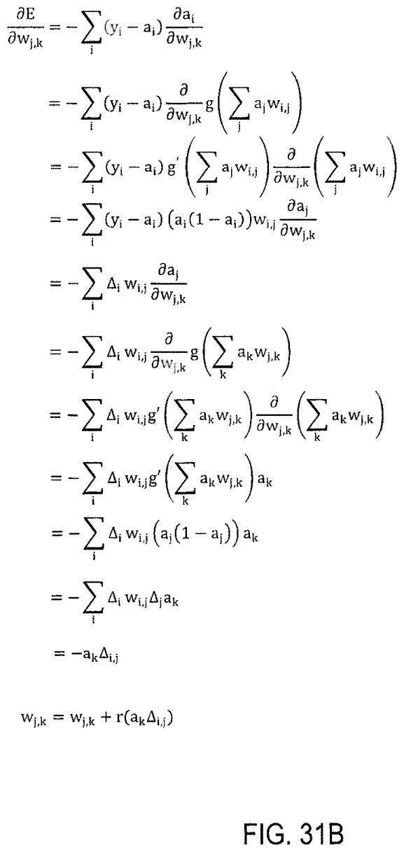

FIGS. 31A-B show the details of the weight-adjustment calculations carried out during back propagation. An expression for the total error, or loss. E with respect to an input-vector/label pair within a training dataset is obtained in a first set of expressions 3102, which is one half the squared distance between the points in a multidimensional space represented by the ideal output and the output vector generated by the neural network. The partial differential of the total error E with respect to a particular weight w_{i,j} for the j^{th} input of an output node i is obtained by the set of expressions 3104. In these expressions, the partial differential operator is propagated rightward through the expression for the total error E. An expression for the derivative of the activation function with respect to the input x produced by the input component of a node is obtained by the set of expressions 3106. This allows for generation of a simplified expression for the partial derivative of the total energy E with respect to the weight associated with the j^{th} input of the output node 3108. The weight adjustment based on the total error E is provided by expression 3110, in which r has a real value in the range [0-1] that represents a learning rate, aⱼ is the activation received through input/by node and A, is the product of parenthesized terms, which include a₁ and y₁, in the first expression in expressions 3108 that multiplies a FIG. 31B provides a derivation of the weight adjustment for the hidden-layer nodes above the output layer. It should be noted that the computational overhead for calculating the weights for each next highest layer of nodes increases geometrically, as indicated by the increasing number of subscripts for the Δ multipliers in the weight-adjustment expressions.

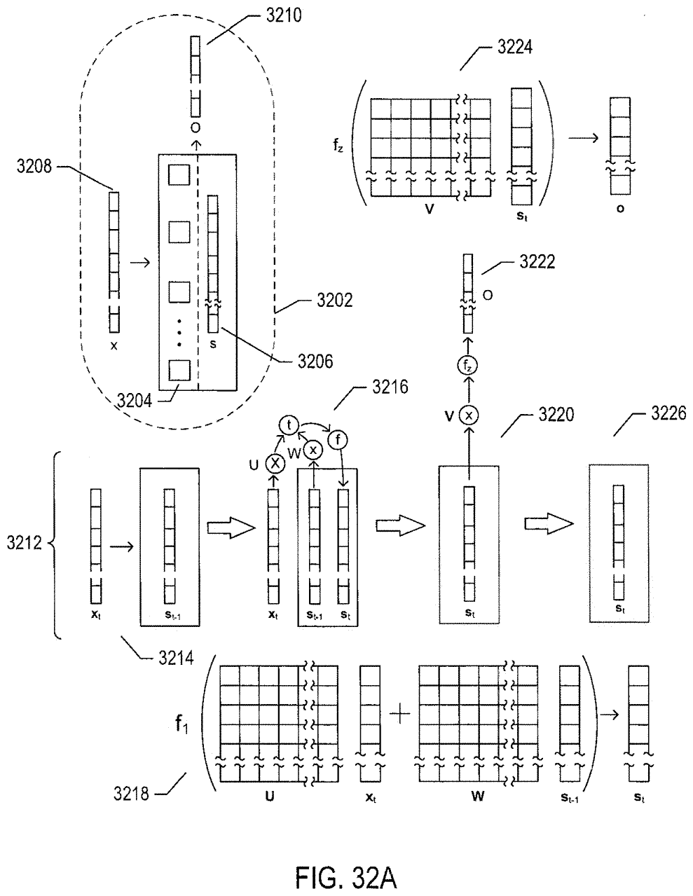

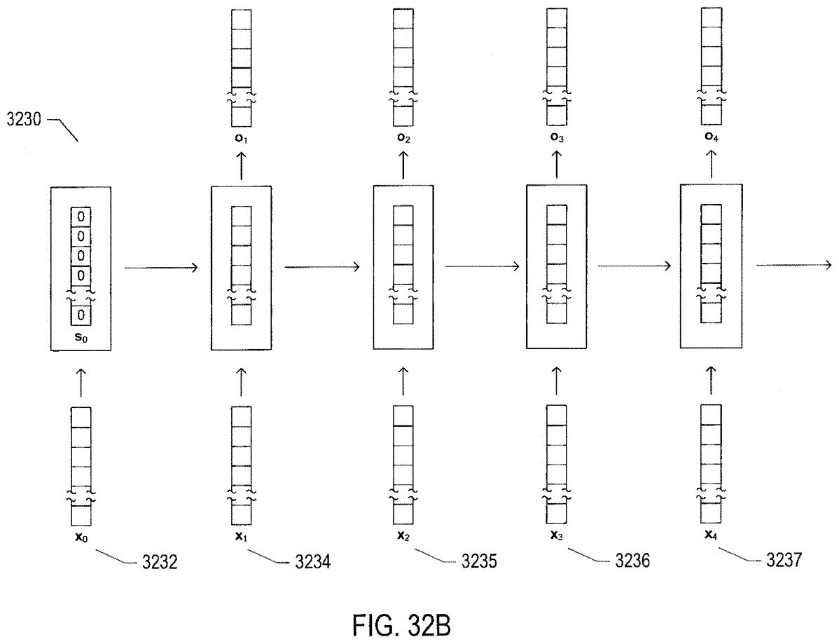

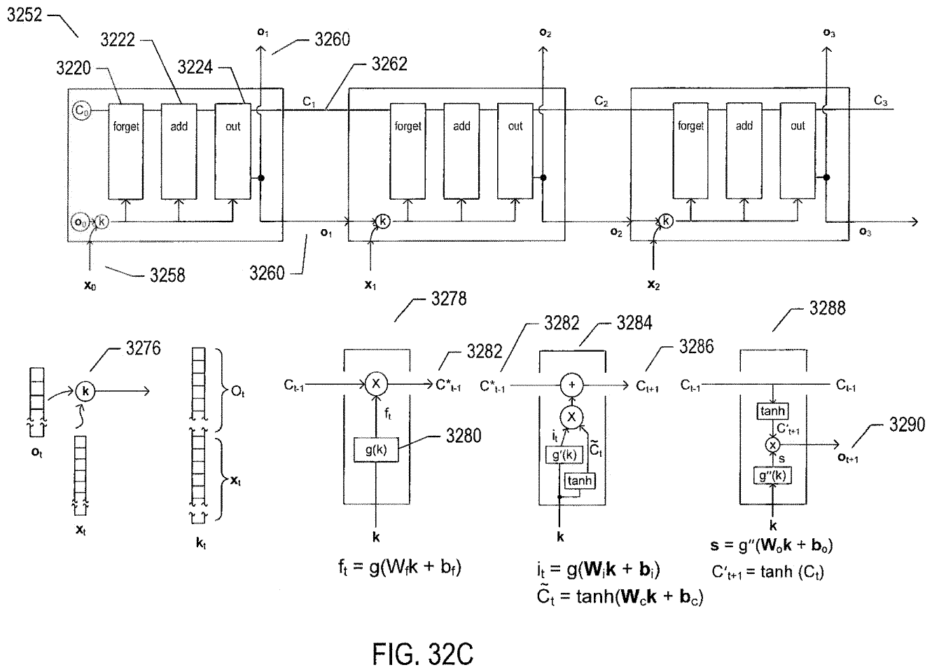

A second type of neural network, referred to as a “recurrent neural network,” is employed to generate sequences of output vectors from sequences of input vectors. These types of neural networks are often used for natural-language applications in which a sequence of words forming a sentence are sequentially processed to produce a translation of the sentence, as one example. FIGS. 32A-C illustrate various aspects of recurrent neural networks. Inset 3202 in FIG. 32A shows a representation of a set of nodes within a recurrent neural network. The set of nodes includes nodes that are implemented similarly to those discussed above with respect to the feed-forward neural network 3204, but additionally include an internal state 3206. In other words, the nodes of a recurrent neural network include a memory component. The set of recurrent-neural-network nodes, at a particular time point in a sequence of time points, receives an input vector x 3208 and produces an output vector 3210. The process of receiving an input vector and producing an output vector is shown in the horizontal set of recurrent-neural-network-nodes diagrams interleaved with large arrows 3212 in FIG. 32A. In a first step 3214, the input vector x at time t is input to the set of recurrent-neural-network nodes which include an internal state generated at time t−1. In a second step 3216, the input vector is multiplied by a set of weights U and the current state vector is multiplied by a set of weights W to produce two vector products which are added together to generate the state vector for time t. This operation is illustrated as a vector function ƒ₁ 3218 in the lower portion of FIG. 32A. In a next step 3220, the current state vector is multiplied by a set of weights V to produce the output vector for time t 3222, a process illustrated as a vector function ƒ₂ 3224 in FIG. 32A. Finally, the recurrent-neural-network nodes are ready for input of a next input vector at time t+1, in step 3226.

FIG. 32B illustrates processing by the set of recurrent-neural-network nodes of a series of input vectors to produce a series of output vectors. At a first time 3230, a first input vector x₀ 3232 is input to the set of recurrent-neural-network nodes. At each successive time point 3234-3237, a next input vector is input to the set of recurrent-neural-network nodes and an output vector is generated by the set of recurrent-neural-network nodes. In many cases, only a subset of the output vectors are used. Back propagation of the error or loss during training of a recurrent neural network is similar to back propagation for a feed-forward neural network, except that the total error or loss needs to be back-propagated through time in addition to through the nodes of the recurrent neural network. This can be accomplished by unrolling the recurrent neural network to generate a sequence of component neural networks and by then back-propagating the error or loss through this sequence of component neural networks from the most recent time to the most distant time period.

Finally, for completeness. FIG. 32C illustrates a type of recurrent-neural-network node referred to as a long-short-term-memory (“LSTM”) node. In FIG. 32C, a LSTM node 3252 is shown at three successive points in time 3254-3256. State vectors and output vectors appear to be passed between different nodes, but these horizontal connections instead illustrate the fact that the output vector and state vector are stored within the LSTM node at one point in time for use at the next point in time. At each time point, the LSTM node receives an input vector 3258 and outputs an output vector 3260. In addition, the LSTM node outputs a current state 3262 forward in time. The LSTM node includes a forget module 3270, an add module 3272, and an out module 3274. Operations of these modules are shown in the lower portion of FIG. 32C. First, the output vector produced at the previous time point and the input vector received at a current time point are concatenated to produce a vector k 3276. The forget module 3278 computes a set of multipliers 3280 that are used to element-by-element multiply the state from time t−1 in order to produce an altered state 3282. This allows the forget module to delete or diminish certain elements of the state vector. The add module 2134 employs an activation function to generate a new state 3286 from the altered state 3282. Finally, the out module 3288 applies an activation function to generate an output vector 2140 based on the new state and the vector k. An LSTM node, unlike the recurrent-neural-network node illustrated in FIG. 32A, can selectively alter the internal state to reinforce certain components of the state and deemphasize or forget other components of the state in a manner reminiscent of human short-term memory. As one example, when processing a paragraph of text, the LSTM node may reinforce certain components of the state vector in response to receiving new input related to previous input but may diminish components of the state vector when the new input is unrelated to the previous input, which allows the LSTM to adjust its context to emphasize inputs close in time and to slowly diminish the effects of inputs that are not reinforced by subsequent inputs. Here again, back propagation of a total error or loss is employed to adjust the various weights used by the LSTM, hut the back propagation is significantly more complicated than that for the simpler recurrent neural-network nodes discussed with reference to FIG. 32A.

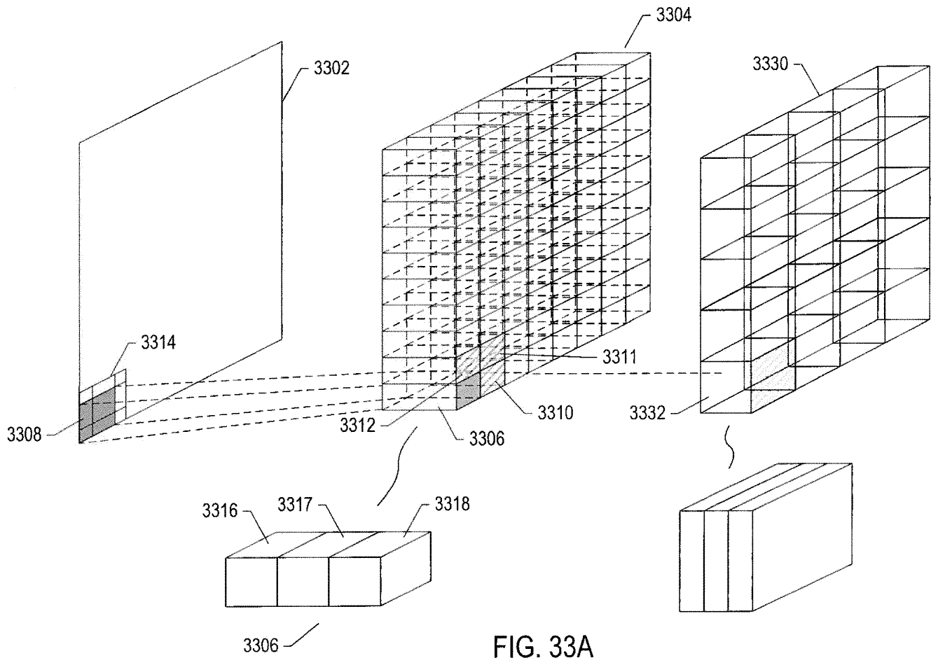

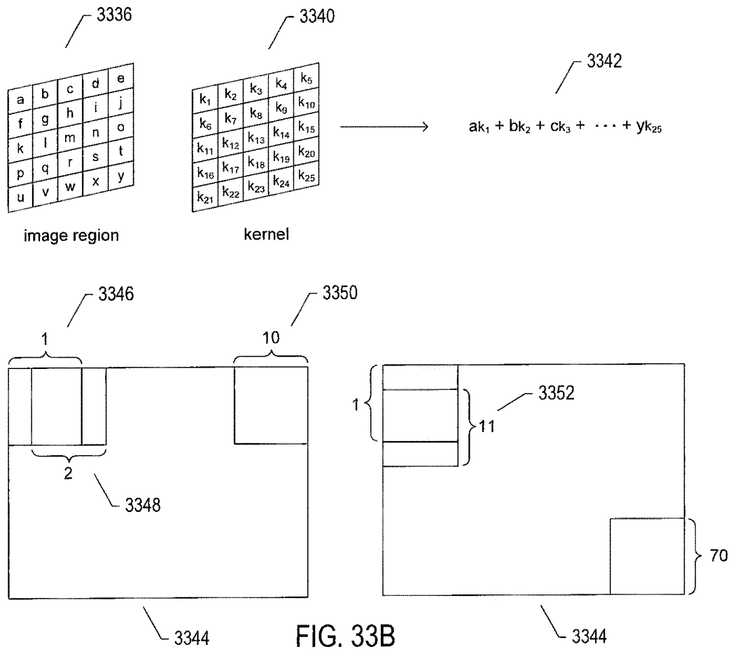

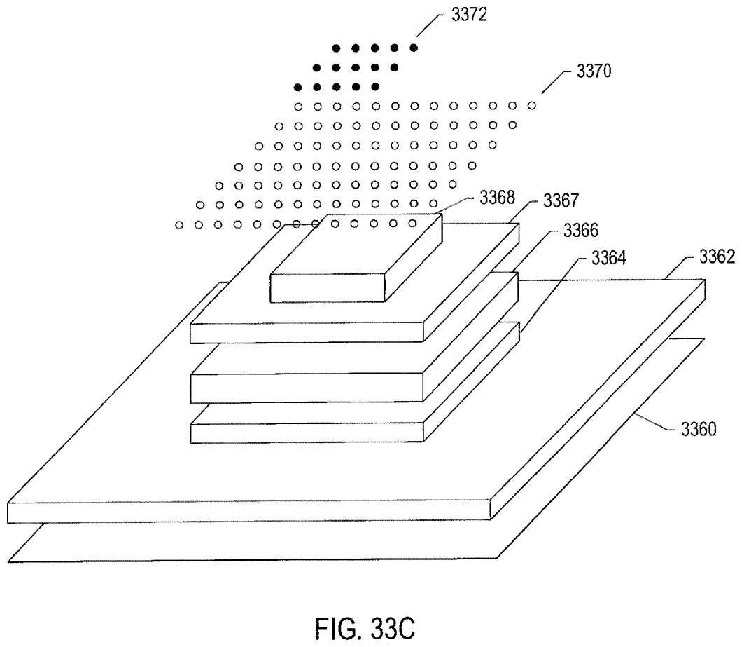

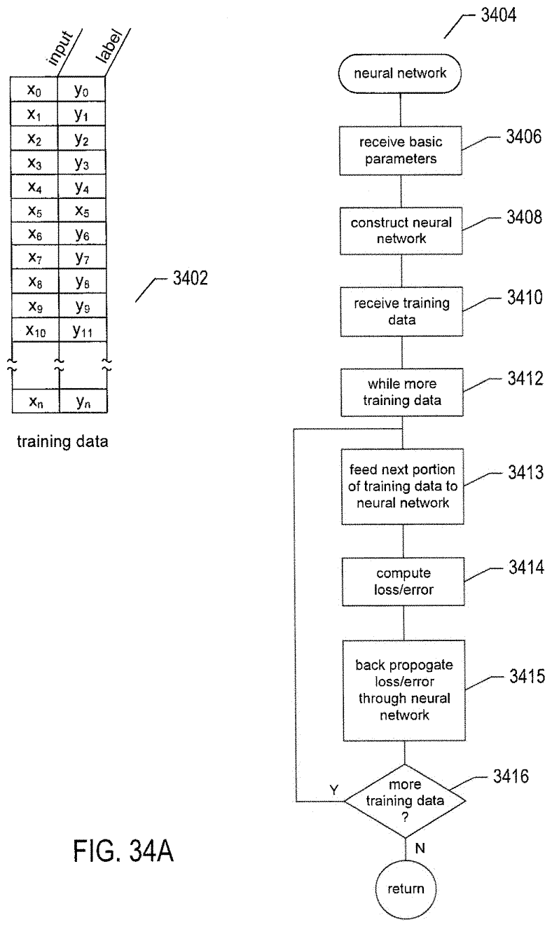

FIGS. 33A-C illustrate a convolutional neural network. Convolutional neural networks are currently used for image processing, voice recognition, and many other types of machine-learning tasks for which traditional neural networks are impractical. In FIG. 33A, a digitally encoded screen-capture image 3302 represents the input data for a convolutional neural network. A first level of convolutional-neural-network nodes 3304 each process a small subregion of the image. The subregions processed by adjacent nodes overlap. For example, the corner node 3306 processes the shaded subregion 3308 of the input image. The set of four nodes 3306 and 3310-3312 together process a larger subregion 3314 of the input image. Each node may include multiple subnodes. For example, as shown in FIG. 33A, node 3306 includes 3 subnodes 3316-3318. The subnodes within a node all process the same region of the input image, but each subnode may differently process that region to produce different output values. Each type of subnode in each node in the initial layer of nodes 3304 uses a common kernel or filter for subregion processing, as discussed further below. The values in the kernel or filter are the parameters, or weights, that are adjusted during training. However, since all the nodes in the initial layer use the same three subnode kernels or filters, the initial node layer is associated with only a comparatively small number of adjustable parameters. Furthermore, the processing associated with each kernel or filter is more or less translationally invariant, so that a particular feature recognized by a particular type of subnode kernel is recognized anywhere within the input image that the feature occurs. This type of organization mimics the organization of biological image-processing systems. A second layer of nodes 3330 may operate as aggregators, each producing an output value that represents the output of some function of the corresponding output values of multiple nodes in the first node layer 3304. For example, second-a layer node 3332 receives, as input, the output from four first-layer nodes 3306 and 3310-3312 and produces an aggregate output. As with the first-level nodes, the second-level nodes also contain subnodes, with each second-level subnode producing an aggregate output value from outputs of multiple corresponding first-level subnodes.

FIG. 33B illustrates the kernel-based or filter-based processing carried out by a convolutional neural network node. A small subregion of the input image 3336 is shown aligned with a kernel or filter 3340 of a subnode of a first-layer node that processes the image subregion. Each pixel or cell in the image subregion 3336 is associated with a pixel value. Each corresponding cell in the kernel is associated with a kernel value, or weight. The processing operation essentially amounts to computation of a dot product 3342 of the image subregion and the kernel, when both are viewed as vectors. As discussed with reference to FIG. 33A, the nodes of the first level process different, overlapping subregions of the input image, with these overlapping subregions essentially tiling the input image. For example, given an input image represented by rectangles 3344, a first node processes a first subregion 3346, a second node may process the overlapping, right-shifted subregion 3348, and successive nodes may process successively right-shifted subregions in the image up through a tenth subregion 3350. Then, a next down-shifted set of subregions, beginning with an eleventh subregion 3352, may be processed by a next row of nodes.

FIG. 33C illustrates the many possible layers within the convolutional neural network. The convolutional neural network may include an initial set of input nodes 3360, a first convolutional node layer 3362, such as the first layer of nodes 3304 shown in FIG. 33A, and aggregation layer 3364, in which each node processes the outputs for multiple nodes in the convolutional node layer 3362, and additional types of layers 3366-3368 that include additional convolutional, aggregation, and other types of layers. Eventually, the subnodes in a final intermediate layer 3368 are expanded into a node layer 3370 that forms the basis of a traditional, fully connected neural-network portion with multiple node levels of decreasing size that terminate with an output-node level 3372.

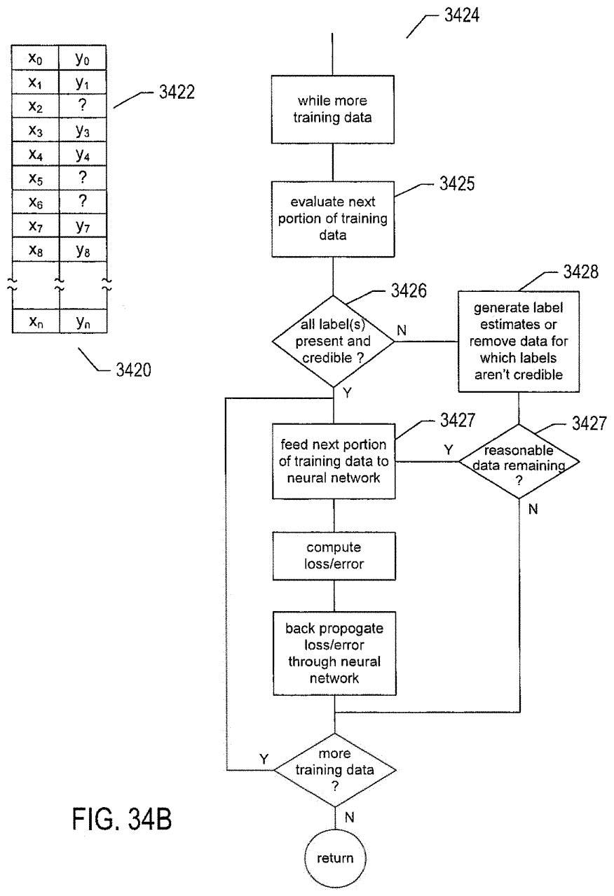

FIGS. 34A-B illustrate neural-network training as an example of machine-learning-based-subsystem training. FIG. 34A illustrates the construction and training of a neural network using a complete and accurate training dataset. The training dataset is shown as a table of input-vector/label pairs 3402, in which each row represents an input-vector/label pair. The control-flow diagram 3404 illustrates construction and training of a neural network using the training dataset. In step 3406, basic parameters for the neural network are received, such as the number of layers, number of nodes in each layer, node interconnections, and activation functions. In step 3408, the specified neural network is constructed. This involves building representations of the nodes, node connections, activation functions, and other components of the neural network in one or more electronic memories and may involve, in certain cases, various types of code generation, resource allocation and scheduling, and other operations to produce a fully configured neural network that can receive input data and generate corresponding outputs. In many cases, for example, the neural network may be distributed among multiple computer systems and may employ dedicated communications and shared memory for propagation of activations and total error or loss between nodes. It should again be emphasized that a neural network is a physical system comprising one or more computer systems, communications subsystems, and often multiple instances of computer-instruction-implemented control components.

In step 3410, training data represented by table 3402 is received. Then, in the while-loop of steps 3412-3416, portions of the training data are iteratively input to the neural network, in step 3413, the loss or error is computed, in step 3414, and the computed loss or error is back-propagated through the neural network step 3415 to adjust the weights. The control-flow diagram refers to portions of the training data rather than individual input-vector/label pairs because, in certain cases, groups of input-vector, label pairs are processed together to generate a cumulative error that is back-propagated through the neural network. A portion may, of course, include only a single input-vector/label pair.

FIG. 34B illustrates one method of training a neural network using an incomplete training dataset. Table 3420 represents the incomplete training dataset. For certain of the input-vector/label pairs, the label is represented by a ‘T’ symbol, such as in the input-vector/label pair 3422. The “?” symbol indicates that the correct value for the label is unavailable. This type of incomplete data set may arise from a variety of different factors, including inaccurate labeling by human annotators, various types of data loss incurred during collection, storage, and processing of training datasets, and other such factors. The control-diagram 3424 illustrates alterations in the while-loop of steps 3412-3416 in FIG. 34A that might be employed to train the neural network using the incomplete training dataset. In step 3425, a next portion of the training dataset is evaluated to determine the status of the labels in the next portion of the training data. When all of the labels are present and credible, as determined in step 3426, the next portion of the training dataset is input to the neural network, in step 3427, as in FIG. 34A. However, when certain labels are missing or lack credibility, as determined in step 3426, the input-vector/label pairs that include those labels are removed or altered to include better estimates of the label values, in step 3428. When there is reasonable training data remaining in the training-data portion following step 3428, as determined in step 3429, the remaining reasonable data is input to the neural network in step 3427. The remaining steps in the while-loop are equivalent to those in the control-flow diagram shown in FIG. 34A. Thus, in this approach, either suspect data is removed, or better labels are estimated, based on various criteria, for substitution for the suspect labels.

### Machine-Reading Comprehension

FIGS. 35A-D illustrate machine-reading-comprehension (“MRC”) systems. MRC systems are commonly used in natural-language processing for various operations that involve selecting phrases or sentences from contextual passages. One important example is for formulating answers to questions related to a contextual passage. In FIG. 35A, an example contextual passage 3502 and question 3504 are shown as inputs to an MRC system 3506. The MRC system generates an answer 3508 to the question. MRC systems do not attempt to actually understand the contextual passage, but instead use various types of vector-space-based operations and heuristics to identify portions of the contextual passage related to the question and then use the identified portions to answer the question. As shown in FIG. 35B, MRC question-answering systems need to be trained, using training data, in order to provide answers to questions. The training data consists of a series or stream of examples, such as example 3510, each of which includes a contextual passage 3512, a question related to the contextual passage 3513, and an appropriate answer to the question 3514. For each example in the training dataset, the MRC system generates a proposed answer A′ 3516, computes some type of distance metric between the proposed answer and the answer included in the training-data example 3517, and adjusts parameters and weights to minimize the distance 3518 were the proposed answer A′ recomputed using the adjusted parameters and weights.

In many MRC systems, words in the contextual passage and question are mapped to feature vectors. Initially, the words are mapped to a type of vector 3520 that includes a different element for each different word in the considered vocabulary. The mapping of a word to this type of vector results in a vector with a single entry, such as entry 3522 in vector 3520, having the value 1 and all other entries having the value 0. These vectors are elements of a vector space of dimension V, where V is the number of words in the vocabulary. These initial vectors are then mapped to feature vectors of a real-number-based vector space 3524 of much smaller dimension N by a mapping encoded in an V×N embedding matrix 3526, each row of which corresponds to an N-dimensional vector representing a particular word in the vocabulary. The mapping incorporates semantic relationships between words into the N-dimensional vectors so that a distance computed by vector subtraction of two N-dimensional feature vectors reflects the semantic relationship between the words represented by the two feature vectors 3528. As shown in FIG. 35C, a subcontext 3531 of adjacent words within a contextual passage 3532 is initially represented as a set of corresponding feature vectors 3534 which are submitted to various types of machine-learning entities, such as recurrent neural networks and convolutional neural networks, to generate a single-vector representation of the subcontext 3536. Similarly, a question 3538 is initially represented by a set of feature vectors 3540 and then processed via machine-learning entities to produce a single vector 3542 representing the question. A comparison operation 3544, in certain implementations based on a matrix computed from the subcontext and question vectors 3546, can then be applied to the subcontext and question vectors in order to determine the relatedness of the question to the subcontext represented by the subcontext vector. An operation that considers successive contexts within the contextual passage and computes the relatedness of the question to each of the successive contexts can then determine those subcontexts most closely related to the question, which provides a basis for generating an answer to the question. MRC systems are well-known and mature, and there are many different types of MRC-system implementations used for a variety of different problem domains.

FIG. 35D illustrates training an MRC system to identify sensitive fields in log/event messages. A training data set 3552 is developed using a sensitive-field dictionary 3554, discussed above, and a large set of log/event messages 3556. The log messages are processed using the sensitive-field dictionary to generate examples, such as example 3558, which together comprise the training data set. Each example includes a log/event message, such as log/event message 3560 in example 3558, the question “What are the sensitive fields in the log?” 3562, and the answer 3564. When event types are computed for, and associated with, log/event messages, Groks may also be included in the examples and also included with the log/event messages submitted to the trained MRC system. When an MRC system is trained with this training data, it can reliably identify the sensitive fields in log/event messages in the same way that a trained MRC system can provide answers to questions related to contextual passages. A log/event message can then be represented as a log/event-message feature vector based on the sensitive fields it contains, where the sensitive fields found in all types of log/event messages constitutes a vocabulary for log/event messages.

### Currently Disclosed Methods and Subsystems

The currently disclosed methods and systems are concerned with processing log/event messages within message collectors and message-processing-and-ingestion systems. As discussed above in the second subsection of this document, with reference to FIGS. 11-23C, log/event messages are generated by many different computational entities within a distributed computer system. In large, distributed computer systems, such as cloud-computing facilities and data centers, large numbers of different types of complex applications generally execute in the large numbers of execution environments provided by the physical and virtual computational resources within the large, distributed computer systems. Often, each of these complex applications generates a large set of different types of application-dependent lot; event messages, and these many different types of application-dependent log/event messages comprise a significant portion of the enormous volumes of log/event message generated within the large, distributed computer systems. To facilitate processing and use of log/event messages, the manufacturers and vendors of various types of applications and other computational entities that generate log/event messages, as well as additional third-party providers, develop content packs and provide the content packs to developers, owners, administrators, and managers of distributed computer systems. The content packs provide many different types of information and tools, including definitions of the different types of log/event messages produced by particular computational entities, or log sources, definitions of fields within log/event messages, functions and routines for extracting field values and other information from log/event messages, automated dashboards for monitoring computational entities via the log/event messages produced by them, and many other tools and types of information. The tools and information provided by content packs can provide for efficient and cost-effective implementation of message collectors, message-processing-and-ingestion systems, log/event-message systems, and log-analytics systems.

FIG. 36 provides an illustration of log/event-message information and tools provided by different content packs developed for different sets of log/event messages generated within a hypothetical distributed computer system. In FIG. 36, each content pack is represented by a dashed-line rectangle, such as dashed-line rectangles 3602-3604. Ellipsis 3606 indicates that there may be many additional content packs. Each content pack is associated with a log-source identifier 3608-3610. The log-source identifier is generally a key/value pair, and each content pack requires a log/event messages to be tagged with a particular log-source identifier recognized by the content pack. The phrase “log source” refers to the identity of the computational entity or entities that issue log/event messages of a particular log/event-message set for which a content pack provides information and tools. When log/event messages are tagged with the particular log-source identifier recognized by a content pack, an automated system can determine to which log/event messages in a stream of log/event messages the tools information provided by the content pack are applicable. When, by contrast, the log source of a log/event message is not known, the information and tools in relevant content packs cannot be used b the automated system, since only particular content packs are relevant to any given log/event message.

Each content pack is generally differently organized and includes different types of tools and information. In FIG. 36, hypothetical information and routines relevant to processing log/event messages are shown for content packs 3602 and 3603. Content pack 3602 provides descriptions of log/event messages generated by the computational entity or entities, or log source, associated with the content pack, represented in FIG. 36 as two relational-database tables: (1) Logs 3612; and (2) Fields 3614. The table Logs includes an identifier and name for each different type of log/event message and the table Fields includes a field identifier, name, type, and regular expression for each type of field in each type of log/event message. Content pack 3602 also provides a routine, represented by the function ƒ_{type} ( ) 3616, which receives, as an argument, a reference to a log/event message and returns the identifier, or type, of the log/event message. Content pack 3603, by contrast, provides three routines 3618-3620 that return BON-encoded or XML-encoded descriptions of log/event-message-related information. The function ƒ_{type} ( ) 3618 receives a reference to a log message and a reference to a memory buffer as arguments and places, in the memory buffer. BON-encoded or XML-encoded log/event-message-type information for the log/event message. The function ƒ_{ff}( ) 3619 receives a reference to a log message and a reference to a memory buffer as arguments and places, in the memory buffer, JSON-encoded or XML-encoded information related to the first field in the log/event-message, including the value contained in the field and the type of value. The function ƒ_{nf}( ) 3620 receives a reference to a log message and a reference to a memory buffer as arguments and places, in the memory buffer. BON-encoded or XML-encoded information related to the next field in the log/event-message, including the value contained in that field and the type of value.

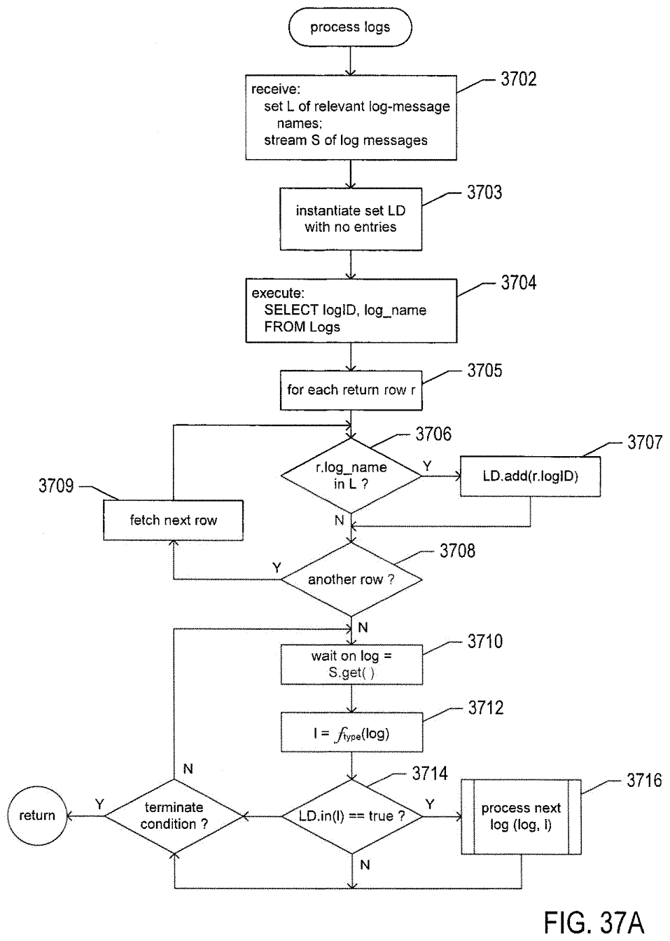

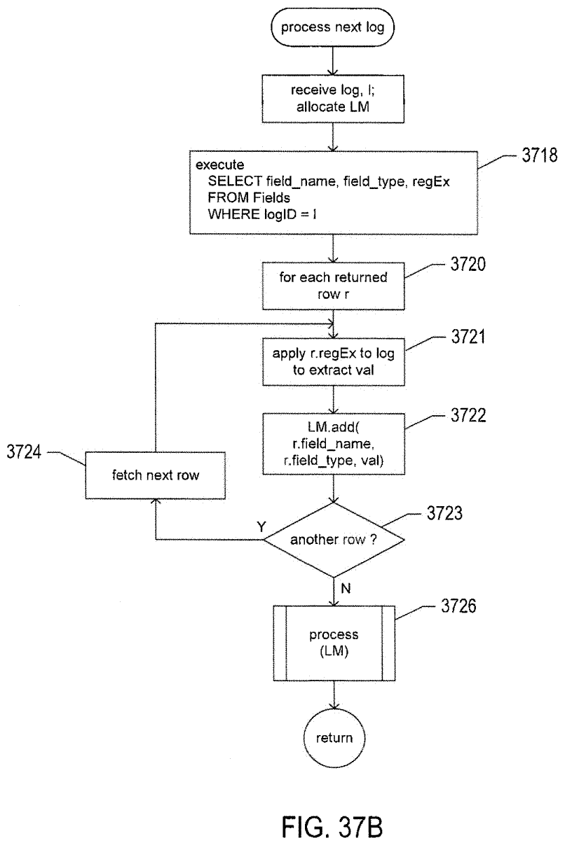

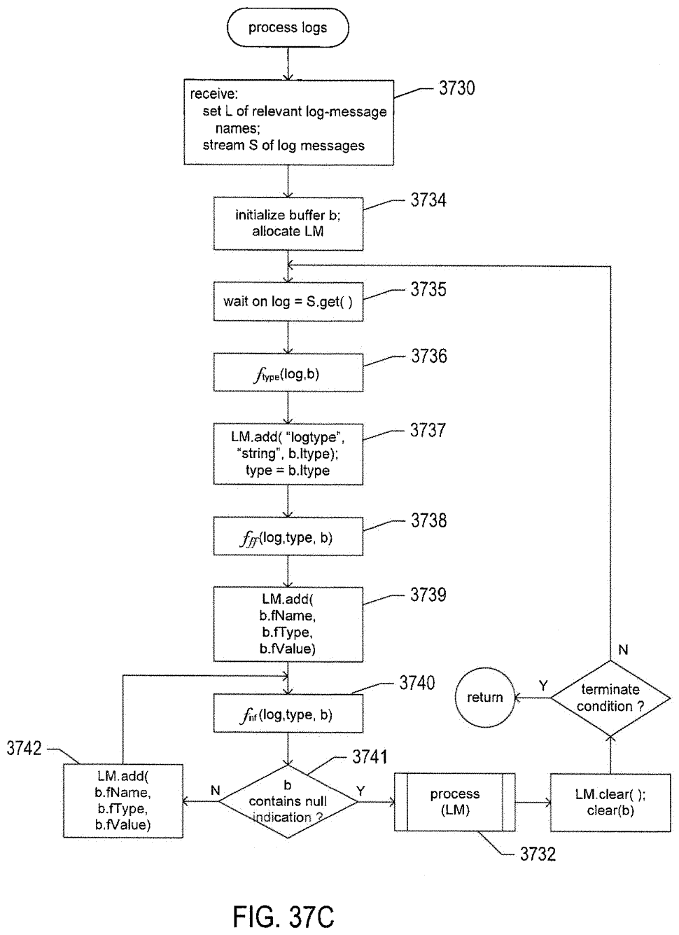

FIGS. 37A-C illustrate hypothetical log/event-message processing using the hypothetical content-pack information and tools provided by content packs 3602 and 3603 illustrated in FIG. 36. FIGS. 37A-B illustrates log/event-message processing using content pack 3602. In two initial steps 3702-3703 of FIG. 37A, the routine “process logs” receives a set L of relevant log-message names for processing and a stream S of log messages and instantiates a set LD with no entries. In step 3704, the routine “process logs” executes an SQL-like query to retrieve the entries from the Logs table (3612 in FIG. 36). Then, in the for-loop of steps 3705-3709, the routine “process logs” reads the log identifiers for relevant log messages into the list LD. In step 3710, the routine “process logs” waits on an available message from the stream S. When a next log/event messages obtained from the stream, the content-pack routine ƒ_{type}( ) is used to determine the type I of the log/event message, in step 3712, and when the type is one of the relevant types, as determined in step 3714, a routine “process next” is called, in step 3716, to process the log/event message. Control then returns to step 3710 for processing a next log/event message obtained from the stream S. FIG. 37B provides a control-flow diagram for the routine “process next log,” called in step 3716 of FIG. 37A. In step 3718, an SQL-like query is executed to retrieve information for the type of log/event message 1. Then, in the for-loop of steps 3720-3724, the field-value-extraction regular expression provided by the content pack for each field in the log/event message is applied to extract a field value, in step 3721, and the extracted field value is then added to an initially processed message LM, in step 3722. Following completion of the for-loop of steps 3720-3724, a routine “process” is called, in step 3726, to process the log/event-message information extracted from the log/event message and placed in the initially processed message LM. The routine “process,” and other downstream routines, may also use content-pack tools and information.

FIG. 37C provides a control-flow diagram for a second version of the routine “process logs,” the first version of which is shown in FIGS. 37A-B. The second version of the routine “process logs” uses the tools and information provided in the second content pack 3603 illustrated in FIG. 36. The initial step 3730 is the same as the initial step 3702 in FIG. 37A. Similarly, the second version of the routine “process logs” prepares an initially processed message LM and supplies this initially process message to the routine “process.” in step 3732, just as in step 3724 of FIG. 37B. However, because the information and tools provided by the second content pack are different from those provided by the first content pack, the intervening steps 3734-3742 are different from corresponding steps in FIGS. 37A-B. There are, for example, no calls to SQL-like queries, since the second content pack does not provide log/event-message information in tables, but there are steps in which the second and third routines ƒ_{ff}( ) and ƒ_{nf}( ) provided by the second content pack are called to extract fields values from each received log/event message.

FIGS. 37A-C illustrate that the processing steps used by a message collector or message-processing-and-ingestion system may differ significantly depending on which content pack is being used for processing the log/event messages, and the differential processing therefore, in part, depends on the source of the log/event messages. In order to use the information provided by content packs, a message-processing-and-ingestion system needs to know the source computational entity, or log source, for each log/event message as well as the log-source identifier expected by the content pack from which the message-processing-and-ingestion system obtains information and tools to process the log/event message. Thus, for example, a message-processing-and-ingestion system would initially determine the log source for a particular received log/event message from a log-source tag associated with the log/event message and then call the appropriate processing routines for messages issued by the determined log source to process the log/event message.

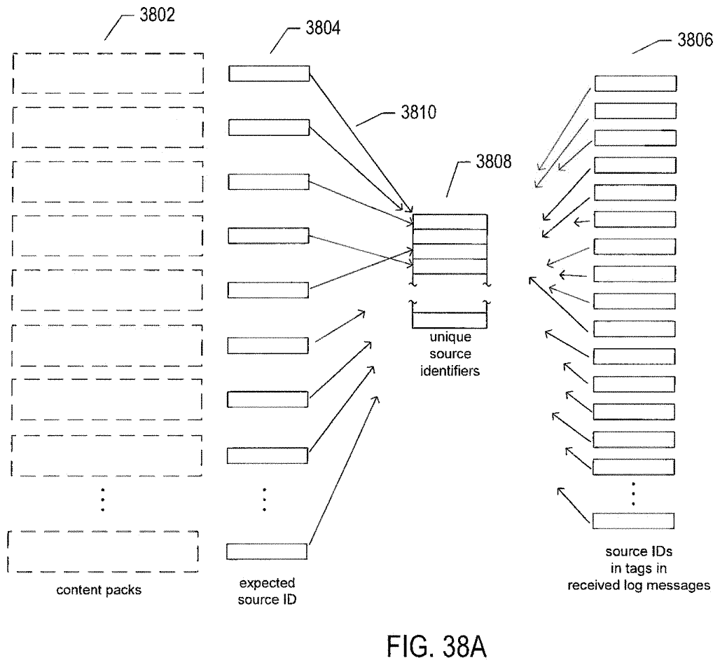

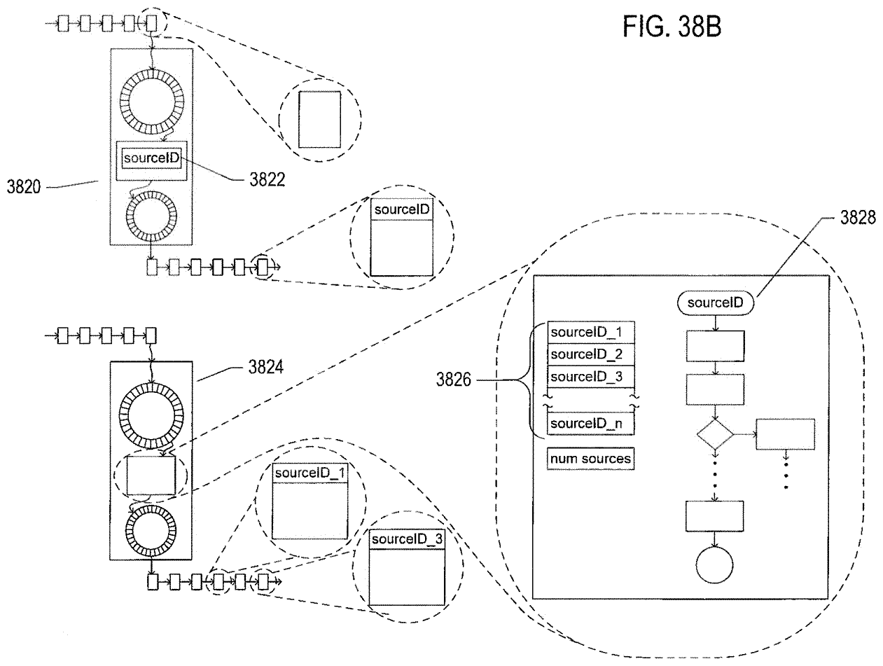

FIGS. 38A-B illustrate problems associated with log/event-message tagging. While log/event-message tagging is needed in order to efficiently use content-pack tools and information for log/event-message processing, currently available log/event-message tagging for adding log-source information to log/event messages is associated with significant problems and deficiencies. As shown in FIG. 38A, a log/event-message message collector, message-processing-and-ingestion system, and, most probably, downstream analytics and query-processing facilities provided by a log/event-message system may need to use information and tools provided by many different content packs, each represented, in FIG. 38A, by a dashed-line rectangle in column 3802. Processing logic that uses content-pack information and tools generally depends on log/event messages being tagged with a log-source identifier in order that the information and tools can be accessed from an appropriate content pack or content packs. The log-source identifiers expected by each of the content packs are represented by solid-line rectangles, in column 3804. The various different log-source identifiers that may be included in log-source-identifier tags associated with log/event messages, also represented by solid-line rectangles, are shown in column 3806. Finally, a hypothetical set of unique log-source identifiers 3808 is shown in the central portion of FIG. 38A. There is a relatively complex mapping, represented by arrows, such as arrow 3810, from the particular log-source identifiers expected by content packs, shown in column 3804, to the set of unique log-source identifiers 3808 and a relatively complex mapping from the various different log-source identifiers that may be found in tags associated with received log/event messages to the unique log-source identifiers 3808. Multiple particular expected log-source identifiers may map to a single unique log-source identifier, multiple log-source identifiers found in tags may map to a single unique log-source identifier, and a set of particular expected log-source identifiers may map to a different set of log-source identifiers found in tags of received event/log messages. These mappings are generally not provided by content packs or other third-party providers, and must be determined and/or inferred by developers. Furthermore, these mappings are potentially quite dynamic, depending on the different types of computational entities currently generating log/event messages within a distributed computer system and on the various content packs available for each of these computational entities. This complex, dynamic set of mappings between log-source identifiers that might be found in tags in received log/event messages and the log-source identifiers expected by particular content packs represents a significant hurdle in designing a log/event-message system to take advantage of the information and tools provided by multiple content packs in a distributed computer system containing many different types of computational entities generating log/event messages. But. of course, an additional, more significant problem is how log/event messages are tagged with log-source identifiers.

FIG. 38B illustrates possible approaches to automated tagging of log/event messages by a log/event-message system. In one approach, message collectors, such as message collector 3820, are configured with a particular log-source identifier 3822 with which to tag all received log/event messages. In this case, each message collector is delegated to collecting messages from a single type of computational entity so that each log/event message collected by the message collector can be tagged by the configured log-source identifier 3022. However, requiring a particularly configured message collector for each type of computational entity is a significant constraint, and a difficult constraint to meet and maintain in a large, distributed computer system. Configuring tens, hundreds, or thousands of message collectors within a large, distributed computer system with a rapidly changing set of computational-entity types may be an imposing or nearly impractical or infeasible task. In a second approach, a message collector 3824 is configured with multiple different log-source identifiers 3826 in order to collect log/event messages for multiple different types of computational entities and appropriately tag the collected log/event messages with log-source identifiers. However, in this case, the message collector needs to have complex log/event-message-processing logic 3828 to determine the probable source of each received log/event message. As discussed above, message collectors are designed to quickly and efficiently process received log/event messages, due high rates of log/event-message reception. Furthermore, the configuration problem discussed with respect to the first approach becomes even more burdensome when message collectors need to be configured with multiple log-source identifiers and the log/event-message-processing logic may need to also be regularly reconfigured to address changes in the types of computational entities currently resident within the distributed computer system.

The combination of the source-identifier-tagging problems discussed with reference to FIGS. 38A-B, and additional problems, including the need to forward log/event messages to external processing systems which may not recognize tags associated with log/event messages from the source system, present a difficult hurdle to developing efficient automated log/event-message processing systems that can take advantage of the information and tools provided by many different available contact packs. The currently disclosed methods and systems are particularly directed to addressing these problems.

The currently disclosed methods and systems automatically tag log/event messages with log-source tags. This is enabled by automatic mapping of event types, automatically determined for log/event messages, to log-source identifiers. Processing components of a log/event-message system then use the log-source identifiers to determine which content packs are relevant to a given log/event message and can then map the log-source identifier to a particular corresponding log-source identifier required by the content pack.

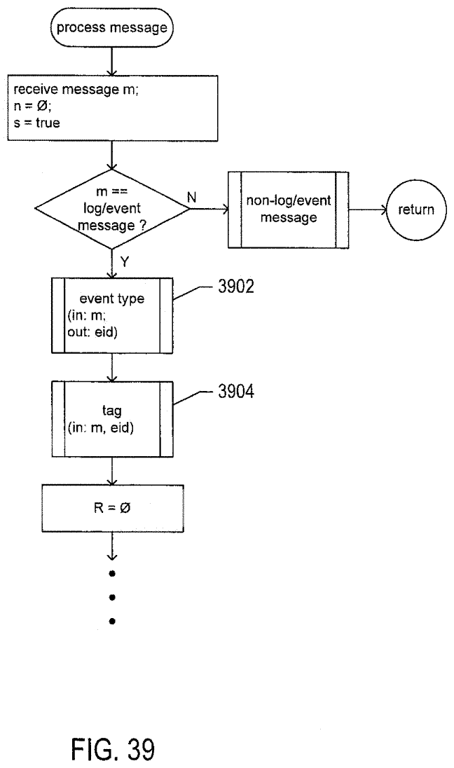

FIG. 39 shows a small, modified portion of the routine “process message” shown in FIG. 17B and described in a preceding subsection of this document. The modifications enable automated determination of the sources of log/event messages and automated tagging of log/event messages by message collectors and/or message-processing-and-ingestion systems. The modifications include a call to an event-type determining routine, in step 3902, followed by a call to the routine “tag,” in step 3904. The event-type determining routine called in step 3902 determines the event type of the received log/event message by any of the event-type determination methods discussed in a preceding subsection of this document with reference to FIGS. 20A-22B as well as other methods for determining the event types to which received log/event messages correspond. The routine “tag,” called in step 3904, automatically tags log/event messages with log-source identifiers when automated tagging, or auto-tagging, is enabled and collects and stores tag information from already-tagged log/event messages, particularly during an initial source-learning phase 1 during which the log/event-message system processes log/event messages already tagged by external log/event-message sources or already tagged in a controlled test environment in which configured message collectors and/or log/event-processing-and-ingestion systems with a distributed computer system generate reliable source-identifier tags. Following completion of the initial source-learning phase, the routine “tag” continues to collect information that is used to discover log sources for newly observed event types and unique log-source identifiers for various different log-source identifiers extracted from already-tagged log/event messages. A log-source mapping routine carries out the association of sources with event types at the end of the initial source-learning phase and is then periodically run, during the lifetime of a log/event-message stem, to associate event types with log sources using this collected information on an ongoing basis.

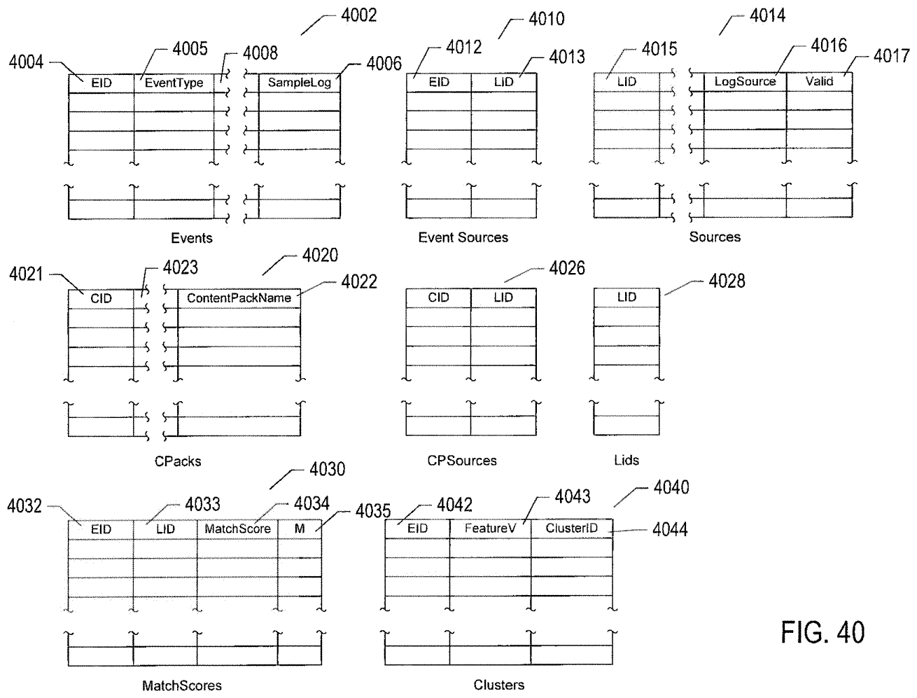

FIG. 40 shows a small number of simple, relational database tables used in one implementation of the currently disclosed methods and systems. Each record, or row, of the table Events 4002 represents an event type determined for, or assigned to, certain received log/event messages. Each column of the table represents a different field contained in each row, or record. These columns include: (1) EID 4004, a numeric event-type identifier; (2) EventType 4005, a descriptive name for the event type; and (3) SampleLog 4006, an example log/event message for the event type that is represented by the row containing this field. The broken column 4008 represents the fact that the rows of table Events may contain additional fields. This illustration convention is also used for the table Sources and the table CPacks, discussed below. The contents of the table Events are generated by the event-typing facilities in the log/event-message system that include the routine “event type,” called in step 3902 of FIG. 39. The table EventSources 4010 represents a mapping of event types to log-source identifiers (“LIDs”). This mapping is periodically updated during the lifetime of the log/event-message system. The column EID 4012 contains an event-type identifier also contained in the column of the same name in one row of the table Events and the column LID 4013 contains the log-source identifier for the course of log/event messages of this event type. The table Sources 4014 includes the columns: (1) LID 4015, a numeric log-source identifier; (2) LogSource 4016, the text extracted from one or more event/log messages representing the log source identified by the log-source identifier; and (3) Valid 4017, an indication that the log source has been validated. The table Sources is initially populated with log-source information available from content packs and other information sources and may be updated manually when new log sources become known to developers and users of the log/event-message system. When new textual log-source identifiers are identified in subsequently received log/event messages, and when they can be mapped to already present, valid log-source identifiers, the entries in the table Sources corresponding to the new textual log-source identifiers are updated to include numeric log-source identifiers and the field Valid is set to TRUE. There may be multiple entries in the table Sources for a given LID. Thus, the table Sources represents a mapping between the particular log-source identifiers expected by different content packs and the underlying log source. The table CPacks 4020 includes a column (ID 4021 that contains numerical identifiers for content packs and a column Content Pack Name 4022 that contains the names of content packs. Broken column 4023 indicates that there are many additional fields in a row of the table CPacks. The table CPacks is initially populated with content-pack information known to developers and users of the log/event-message system and is updated by those developers and users as new content packs become available. The table CPSources 4026 represents a mapping between content packs and log sources. Each row contains a numeric content-pack identifier and a numeric log-source identifier. This table is manually created and updated by developers and users of the event/log system, in the described implementation. In alternative implementations, it is possible that all three of the tables Sources, CPacks, and CPSources may be automatically populated with information obtained by the event/log system from information sources accessible to the event/log system. The table Lids 4028 stores numeric log-source identifiers available for reuse, as described further below. The table MatchScores 4030 is used during cluster-based log-source identification. This table includes four columns: (1) EID 4032, a numeric event-type identifier; (2) LID 4033, a numeric log-source identifier; (3) MatchScore 4034, a numeric score for the association of the numeric log-source identifier with the numeric event-type identifier; and (4) M 4035, a Boolean value indicating that the sample log/event message associated with event-type EID has matched at least one field definition in at least one content pack, as further discussed below. The table Clusters 4040 is also used during cluster-based log-source identification. This table includes three columns: (1) EID 4042, a numeric event-type identifier: 2) Feature V 4042, a feature vector generated from the sample log/event message associated with the event-type identifier, stored in the table Events; and (3) ClusterID 4044, a numeric identifier for an event-type cluster.

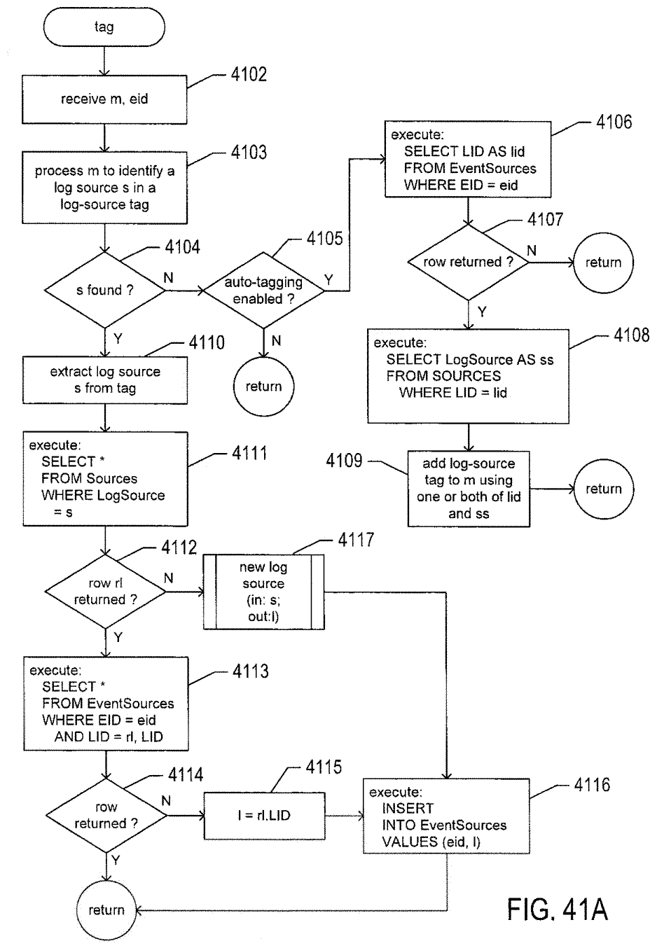

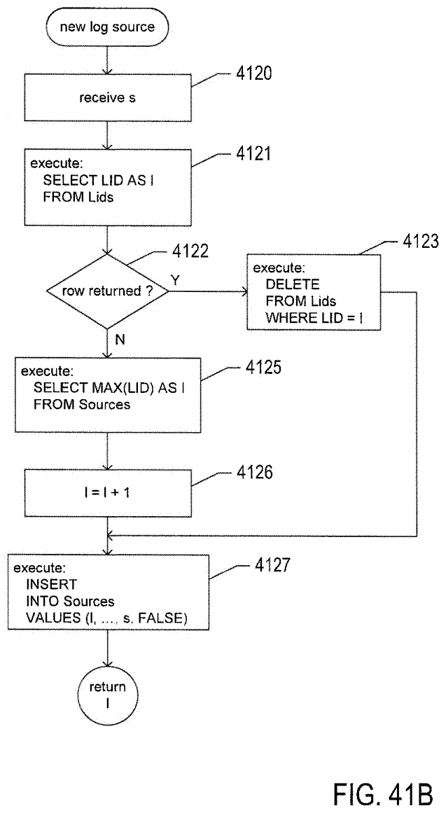

FIGS. 41A-B provide control-flow diagrams for the routine “tag,” called in step 3904 of FIG. 39. The routine “tag” is called, in certain implementations, by a message collector and, in other implementations, by a message-processing-and-ingestion system or other log/event-message-system component. In step 4102, the routine “tag” receives a reference to a message, m, and an event type, eid. In step 4103, the routine “tag” processes the received message to identify a log source s encoded in a tag within the message. If such a tag is not found, as determined in step 4104, and when auto-tagging is enabled, as determined in step 4105, the routine “tag” executes an SQL-like query to find a log-source identifier lid for the event type in the table EventSources, in step 4106. If a row is returned by the query, as determined in step 4107, an SQL-like query is executed, in step 4108, to obtain a textual log-source identifier ss corresponding to the numeric log-source identifier lid. The textual log-source identifier ss is then encoded in a tag which is added to the message, in step 4109. When auto-tagging is not enabled or when there is no numeric log-source identifier associated with the event type, the routine “tag” returns, leaving the message unassociated with a log-source identifier. Such messages are considered to be messages with unknown log sources and may be referred to as “unknown log/event messages” in the following discussion.

It should be noted that, in the described implementations, various details, such as whether duplicate rows may be resident in relational-database tables and, if so, whether duplicate rows are removed during table-maintenance operations and details with respect to executing SQL-like queries from programs, are not specified. In many implementations, if not most implementations, a relational database is not used for managing the information. Instead, different types of file-based data-storage methods may be employed, and the details for the various alternative methods differ. The use of SQL-like queries in the control-flow diagrams used illustrate the currently disclosed methods and systems is an illustration convenience to allow the logic to be clearly indicated without descending into details of information management.

Auto-tagging is a generally enabled only after an initial learning phase, as mentioned above. It is during the initial learning phase that an initial mapping between event types and log-source identifiers is established. As mentioned above, the initial learning phase may involve feeding already-tagged log/event messages into the log/event-message system or processing internally generated log/event messages in a controlled test environment. Alternatively, an initial mapping between event types and log-source identifiers may be manually input into the EventSources table by log/event-message-system developers, administrators, and/or managers. When a received log/event message is already tagged, as determined in step 4104, a textual log-source identifier s is extracted from the log/event message, in step 4110. In step 4111, the routine “tag” executes an SQL-like query to find a row in the Sources table that includes the textual log-source identifier s. When such a row is found, as determined in step 4112, an SQL-like query is executed, in step 4113, to find the numeric log-source identifier corresponding to the textual log-source identifier s in the table EventSources. When no such numeric log-source identifier is found, as determined in step 4114, a new association between the event type eid and the numeric log-source identifier is inserted into the table EventSources in steps 4115-4116. Otherwise, the routine “tag” returns, since the tag found in the message correctly identifies a known log source. When there is no row in the table Sources corresponding to the textual log-source identifier s, as determined in step 4112, a routine “new log source” is called, in step 4117, in order to add the textual log-source identifier to the table Sources. Control then flows to step 4116, where the new numeric log-source identifier corresponding to the textual log-source identifier, output by the routine “new log source,” is added to the EventSources table.

FIG. 41B provides a control-flow diagram for the routine “new log source,” called in step 4117 of FIG. 41A. In step 4120, the routine “new log source” receives a textual log-source identifier s. In step 4121, an SQL-like query is executed to obtain a numeric log-source identifier from the table Lids. When this query returns a row, as determined in step 4122, the obtained numeric log-source identifier is deleted from the table Lids, in step 4123, and the obtained numeric log-source identifier is inserted, along with the textual log-source identifier, into the table Sources, in step 4127. Otherwise, an SQL-like query is executed, in step 4125, to determine the current largest numeric log-source identifier in the table Sources, l, and this value is incremented, in step 4126, to generate a numeric-log-source identifier for the received textual log-source identifier s, which is added to the table Sources in previously described step 4127. Note that the new entry in the table Sources includes the Boolean value FALSE in the field Valid. This indicates that the log source represented by the entry has not yet been verified.

During the above-mentioned initial learning phase, and, subsequently, during operation of the log/event-message system, received log/event messages may end up being classified as having unknown sources, either because they do not contain log-source-identifier tags and their event types have not been associated with a log source or because they contain log-source-identifier tags for textual log-source identifiers that have not yet been verified. These log/event messages may be reclassified following a next execution of the routine “log-source mapping,” described below. This routine is called following the initial learning phase and then periodically, thereafter, to resolve event types with unknown log sources.

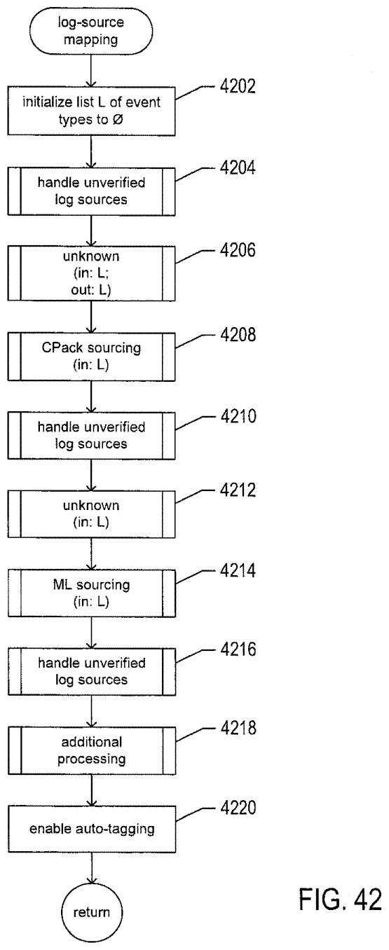

FIG. 42 provides a control-flow diagram for the routine “log-source mapping.” This routine attempts to map event-type identifiers, which are not already associated with numeric log-source identifiers, to numeric log-source identifiers. In step 4202, a list L of event types is initialized to an empty list. In step 4204, a routine “handle unverified log sources” is called to attempt to resolve entries in the table Sources for which the field Valid contains the Boolean value FALSE. This resolution is possible when an event type associated with such an entry is also associated with a verified log source. Then, in step 4206, a routine “unknown” is called in order to populate the list L with event types associated with log/event messages for which a verified log source has not yet been identified. In step 4208, a routine “CPack sourcing” is called to employ information obtained from content packs and a clustering method, discussed below, to resolve unknown event types. Then, in steps 4210 and 4212, the routines “handle unverified log sources” and “unknown” are again called to verify unverified log sources. In step 4214, a routine “ML sourcing” is called to use machine-learning techniques to attempt to resolve any still-unresolved event types. In step 4216, the routine “handle unverified log sources” is again called. In step 4218, a routine “additional processing” is called to carry out various additional types of maintenance and longer-term event-type resolution methods, including de-duplication of entries in the above-described tables, comprehensive reclustering of all known event types and reassigning numeric log-source identifiers to the reclustered event types, incorporation of newly obtained information into the above-described tables, and additional types of log-source verification and unknown-event-type resolution. Finally, in step 4220, auto-tagging is enabled. Thus, in the described implementation, auto-tagging is enabled following the first execution of the routine “log-source mapping” and remains enabled thereafter. During operation of the log/event-message system, when new log-source identifiers are encountered, that are mapped to an already verified log-source identifier, and when new event types are encountered, they are resolved to an association with a log-source identifier for the computational entity or entities that issue log/event messages of the new event types. This is made possible by initial information processed in the initial execution of the routine “log-source mapping” and by subsequent processing of new information by subsequent, periodic execution of the routine “log-source mapping.”

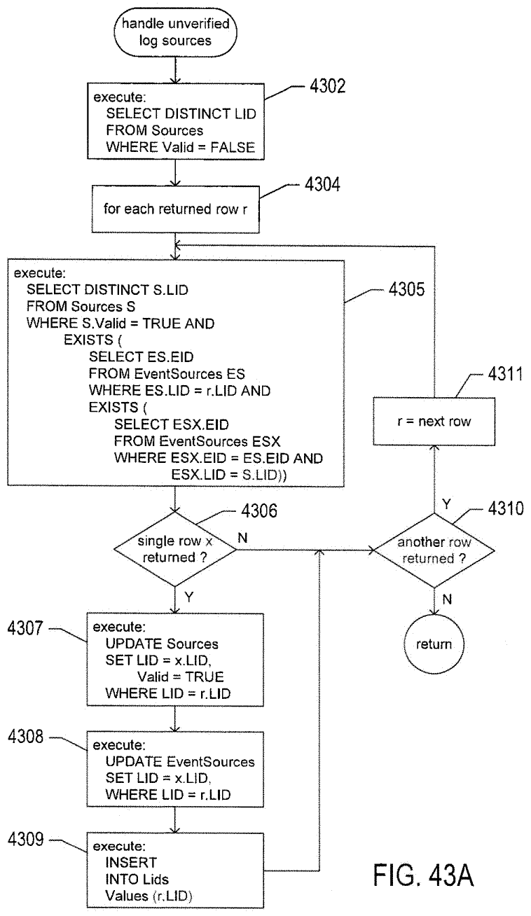

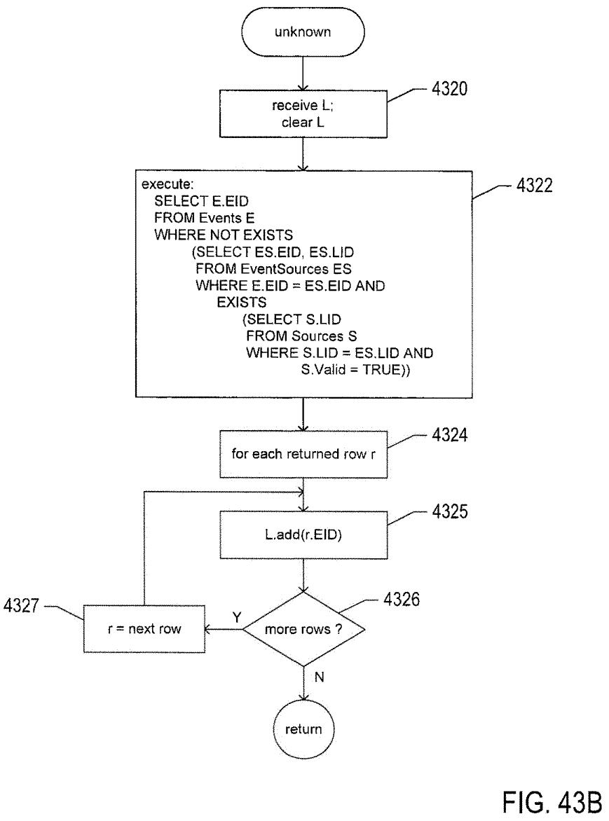

FIGS. 43A-B provide control-flow diagrams for the routines “handle unverified log sources” and “unknown.” both repeatedly called by the routine “log-source mapping” shown in FIG. 42. FIG. 43A shows a control-flow diagram for the routine “handle unverified log sources.” In step 4302, an SQL-like query is executed to obtain entries in the table Sources representing unverified log sources. In the for-loop of steps 4304-4311, each Sources entry, or row r, returned by the query is considered. In step 4305, an SQL-like query is executed to determine whether there are any verified numeric log-source identifiers associated event types that are also associated with the unverified log source corresponding to the currently considered row r. If a single row x is returned by this query, as determined in step 4306, then, in steps 4307-4309, the numeric log-source identifier in the entry represented by currently considered row r is replaced by the numeric log-source identifier in the entry represented by row x, event-type mappings to the replaced numeric log-source identifier in the table EventSources are updated, and the now unused numeric log-source identifier in currently considered row r is added to the table Lids for subsequent reuse. Control then flows back to step 4310 for another possible iteration of the for-loop of steps 4304-4311. When the SQL-like query executed in step 4305 fails to return a single row, control flows to step 4310. Thus, the routine “handle unverified log sources” resolves unverified log sources when an unambiguous mapping of the unverified log source to an already verified log source can be identified.

FIG. 43B provides a control-flow diagram for the routine “unknown.” In step 4320, the routine receives the list L and clears the list. In step 4322, an SQL-like query is executed to find any event types that are either not mapped to a log-source identifier or that are mapped only to unverified log-source identifiers. Any event types returned by this query are added to the list L in the for-loop of steps 4324-4327.

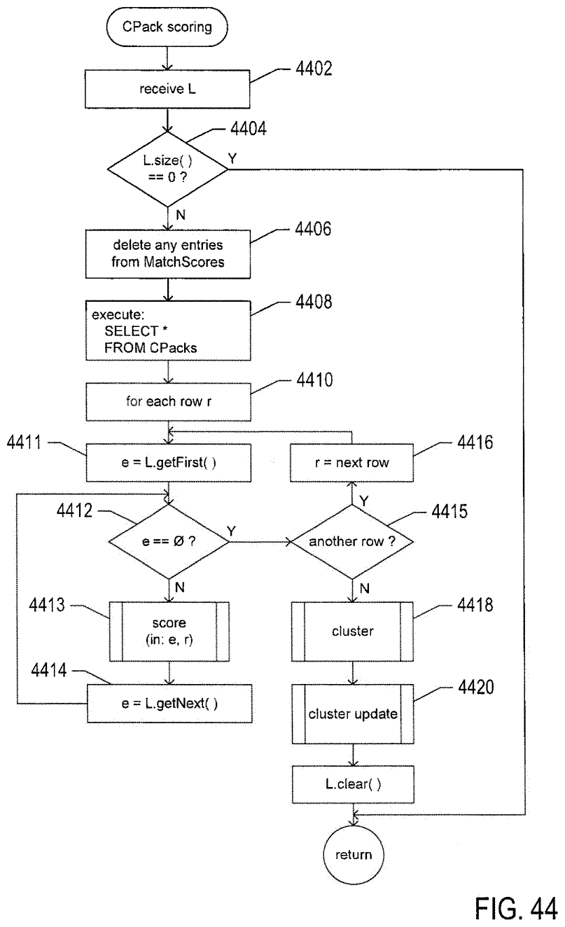

FIG. 44 provides a control-flow diagram for the routine “CPack scoring,” called in step 4208 of FIG. 42. In step 4402, the routine “CPack scoring” receives the list L. If this list is empty, as determined in step 4404, the routine “CPack scoring” returns, since there are no unknown event types to resolve. Otherwise, in step 4406, the routine “CPack scoring” deletes any entries from the table MatchScores. In step 4408, an SQL-like query is executed to retrieve information from the table CPacks about the available content packs. In the for-loop of steps 4410-4416, each content pack represented by a returned row r is considered. In each iteration of an inner loop of steps 4411-4414, a score is computed for each event type in the list L for the content pack currently considered in the for-loop of steps 4410-4416. Thus, each unknown event type is scored with respect to each content pack. Following completion of the for-loop of steps 4410-4416, a routine “cluster” is called, in step 4418, to cluster the unknown event types and then a routine “cluster update” is called, in step 4422, which uses the clustering produced by the routine “cluster” to resolve as many unknown event types as possible.

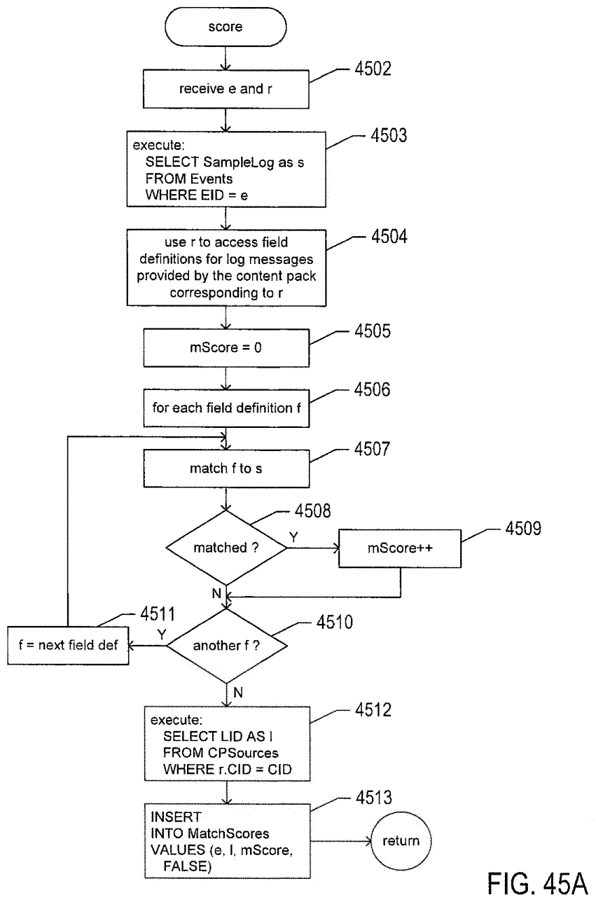

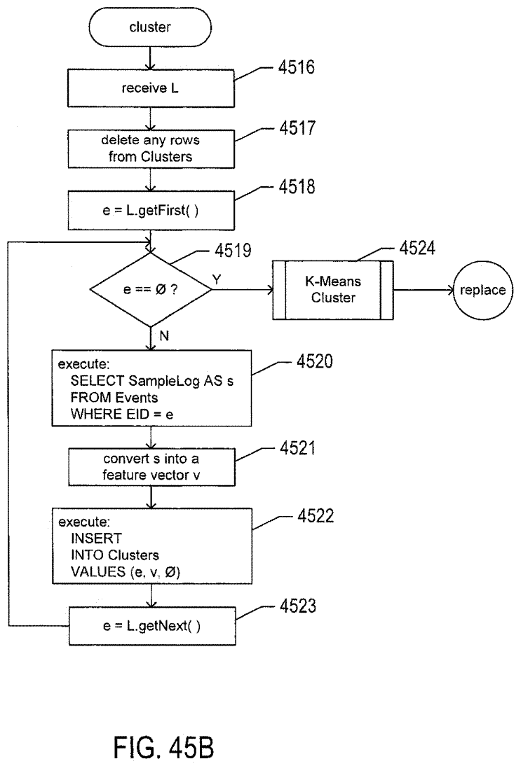

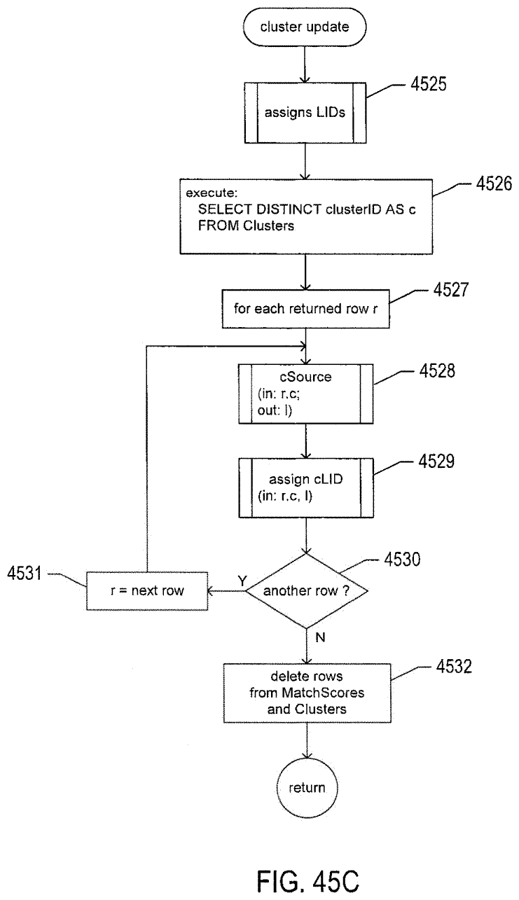

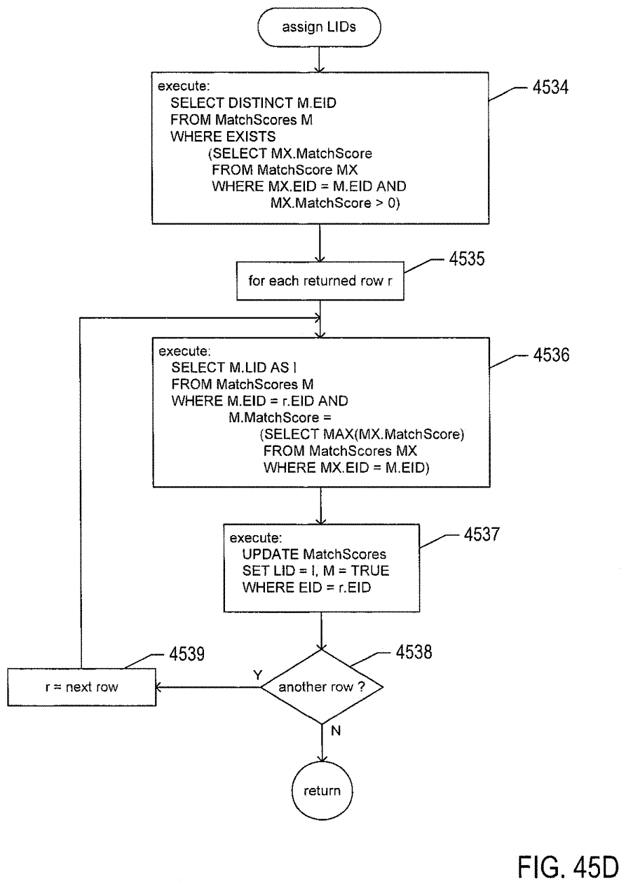

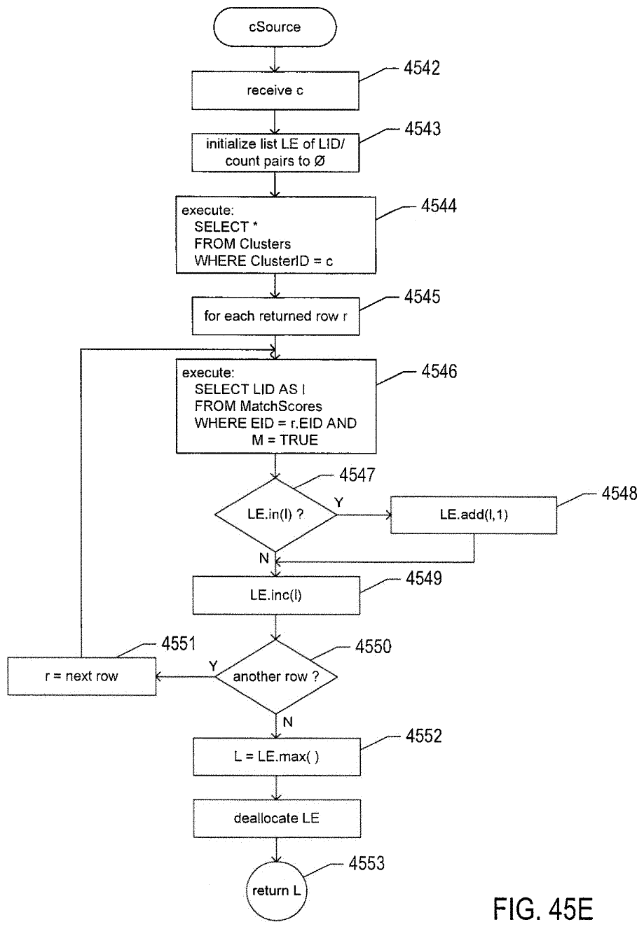

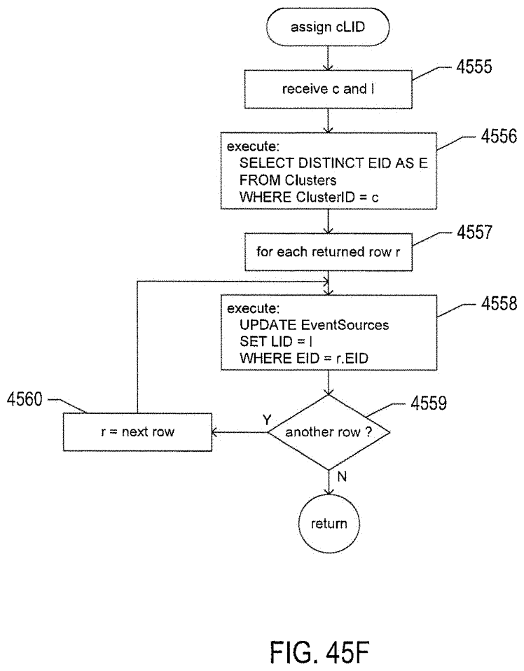

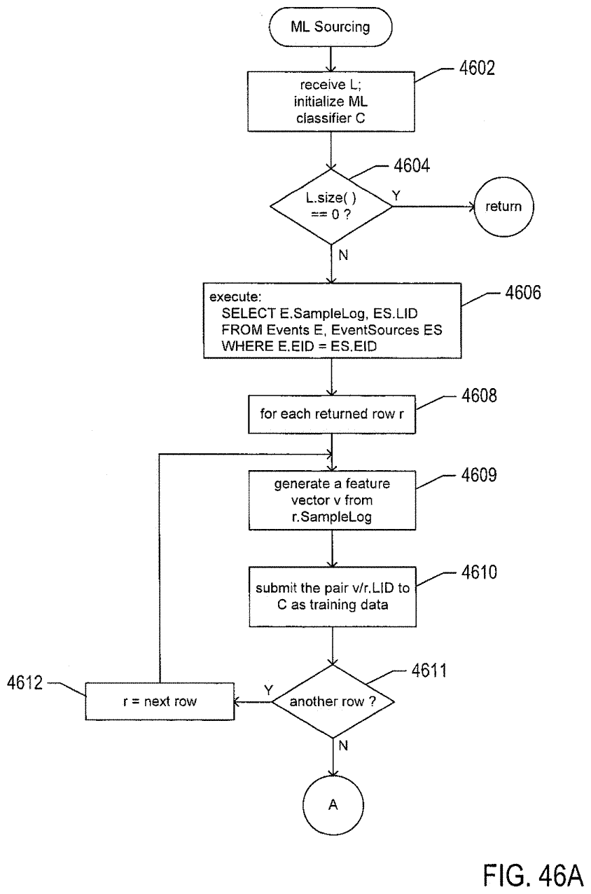

FIGS. 45A-F provide control-flow diagrams for the routines directly and indirectly called by the routine “CPack scoring.” FIG. 45A provides a control-flow diagram for the routine “score,” called in step 4413 of FIG. 44. In step 4502, the routine “score” receives an event-type identifier e and a row r returned from the table Cpacks by the SQL-like query executed in step 4408 of FIG. 44. In step 4503, the routine “score” executes an SQL-like query to retrieve the sample log/event message s for event-type identifier from the table Events. In step 4504, the routine “score” accesses the content pack represented by the row r to obtain the field definitions for log messages provided by the content pack. In step 4505, the routine “score” sets a local variable mScore to 0. In the for-loop of steps 4506-4511, each field definition ƒ provided by the currently considered content pack is considered. In step 4507, the currently considered field definition ƒ is attempted to be matched to the sample log/event message s. As one example, the matching may be carried out using a regular expression to attempt to extract the field from the sample log/event message s. If a match is obtained, as determined in step 4508, the local variable mScore is incremented, in step 4509. Following completion of the for-loop of steps 4506-4511, the score for the event identifier e and currently considered content pack is inserted into the table MatchScores via the two SQL-like queries executed in steps 4512 and 4513. The event type is temporarily associated with the log-source identifier associated with the content pack that provides the greatest number of matching field definitions for the sample log/event message s. This association is made by a routine “assign LIDs,” discussed below. The field M is initially set to FALSE for all entries in MatchScores.

FIG. 45B provides a control-flow diagram for the routine “cluster,” called in step 4418 of FIG. 44. In step 4516, the routine “cluster” receives the list of unknown event types L. In step 4517, the routine “cluster” deletes any rows from the table Clusters. In the loop of steps 4518-4423, an entry is inserted into the table Clusters for each unknown event type in list L. The entry includes the event type e, a feature vector corresponding to the sample log/event message s for the event type e, and a null value for the ClusterID field. The sample log/event messages is obtained by execution of an SQL-like query in step 4520 and the feature vector is generated in step 4521. Feature vectors are discussed, in a preceding subsection, with reference to FIGS. 35A-D. There are a variety of methods for converting a log/event message into a feature vector in addition to the methods discussed in the preceding subsection. Following completion of the loop of steps 4518-4423, a K-means clustering routine is called, in step 4524, to cluster event types based on the feature vectors associated with the event types. This routine replaces the null entries in the ClusterID field in the table Clusters with a numeric cluster identifier that indicates the cluster to which the event type is assigned. K-means clustering is discussed in a preceding subsection with reference to FIGS. 25A-26 G. For simplicity, it is assumed that all event types are assigned to a cluster. However, in many implementations, outlying event types may be unassigned and remain unknown following the cluster-based resolution process represented by the routine “CPack scoring.”

FIG. 45C provides a control-flow diagram for the routine “cluster update,” called in step 4420 of FIG. 44. In step 4525, the routine “cluster update” calls a routine “assign LIDs” to temporarily associate a single log-source identifier with each event type in the table MatchScores. The log-source identifier associated with the content pack for which the sample log/event message associated with the event-type identifier matched the greatest number of field definitions is selected for the temporary association. In step 4526, an SQL-like query is executed to select the distinct cluster identifiers from the table Clusters. In the for-loop of steps 4527-4531, a log-source identifier is determined for each cluster via a call to a routine “cSource,” in step 4528, and the determined log-source identifier is then associated with the event types corresponding to the cluster via a call to a routine “assign cLID,” in step 4529. Following completion of the for-loop of steps 4527-4531, all of the rows are deleted from the tables MatchScores and Clusters.

FIG. 45D provides a control-flow diagram for the routine “assign LIDs,” called in step 4525 of FIG. 45C. In step 4534, an SQL-like query is executed in order to find all event types associated with at least one non-0 match score in the table MatchScores. In the for-loop of steps 4535-4539, each of these event types is considered. Each of the event types is temporarily assigned a log-source identifier corresponding to the content pack for which the sample log/event message for the event type matched the largest number of field definitions and the field M in the table MatchScores for the entity type is set to TRUE in the query executed in step 4537.

FIG. 45E provides a control-flow diagram for the routine “eSource,” called in step 4528 FIG. 45C. In step 4542, the routine “cSource” receives a cluster identifier c. In step 4543, the routine “cSource” initializes a list LE of log-source-identifier/count pairs to the empty list. In step 4544, the routine “cSource” executes an SQL-like query to select rows from the table Clusters corresponding to the cluster identifier c. In the for-loop of steps 4545-4551, the number of log-source identifiers corresponding to each of the event types in the currently considered cluster are counted and stored in the list LE. Following completion of the for-loop of steps 4545-4551, the log-source identifier with the greatest count is obtained from the list LE, in step 455, and returned, in step 4553.

FIG. 45F provides a control-flow diagram for the routine “assign cLID,” called in step 4529 of FIG. 45C. In step 4555, the routine “assign cLID” receives a cluster identifier c and a log-source identifier l. In step 4556, the routine “assign cLID” executes an SQL-like query to obtain the event-type identifiers associated with the cluster identified by cluster identifier c. In the for-loop of steps 4557-4560, the mapping for each event-type identifier in the table EventSources is updated to map the event-type identifier to the log-source identifier l.

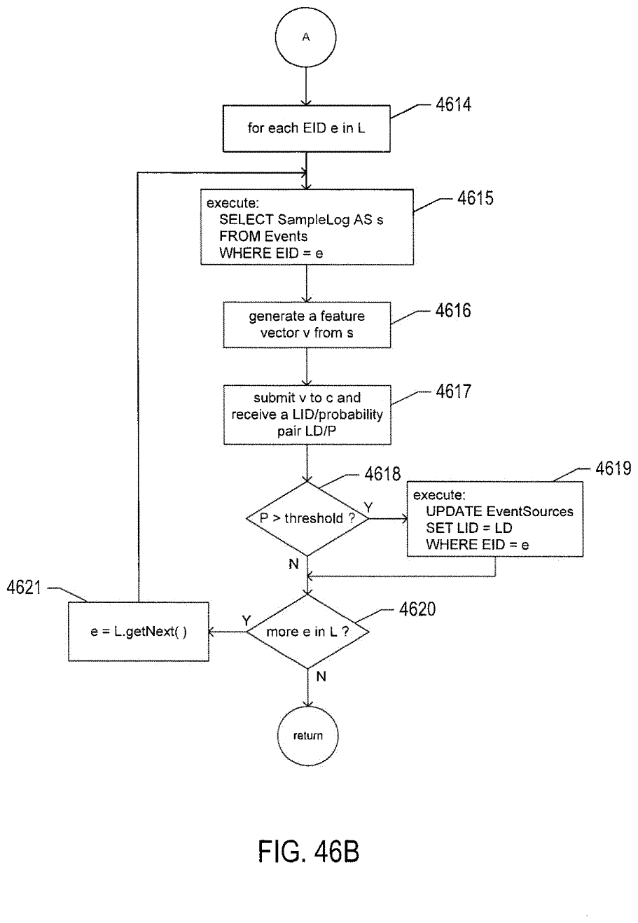

FIGS. 46A-B provide control-flow diagrams for the routine “ML sourcing,” called in step 4214 of FIG. 42. In step 4602, the routine “ML sourcing” receives a list of unknown event types L and initializes a machine-learning classifier, such as a neural network or support vector machine, discussed above in preceding subsections with reference to FIGS. 24A-B and 27-34B. When the list L is empty, as determined in step 4604, the routine “ML sourcing” returns. Otherwise, in step 4606, the routine “ML sourcing” executes in SQL-like query to obtain the sample log/event-message and log-source identifier for all resolved event types. In the far-loop of steps 4608, a feature vector is generated, in step 4609, for the sample log/event-message of each sample-log/event-message/log-source-identifier pair and the corresponding feature-vector/log-source-identifier pair is submitted, in step 4610, to the machine-learning classifier as training data. The machine-learning classifier is thus trained to predict a log-source identifier from feature vectors generated from sample log/event messages. Then, turning to FIG. 46B, in the for-loop of steps 4614-4621, each event-type identifier corresponding to an as yet unresolved event type contained in the list L is considered. In step 4615, an SQL-like query is executed to obtain the sample log/event messages for the currently considered event-type identifier. In step 4616, a feature vector v is generated from s. In step 4617, the feature vector v is submitted to the machine-learning classifier, which returns a log-source-identifier/probability pair LD/P. When the returned probability P of the log-source identifier LD being correctly mapped to the event-type identifier is greater than a threshold value, as determined in step 4618, the mapping for the event-type identifier is updated to associate the event-type identifier with the log-source identifier LD, in step 4619.

The present invention has been described in terms of particular embodiments, it is not intended that the invention be limited to these embodiments. Modifications within the spirit of the invention will be apparent to those skilled in the art. For example, any of many different implementations of the log/event-message system can be obtained by varying various design and implementation parameters, including modular organization, control structures, data structures, hardware, operating system, and virtualization layers, and other such design and implementation parameters. As discussed above, K-means clustering and a machine-learning classifier are both employed in the described implementation of the currently disclosed methods and systems. There are many different alternative types of clustering in machine-learning classifiers that can be employed in alternative implementations. Furthermore, alternative implementations may choose different thresholds and other parameters for deciding when an event-type-identifier/log-source identifier mapping is sufficiently well-established to be stored and used for subsequent auto-tagging. Different implementations of different log/event-a message systems may place auto-tagging and log-source mapping functionalities in different modules and subsystems. In many cases, auto-tagging is best incorporated in message collectors and log-source mapping is best carried out by a specialized logic module that executes on a backend system and that is periodically called to resolve event-type identifiers that have not been previously mapped to log sources.

1. An improved log/event-message system, within a distributed computer system, that collects log/event messages from log/event-message sources within the distributed computer system, automatically associates log-source tags with those collected log/event messages for which log-source mappings have been learned, stores the collected log/event messages, and provides query-based access to the stored log/event-messages, the log/event-message system comprising:
one or more message collectors, incorporated within one or more computer systems, each having one or more processors and one or more memories, which each
receives log/event messages,
processes the received log/event messages, and
transmits the log/event messages to one or more downstream processing components, including one or more message-ingestion-and-processing systems; and
the one or more message-ingestion-and-processing systems, incorporated within one or more computer systems, each having one or more processors and one or more memories, which each
receives log/event messages from one or more of the one or more message collectors,
processes the received log/event messages, and
transmits the log/event messages to one or more downstream processing components, including a log/event-message query system.

2. The log/event-message system of claim 1 wherein log/event-message sources include:
message-generation-and-reporting components of hardware components of the distributed computer system, including network routers and bridges, network-attached storage devices, network-interface controllers, and other hardware components and devices; and
message-generation-and-reporting components within computer-instruction-implemented components of the distributed computer system, including virtualization layers, operating systems, and applications running within servers and other types of computer systems.

3. The log/event-message system of claim 1 wherein log/event-messages include text, alphanumeric values, and/or numeric values that represent various types of information, including notification of completed actions, errors, anomalous operating behaviors and conditions, various types of computational events, warnings, and other such information.

4. The log/event-message system of claim 1 wherein the log/event-message system automatically associates log-source tags with the collected log/event messages using multiple types of information, the multiple types of information including:
a mapping of log/event messages to event types;
log-source tags associated with log/event messages prior to an initial learning phase;
clustering of event types unmapped to a verified log source;
log/event-message field definitions provided by content packs; and
machine-learned mappings between information derived from event types and log sources.

5. The log/event-message system of claim 4 wherein the log/event-message system automatically determines an event type for a received log/event message by:
extracting non-variable field values from the received log/event message; and
identifying an event type for which the extracted non-variable fields most closely matches the non-variable fields extracted from the log/event messages of the event type.

6. The log/event-message system of claim 5 wherein the log/event-message system associates an event type with a group of log/event messages by:
representing each of a set of received log/event messages by a vector generated from the non-variable fields extracted from the log/event messages;
clustering the vectors; and
assigning a unique event type to each cluster of vectors.

7. The log/event-message system of claim 4 wherein the log-source tags associated with log/event messages prior to an initial learning phase are generated by one of:
human developers, administrators, managers, and other users of the distributed computer system;
one or more external log/event-message systems; and
by configured message collectors and/or message-processing-and-ingestion systems within a controlled test environment.

8. The log/event-message system of claim 4 wherein the log/event-message system automatically associates a log source with a group of log/event messages by:
clustering event types unmapped to a verified log source by
generating a feature vector for each event type unmapped to a verified log source from an example log/event message of the event type, and
clustering the feature vectors using a distance metric for feature vectors;
assigning a log source to each event-type cluster;
mapping the event types in each cluster to the log source assigned to the cluster; and
mapping log/event messages of the event type to the log source to which the vent type is mapped.

9. The log/event-message system of claim 8 further comprising:
applying log/event-message field definitions provided by content packs to associate each unmapped event type to a content pack; and
assigning a log source to each event-type cluster by
determining a likely content pack for each event-type cluster, and
assigning to each event-type cluster a log source associated with the determined likely content pack for the event-type cluster.

10. The log/event-message system of claim 9 wherein a likely content pack for an event-type cluster is a content pack associated with as many or more unmapped event types in the event-type cluster than any other content pack.

11. The log/event-message system of claim 4 wherein the log/event-message system automatically associates a log source with a group of log/event messages by:
training a machine-learning classifier to map feature vectors, generated from sample log/event messages for event types, to log sources;
inputting a feature vector generated from a sample log/event message for an unmapped event type to the trained machine-learning classifier;
receiving output from the machine-learning classifier; and
when the output indicates that the input feature vector can be assigned to a log source, associating the log source with log/event messages of the event type.

12. The log/event-message system of claim 11
wherein the output includes a log source and a probability; and
wherein the output indicates that the input feature vector can be assigned to the log source when the probability is greater than a threshold value.

13. A method that improves a log/event-message system within a distributed computer system that collects log/event messages from log/event-message sources within the distributed computer system, stores the collected log/event messages, and provides query-based access to the stored log/event-messages, the method comprising:
learning mappings, by the log/event-message system, between log sources and event types; and
automatically associating, by the log/event-message system, log-source tags containing log-source indications with those collected log/event messages having event types for which log-source mappings have been learned.

14. The method system of claim 13 wherein the log/event-message system learns mappings between log sources and event types using multiple types of information, the multiple types of information including:
a mapping of log/event messages to event types;
log-source tags associated with log/event messages prior to an initial learning phase;
clustering of event types unmapped to a verified log source;
log/event-message field definitions provided by content packs; and
machine-learned mappings between information derived from event types and log sources.

15. The method of claim 14
wherein the log/event-message system automatically determines an event type for a received log/event message by
extracting non-variable field values from the received log/event message, and
identifying an event type for which the extracted non-variable fields most closely matches the non-variable fields extracted from the log/event messages of the event type; and
wherein the log/event-message system associates an event type with a group of log/event messages by
representing each of a set of received log/event messages by a vector generated from the non-variable fields extracted from the log/event messages,
clustering the vectors, and
assigning a unique event type to each cluster of vectors.

16. The method of claim 14 wherein the log-source tags associated with log/event messages prior to an initial learning phase are generated by one of:
human developers, administrators, managers, and other users of the distributed computer system;
one or more external log/event-message systems; and
by configured message collectors and/or message-processing-and-ingestion systems within a controlled test environment.

17. The method of claim 14 wherein the log/event-message system automatically associates a log source with a group of log/event messages by:
clustering event types unmapped to a verified log source by
generating a feature vector for each event type unmapped to a verified log source from an example log/event message of the event type, and
clustering the feature vectors using a distance metric for feature vectors;
assigning a log source to each event-type cluster;
mapping the event types in each cluster to the log source assigned to the cluster; and
mapping log/event messages of the event type to the log source to which the vent type is mapped.

18. The method of claim 17 further comprising:
applying log/event-message field definitions provided by content packs to associate each unmapped event type to a content pack; and
assigning a log source to each event-type cluster by
determining a likely content pack for each event-type cluster, and
assigning to each event-type cluster a log source associated with the determined likely content pack for the event-type cluster, wherein the likely content pack for the event-type cluster is a content pack associated with as many or more unmapped event types in the event-type cluster than any other content pack

19. The method of claim 18 wherein the log/event-message system automatically associates a log source with a group of log/event messages by:
training a machine-learning classifier to map feature vectors, generated from sample log/event messages for event types, to log sources;
inputting a feature vector generated from a sample log/event message for an unmapped event type to the trained machine-learning classifier;
receiving output from the machine-learning classifier that includes a log source and a probability; and
when the output probability is greater than a threshold value, associating the output log source with log/event messages of the event type.

20. A physical data-storage device that stores computer instructions that, when executed by processors within computer systems of a log/event-message system within a distributed computer system, control the log/event-message system to:
collect log/event messages from log/event-message sources within the distributed computer system;
learn a mapping between log sources and event types;
automatically associating log-source tags containing log-source indications with those collected log/event messages having event types for which log-source mappings have been learned:
store the collected log/event messages; and
provide query-based access to the stored log/event-messages.
